(19) United States
(12) Patent Application Publication
(10) Pub. No.: US 2025/0223199 A1
(43) Pub. Date: Jul. 10, 2025

(54) METHODS OF REMOVING ENVIRONMENTAL CONTAMINANTS

(71) Applicants: THE UNIVERSITY OF BRITISH COLUMBIA, Vancouver (CA); POLYVALOR, LIMITED PARTNERSHIP, Quebec (CA)

(72) Inventors: Fuhar Dixit, Vancouver (CA); Benoit Barbeau, Montreal (CA); Madjid Mohseni, Vancouver (CA)

(21) Appl. No.: 18/702,977

(22) PCT Filed: Oct. 20, 2022
(86) PCT No.: PCT/CA2022/051552

§ 371 Date: Apr. 19, 2024

Related U.S. Application Data
(60) Provisional application No. 63/270,105, filed on Oct. 21, 2021.
(60) Provisional application No. 63/257,755, filed on Oct. 20, 2021.

(51) Int. Cl. C02F 1/28; B01J 20/02; B01J 20/22; C02F 1/72; C02F 101/36

(52) U.S. Cl. CPC C02F 1/288; B01J 20/0211; B01J 20/0229; B01J 20/22; C02F 1/281; C02F 1/72; C02F 1/286; C02F 2101/36; C02F 2303/16; C02F 2305/08

(57) ABSTRACT

The present disclosure includes methods of removing an environmental contaminant from media comprising the environmental contaminant as well as methods for preparing a composite material that may be useful in such methods. The methods of preparing a composite material can comprise: preparing a nanoparticle from a polyphenol-containing natural material and a metal salt; and combining the nanoparticle with a substrate.

### CROSS-REFERENCE TO RELATED APPLICATIONS

The present disclosure claims the benefit of priority from co-pending U.S. provisional application nos. 63/257,755 filed on Oct. 20, 2021, and 63/270,105, filed on Oct. 21, 2021, the contents of each of which are incorporated herein by reference in their entirety.

### FIELD

The present disclosure relates to methods of removing an environmental contaminant such as per- and poly-fluoroalkyl substances (PFAS) from media comprising the environmental contaminant as well to composite materials which may be used in such methods and methods for the preparation of such composite materials.

### BACKGROUND

Per- and poly-fluoroalkyl substances (PFAS) are anthropogenic compounds with high chemical and thermal stability.^{1,2} These anthropogenic compounds include those made up of a long hydrophobic perfluorinated carbon chain (CₙF₂ₙ₊₁) and a hydrophilic functional group (such as —SO₃⁻). This unique combination of hydrophilicity and hydrophobicity enables such PFAS compounds to exhibit excellent surface properties with tremendous industrial applications. PFAS are, or have been, extensively used in products and applications such as non-stick cookware, specialized garments such as water-resistant clothing, stain-resistant coatings, aqueous film-forming foams (AFFF) for extinguishing hydrocarbon fires, and fluoropolymer manufacture.^{3,4} However, PFAS have recently drawn substantial attention due to their potential toxicity and ubiquitous presence in the environment. For example, PFAS have drawn increased attention in recent years due to their potential toxicity to the mammalian reproductive and developmental systems.^{5,6,7} In recent years, several PFAS compounds have been linked to cancer, liver/kidney damage and developmental effects in mammals.

Well-known PFAS such as anionic perfluorooctanoic acid (PFOA) and perfluorooctane sulfonate (PFOS) have been ubiquitously detected in the aquatic environment.^{6,8} Drinking water is one of the potential pathways for human exposure to PFAS. Its presence has been detected in tap water all across the globe. A drinking water guideline has been set in Canada (perfluorooctanoic acid (PFOA): 200 ng/L) as well as in the European Community (100 ng/L for individual PFAS and 500 ng/L for all total PFAS).^{9,10} More importantly, exposure to PFAS via consumption of contaminated drinking water has been linked with increased incidence of health issues in impacted populations. The United States Environmental Protection Agency (USEPA) has set a drinking water health advisory of 70 ng/L for PFOA, PFOS, and their sum.¹¹ However, recent guidance from regulatory health agencies across the United States suggests that chronic exposures to lower PFAS concentrations (e.g., 10-15 ng/L) may already present human health risks.^{75,12,13} In June 2022, the USPEA released new drinking water health advisories: 0.004 ng/L for PFOA and 0.02 ng/L for PFOS.¹⁴

In recent years, new emerging classes of zwitterionic PFAS have been detected in aquatic environments across the globe. Chemicals such as 6:2 fluorotelomer sulfonamidopropyl betaine (6:2 FTAB) and 8:2 FTAB have been recently reported to be key ingredients in several brands of AFFF formulations and widely detected at contaminated sites.⁷³ For instance, Boiteux et al. reported approximately 18 μg/L of 6:2 fluorotelomer betaine (6:2 FTAB) in a French river that receives wastewater from a training site involving AFFF usage.¹⁵ The reported concentrations of 6:2 FTAB in their study were about 350-fold higher than the concentrations of regulated PFAS compounds such as PFOA.¹⁵ D'Agostino and Mabury also reported elevated levels of FTAB and fluorotelomer betaines (FTB) in surface waters of the Welland River (ON, Canada) impacted by AFFF.⁸⁷ The magnitude of their concentration and increased frequency of detection worldwide raise the questions of their possible presence in treated water and associated health risk. The environmental behaviors of zwitterionic PFAS are presumably very different from anionic PFAS.¹⁵ Zwitterionic PFAS such as 6:2 FTAB can exist in either zwitterionic or cationic form and thus, may not be removed via techniques that rely solely on electrostatic interactions with conventional anionic PFAS. This warrants identification of appropriate water treatment techniques to effectively remove zwitterionic PFAS from contaminated water sources.

Adsorption, advanced oxidation, ion-exchange (IX) and reverse osmosis are examples of known PFAS removal techniques from contaminated waters. All of these techniques, however, have numerous drawbacks and restrictions, thus limiting their scope of application. Treatment technologies such as the ion exchange (IX) process exhibit promising potentials for removing anionic PFAS from natural waters.^{75,16,17} For example, IX has been found to offer superior performance over other removal techniques such as activated carbon and advanced oxidation processes, particularly for short-chained PFAS. This method, however, is very slow for regenerable ion-exchange resins due to their competition with other dissolved organic/inorganic species for active uptake sites. New IX resins with higher selectivity towards PFAS are also becoming commercially available for surface/ground water treatment and wastewater reuse. In recent years, industries have started manufacturing PFAS-specific resins which are typically operated in a single load-and-dispose mode until exhaustion.^{18,19,52} Without regeneration and reuse, this results in high cost and greater environmental burden. However, certain PFAS-capturing resins can also be regenerated and reused for multiple cycles for simultaneous removal of PFAS, dissolved organic matter (DOM) and inorganics ions (e.g., sulfate, nitrate, etc.) from drinking and recycled wastewater sources.⁴⁵ Although past studies on IX resins have majorly focused on anionic PFAS capture, recent studies have started examining their efficacy for zwitterionic PFAS.⁷⁶ For example, Wang et al. reported about 10% removal of 6:2 FTAB with Purofine PFA694E, a PFAS-specific resin that captured >50% PFOA and PFOS under similar operating conditions (C₀=10 μg PFAS/L and 10 mg IX/L).⁷⁶ Similarly, nonionic exchange resins such as Purofine PFC 100, captured only 25% of 6:2 FTAB (C₀=10 μg PFAS/L and 10 mg IX/L),⁷⁶ highlighting the need for the development of new adsorbent media for effectively capturing zwitterionic PFAS.

MXenes are a new type of two-dimensional (2D) material, which rapidly gained traction for a range of chemical, environmental and medical applications._{20,21} MXenes and MXene-composites exhibit high surface area, superlative thermal conductivity, chemical stability, hydrophilicity and are environmentally compatible.^{22,23,24,25,80} These compounds of general formula Mₙ₊₁XₙTₓ represent a family of transition metal carbides, nitrides and carbonitrides. Here, M represents an early transition metal (such as Ti, Mo, Zr, W, etc.) while X represents carbon/nitrogen. T denotes surface termination groups such as fluorine (F), hydroxyl (OH), oxygen (O) and chlorine (Cl). The symbol x represents the number of surface functional groups, and n is an integral number between 1 and 3. One of the most common MXenes is Ti₃C₂Tₓ with —F or —OH terminal groups.^{25,26,27,28} It has been reported that MXenes can adsorb metal ions, organic dyes and other charged contaminants through electrostatic and chemical interactions.^{81,29,81,30,31} However, the application of MXenes for PFAS removal has not yet been reported in scientific literature.

### SUMMARY

The present disclosure includes a method of removing an environmental contaminant from media comprising the environmental contaminant, the method comprising:
contacting the media comprising the environmental contaminant with a nanoparticle prepared from a polyphenol-containing natural material and a metal salt.

In an embodiment, the polyphenol-containing natural material is a polyphenol-containing plant material. In another embodiment, the polyphenol-containing plant material is a polyphenol-containing fruit, bark, leaf, vegetable, grain or combinations thereof. In a further embodiment, the polyphenol-containing fruit is of Cyanococcus, Fragaria spp., Rubus spp., Phyllanthus emblica or combinations thereof. In another embodiment, the polyphenol-containing natural material comprises Phyllanthus emblica fruit powder. In an embodiment, the preparation of the nanoparticle comprises combining the polyphenol-containing natural material in the form of a polyphenol-containing extract from the natural material with the metal salt.

In an embodiment, the metal salt is a metal nitrate, sulfate, chloride or combination thereof. In another embodiment, the metal of the metal salt is iron, silver, gold or combinations thereof. In a further embodiment, the metal salt comprises FeSO₄.

In an embodiment, the nanoparticle is in a composite material comprising the nanoparticle and a substrate. In another embodiment, the substrate comprises sand, gravel, clay, hydrogel, carbon, mined material, sediment, polymer, a metal organic framework, a zeolite, MXene, a biomaterial or combinations thereof. In a further embodiment, the substrate comprises a PFAS specific resin or a PFAS specific membrane. In another embodiment, the substrate comprises a polystyrenic resin comprising a quaternary ammonium functional group. In another embodiment, the substrate comprises a polyacrylic resin comprising a quaternary ammonium functional group.

In an embodiment, the nanoparticles are raw.

In an embodiment, the environmental contaminant comprises PFAS, natural organic matter or combinations thereof. In another embodiment, the environmental contaminant comprises PFAS. In a further embodiment, the environmental contaminant comprises anionic PFAS, cationic PFAS, neutral and zwitterionic PFAS or combinations thereof. In another embodiment, the environmental contaminant comprises a long chain perfluorocarboxylic acid, a short chain perfluorocarboxylic acid, a long chain perfluoroalkane sulfonic acid, a short chain perfluoroalkane sulfonic acid, GenX™, a fluorotelomer sulfonic acid (betaine) or combinations thereof.

In an embodiment, the media comprises air, a liquid, a solid, a gel, a slurry or combinations thereof. In another embodiment, the media comprises water.

In an embodiment, subsequent to contacting, the method further comprises separating the nanoparticle from the media.

In an embodiment, the nanoparticle is in the composite material comprising the nanoparticle and a substrate as described herein, and the method further comprises regenerating the composite material. In another embodiment, the composite is regenerated with an aqueous solution comprising an inorganic salt, inorganic acid, inorganic base, organic solvent or combinations thereof to obtain a regenerated composite material and a regeneration concentrate comprising the environmental contaminant and/or by-products thereof.

In an embodiment, the method further comprises treatment of the regeneration concentrate to degrade and/or destroy the environmental contaminant and/or by-products thereof.

In an embodiment, subsequent to contacting, the method further comprises treatment of the contacted media to degrade and/or destroy remaining environmental contaminant and/or by-products thereof. In an embodiment, the treatment comprises defluorination. In another embodiment, the treatment comprises treatment with ultraviolet light or an electrochemical process.

In an embodiment, prior to contacting the media comprising the environmental contaminant with the nanoparticle, the method comprises oxidizing the environmental contaminant.

The present disclosure also includes a method of removing a zwitterionic PFAS from media comprising the zwitterionic PFAS, the method comprising:
contacting the media comprising the zwitterionic PFAS with a MXene.

In an embodiment, the MXene comprises Ti₃C₂ MXene.

In an embodiment, the media further comprises an additional environmental contaminant, wherein the additional environmental contaminant comprises anionic, cationic and/or neutral PFAS, natural organic matter or combinations thereof.

In an embodiment, the media comprises water.

In an embodiment, subsequent to contacting, the method further comprises separating the MXene from the media.

In an embodiment, the method further comprises regenerating the MXene. In another embodiment, the MXene is regenerated with an aqueous solution comprising an inorganic salt, inorganic acid, inorganic base, organic solvent or combinations thereof to obtain a regenerated MXene and a regeneration concentrate comprising the zwitterionic PFAS and optionally the additional environmental contaminant comprising anionic, cationic and/or neutral PFAS, natural organic matter or combinations thereof and/or by-products thereof.

In an embodiment, the method further comprises treatment of the regeneration concentrate to degrade and/or destroy the zwitterionic PFAS and optionally the additional environmental contaminant comprising anionic, cationic and/or neutral PFAS, natural organic matter or combinations thereof and/or by-products thereof.

In an embodiment, subsequent to contacting, the method further comprises treatment of the contacted media to degrade and/or destroy remaining zwitterionic PFAS and optionally additional environmental contaminant. In an embodiment, the treatment comprises defluorination.

The present disclosure also includes a method of preparing a composite material, the method comprising:
preparing a nanoparticle from a polyphenol-containing natural material and a metal salt; and
combining the nanoparticle with a substrate.

In an embodiment, the polyphenol-containing natural material is a polyphenol-containing plant material. In another embodiment, the polyphenol-containing plant material is a polyphenol-containing fruit, bark, leaf, vegetable, grain or combinations thereof. In a further embodiment, the polyphenol-containing fruit is of Cyanococcus, Fragaria spp., Rubus spp., Phyllanthus emblica or combinations thereof. In another embodiment, the polyphenol-containing natural material comprises Phyllanthus emblica fruit powder. In another embodiment, the preparation of the nanoparticle comprises combining the polyphenol-containing natural material in the form of a polyphenol-containing extract from the natural material with the metal salt.

In an embodiment, the metal salt is a metal nitrate, sulfate, chloride or combinations thereof. In another embodiment, the metal of the metal salt is iron, silver, gold or combinations thereof. In a further embodiment, the metal salt comprises FeSO₄.

In an embodiment, the substrate comprises sand, gravel, clay, hydrogel, carbon, mined material, sediment, polymer, a metal organic framework, a zeolite, MXene, a biomaterial or combinations thereof. In another embodiment, the substrate comprises a PFAS specific resin or a PFAS specific membrane. In a further embodiment, the substrate comprises a polystyrenic resin comprising a quaternary ammonium functional group. In another embodiment, the substrate comprises a polyacrylic resin comprising a quaternary ammonium functional group.

The present disclosure also includes a composite material prepared by a method of preparing a composite material as described herein. The present disclosure also includes a use of such a composite material for removal of an environmental contaminant from media comprising the environmental contaminant.

The present disclosure also includes a nanoparticle prepared from a polyphenol-containing natural material and a metal salt as described herein for use in removal of an environmental contaminant from media comprising the environmental contaminant.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should rather be given the broadest interpretation consistent with the description as a whole.

### BRIEF DESCRIPTION OF THE DRAWINGS

FIG. 1 is a schematic of an embodiment of a method of removing an environmental contaminant from media comprising the environmental contaminant of the present disclosure.

FIG. 2 is a schematic of another embodiment of a method of removing an environmental contaminant from media comprising the environmental contaminant of the present disclosure.

FIG. 3 is a schematic of the process flow at the Vancouver Convention Centre (VCC) secondary wastewater treatment plant.

FIG. 4 shows the Zeta potential of MXene (tested at a dose of 50 mg/L) as a function of pH using a Malvern Zetasizer Nano ZS—NIB (U.K.).

FIG. 5 shows liquid chromatography—organic carbon detection (LCOCD) data for Vancouver Convention Centre water before ion exchange (IX) treatment.

FIG. 6A shows illustrative liquid chromatography with tandem mass spectrometry (LC-MS/MS) chromatograms of target X:2 FTAB, using triple quadrupole tandem mass spectrometry (Q.T.: quantification transition; C.T.: confirmation transition). From top to bottom: 6:2 FTAB—Q.T. (571→440), 6:2 FTAB—C.T. (571→468), 8:2 FTAB—Q.T. (671→540), 8:2 FTAB—C.T. (671→568), 10:2 FTAB—Q.T. (771→640), and 10:2 FTAB—C:T (771→668). FIG. 6B shows illustrative liquid chromatography-high resolution mass spectrometry (LC-HRMS) chromatograms of Z-PFAS, extracted within ±10 ppm exact mass accuracy of their theoretical m/z. Left column, from top to bottom: 6:2 FTAB, 8:2 FTAB and 10:2 FTAB; center column, from top to bottom: 5:3 FTB, 7:3 FTB and 9:3 FTB; and right column, from top to bottom: 5:1:2 FTB, 7:1:2 FTB, 9:1:2 FTB and 11:1:2 FTB.

FIG. 7 shows recoveries of ¹³C₄-PFHpA (upper plot) and ¹³C₂₋₆:2FTSA (lower plot) surrogate internal standards, tested for different sample types (solvent blanks, procedure blanks, UV/sulfite reacted samples, SRNOM, and recycled wastewater).

FIG. 8 shows removal of different zwitterionic PFAS on the tested adsorbent media (from left to right for each compound: A860, A592, A694, XAD 4, XAD 7 and MXene) with 5 mg C/L background DOM concentration (SRNOM). Adsorbent dosage: 100 mg/L at pH about 7.0 and T=23° C. The initial concentration (C₀, μg/L) in solution is given under each compound, from left to right: 6:2 FTAB, 8:2 FTAB, 10:2 FTAB, 5:1:2 FTB, 7:1:2 FTB, 9:1:2 FTB, 11:1:2 FTB, 5:3 FTB, 7:3 FTB, 9:3 FTB and 11:3 FTB.

FIG. 9 shows effect of pH (from left to right for each adsorbent media: 6, 6.5, 7 and 7.5) on the removal of Z-PFAS by resins and MXene (from left to right: A860, A592, A694, XAD4, XAD7 and MXene) with 5 mg C/L background DOM concentration (SRNOM). Adsorbent dosage: 100 mg/L at pH about 7 and T=23° C.

FIG. 10 is a schematic of a hypothesized mechanism of Z-PFAS removal by Ti₃C₂ MXenes via electrostatic interactions (upper image) and hydrogen bonding (lower image).

FIG. 11A shows a plot of estimated Biot numbers for 6:2 FTAB (from left to right for each adsorbent: 2500, 1250, 500 and 100 ng/L) uptake on the tested adsorbents (from left to right: A860, A592, A694, XAD 4, XAD 7 and MXene) in DI water. FIG. 11B shows a plot of estimated Biot numbers for 6:2 FTAB (from left to right for each adsorbent: 2500, 1250, 500 and 100 ng/L) uptake on the tested adsorbents (from left to right: A860, A592, A694, XAD 4, XAD 7 and MXene) in synthetic water spiked with SRNOM (5 mg C/L).

FIG. 12 is a plot showing cumulative Z-PFAS removal (%) in synthetic (SRNOM; right column) and natural waters (recycled wastewater; left column) with about 5 mg C/L background DOM. Adsorbent (from left to right: A860, A592, A694, XAD4, XAD7 and MXene) dose: 100 mg/L and C₀ of total Z-PFAS: 10 μg/L at pH about 7 and T=23° C.

FIG. 13 is a plot showing regeneration of all adsorbents (from left to right: A860, A592, A694, XAD4, XAD7 and MXene) using 4 mM of salts (from left to right for each adsorbent: sodium sulfite, sodium sulfate and sodium chloride) or 0.1 N acid (HCl; second from right for each adsorbent) and 0.1 N base (NaOH; far right for each adsorbent).

FIG. 14 is a plot showing regeneration of individual Z-PFAS (from left to right: 6:2 FTAB, 8:2 FTAB, 10:2 FTAB, 5:1:2 FTB, 7:1:2 FTB, 9:1:2 FTB, 11:1:2 FTB, 5:3 FTB, 7:3 FTB, 9:3 FTB and 11:3 FTB) from Ti₃C₂ MXenes using from left to right for each adsorbent: sodium sulfite and sodium sulfate (4 mM) and 0.1 N HCl and 0.1 N NaOH.

FIG. 15 is a plot showing cumulative Z-PFAS recovery from Ti₃C₂ MXenes over multiple loading/regeneration cycles (C₀=10 μg Z-PFAS/L, 100 mg/L adsorbent dosage and regeneration with 5 mL of 4 mM mg/L Na₂SO₃).

FIG. 16 is a plot showing degradation of Z-PFAS (from left to right: 6:2 FTAB, 8:2 FTAB, 10:2 FTAB, 5:1:2 FTB, 7:1:2 FTB, 9:1:2 FTB, 11:1:2 FTB, 5:3 FTB, 7:3 FTB, 9:3 FTB and 11:3 FTB) in Na₂SO₃ (4 mM) regenerant with a UV dosage of about 180 J/cm² at T=23° C.

FIG. 17 is a plot showing degradation of summed Z-PFAS, 6:2 FTAB, and 5:1:2 FTB during UV/sulfite treatment as concentration (μg/L) as a function of time for up to 36h (from left to right: T₀, 6 h, 12 h and 36h).

FIG. 18 shows plots of degradation of summed Z-PFAS (upper plot), 6:2 FTAB (middle plot), and 5:1:2 FTB (lower plot) during UV/sulfite treatment as concentration (μg/L) as a function of time for up to 36 h (from left to right in each plot: T₀, 6 h, 12 h and 36h).

FIG. 19 shows liquid chromatography-high resolution mass spectrometry (LC-HRMS) chromatograms (upper images) and elucidated high-resolution tandem mass spectrometry (MS/MS) spectrum (parallel reaction monitoring; PRM mode, normalized collision energy set at 35%, lower image) of 6:2 N-demethylated fluorotelomer amine (transformation product B of Scheme 1), generated during UV/sulfite treatment of 6:2 FTAB.

FIG. 20 is a schematic of an embodiment of a method of preparing a composite material of the present disclosure.

FIG. 21A shows a scanning electron microscope (SEM) image of a commercially available polyacrylic ion exchange resin at 250 μm resolution. FIG. 21B shows a SEM image of a commercially available polyacrylic ion exchange resin at 50 μm resolution.

FIG. 22A shows a SEM Image of PFAS Plus coated polyacrylic ion exchange resin at 250 μm resolution. FIG. 22B shows a SEM Image of PFAS Plus coated polyacrylic ion exchange resin at 50 μm resolution.

FIG. 23A shows a SEM Image of PFAS Plus coated polyacrylic ion exchange resin at 5 μm resolution. FIG. 23B is a plot of number (%) as a function of size (nm) from dynamic light scattering images which show an average Fe particle size of 91.3±12.1 nm.

FIG. 24A shows a SEM image of polystyrenic ion exchange resin at 250 μm resolution as fresh resin. FIG. 24B shows a SEM image of polystyrenic ion exchange resin at 250 μm resolution with PFAS Plus coating.

FIG. 25 is a plot showing contact time required to achieve PFAS removal below limit of detection (to <10 ng/L from C₀=10 μg/L) in presence of 5 mg C/L (Suwannee River Natural Organic Matter Standard) with 0.4 mL IX resin/L (black, control) or 0.4 mL PFAS Plus coated IX resin (grey). Acronyms, from left to right: perfluorobutanoic acid (PFBA), perfluorooctanoic acid (PFOA), perfluorobutanesulfonate (PFBS), perfluorooctanoic sulfonic acid (PFOS), heptafluoropropylene oxide-dimer acid (GenX) and 6:2 fluorotelomer sulfonate.

FIG. 26 is a plot showing PFAS removal by different ion exchange (IX) resins (from left to right for each: polyacrylic resin: raw, polyacrylic resin: tannic acid MPNs, polyacrylic resin: natural MPNs, polystyrenic resin: raw, polystyrenic resin: tannic acid MPNs and polystyrenic resin: natural MPNs) minimum detection limit: 200 μg/L; initial individual PFAS concentration (C₀) in the range of 0.02 μg/L to 200 μg/L (environmentally relevant concentration)) in presence of 10 mg C/L (dissolved organic matter (DOM)) with 0.4 mL IX/L (100 mg/L dry resin weight). From left to right: anionic PFAS, zwitterionic and neutral PFAS, PFCA+PFSA, GenX, long chain PFCA, long chain PFSA, short chain PFCA and short chain PFSA.

FIG. 27 shows PFAS removal by different virgin adsorbents (from left to right for each: polyacrylic resin, polystyrenic resin, natural MPNs and tannic acid MPNs) in presence of 10 mg C/L with 100 mg IX (or Fe)/L and initial individual PFAS concentration (C₀) in the range of 0.02 μg/L to 200 μg/L. From left to right: anionic PFAS, zwitterionic and neutral PFAS, PFCA+PFSA, GenX, long chain PFCA, long chain PFSA, short chain PFCA and short chain PFSA.

FIG. 28 is a plot showing contact time (minutes) to achieve 4-log removal of PFAS in the presence of 5 mg C/L with 100 mg IX (or Fe)/L (from left to right for each: polyacrylic: raw, polyacrylic: natural MPNs, polyacrylic: tannic acid MPNs, polystyrenic: raw, polystyrenic: natural MPNs, natural MPNs (no resin) and tannic acid MPNs (no resin) and initial individual PFAS concentration (C₀) in the range of 0.02 μg/L to 200 μg/L. From left to right: PFOA+PFOS (regulated), long chain PFCA, long chain PFSA, short chain PFCA, short chain PFSA, GenX and zwitterionic PFAS.

FIG. 29 is a plot showing DOM recovery (%) of DOC (far left and second from right) and PFAS (second from left and far right) for saturated polyacrylic resin (coated with natural MPNs) regenerated with 10 bed volumes of sodium chloride (10 wt %; far left and second from left) and sodium sulfite (10 wt %; second from right and far right) with two hours of contact time.

FIG. 30 is a plot showing cumulative PFAS recovery (%) for saturated polyacrylic resin (coated with natural MPNs) regenerated with 10 bed volumes of sodium sulfite (10 wt %) with two hours of contact time over five regeneration cycles.

FIG. 31 shows plots of defluorination (%) over three hours of PFAS (from left to right: zwitterionic PFAS, anionic PFAS and GenX) with ultraviolet (left column in each plot) and electrochemical process (right column in each plot) with 4 mM background sulfite concentration. The 3 hours of UV irradiation would correspond to a dosage of approximately 10.4 J/cm². PFAS concentration in the range of 0.2 mg/L to 20 mg/L in regeneration concentrates.

FIG. 32 is a plot showing the kinetics of defluorination of zwitterionic PFAS for ultraviolet (UV) and electrochemical process (with boron-doped diamond (BDD) electrodes) with 4 mM PFAS concentrate. UV irradiation timings of 0.5, 1, 2 and 4 hours would correspond to a dosage of approximately 1.3 J/cm², 2.6 J/cm², 5.2 J/cm² and 10.4 J/cm².

FIG. 33 is a plot showing kinetics of defluorination of anionic PFAS for ultraviolet (UV) and electrochemical process (with boron-doped diamond (BDD) electrodes) with 4 mM PFAS concentrate. UV irradiation timings of 0.5, 1, 2 and 4 hours would correspond to a dosage of approximately 1.3 J/cm², 2.6 J/cm², 5.2 J/cm² and 10.4 J/cm².

FIG. 34 is a plot showing kinetics of defluorination of GenX for ultraviolet (UV) and electrochemical process (with boron-doped diamond (BDD) electrodes) with 4 mM PFAS concentrate. UV irradiation timings of 0.5, 1, 2 and 4 hours would correspond to a dosage of approximately 1.3 J/cm², 2.6 J/cm², 5.2 J/cm² and 10.4 J/cm².

FIG. 35 is a plot showing defluorination (time for 50% PFCA defluorination in days) of PFCA (total C₀=0.8±0.1 mg/L) at 40° C. with 50 mM sodium persulfate and MPNs (C₀=10±1 mg Fe/L). From left to right: no MPNs, tannic acid MPNs and natural MPNs.

FIG. 36 is a plot showing fluorine release (nmoles/L) from PFCA-laden MPNs coated resins at 25° C. (*) and 40° C. in a MPNs solution (C₀=10±1 mg Fe/L) in 72 hours with (left two columns) and without (right two columns) persulfate ions (C₀=50 mM).

FIG. 37 is a plot showing fluorine release (nmoles/L) from PFSA-laden MPNs coated resins at 25° C. (*) and 40° C. in a MPNs solution (C₀=10±1 mg Fe/L) in 72 hours with (left two columns) and without (right two columns) persulfate ions (C₀=50 mM).

FIG. 38 is a plot showing reduction in formation of halogenated disinfection by-products (DBPs) and haloacetic acids (HAAs) (μg/L) for different natural water sources. Resin dosage: 100 mg IX/L (0.4 mL/L); DOM: 10 mg C/L. From left to right for each water source: raw, polystyrenic: raw, polystyrenic: natural MPNs, polyacrylic: raw, and polyacrylic: natural MPNs.

FIG. 39 is a plot showing increase in the formation of toxic nitrosamines (ng/L) after treatment with polystyrenic and polyacrylic resins. From left to right: water 2: raw, polystyrenic: raw, polystyrenic: natural MPNs, polyacrylic: raw, and polyacrylic: natural MPNs.

FIG. 40 is a plot showing formation of nitrosamines such as N-nitrosodibutylamine (NDBA, ng/L) with PFAS adsorbents which have not been previously documented in drinking water systems and their control with MPNs. From left to right: polystyrenic: raw, polystyrenic: natural MPNs, polyacrylic: raw, and polyacrylic: natural MPNs. MPNs coated resins do not impact the formation/reduction of HAAs and volatile DBPs.

### DETAILED DESCRIPTION

### I. Definitions

Unless otherwise indicated, the definitions and embodiments described in this and other sections are intended to be applicable to all embodiments and aspects of the disclosure herein described for which they would be understood to be suitable by a person skilled in the art.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process/method steps. As used herein, the word “consisting” and its derivatives, are intended to be close ended terms that specify the presence of stated features, elements, components, groups, integers, and/or steps, and also exclude the presence of other unstated features, elements, components, groups, integers and/or steps. The term “consisting essentially of” and any form thereof, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least +5% of the modified term if this deviation would not negate the meaning of the word it modifies.

As used in this disclosure, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is used or present.

The term “suitable” as used herein means that the selection of specific reagents and/or conditions will depend on the reaction being performed and the desired results, but nonetheless, can generally be made by a person skilled in the art once all relevant information is known.

The terms “removing” and “removal” and the like as used herein in respect to removing/removal of an environmental contaminant from media comprising the environmental contaminant in the methods and uses of the present disclosure refers to a reduction in the total amount of the environmental contaminant in the media in comparison to the total amount of the environmental contaminant in the media prior to contact of the media with a nanoparticle (optionally in the form of a composite material comprising the nanoparticle) of the present disclosure. The term “reduction” in reference to the total amount of the environmental contaminant includes embodiments in which an environmental contaminant-loaded composite material of the present disclosure remains in the media (wherein the environmental contaminants are adsorbed to the composite material rather than in the media), embodiments wherein such an environmental contaminant-loaded composite material is separated from the media and embodiments wherein the environmental contaminant is broken down into smaller by-products and/or defluorinated.

The term “polyphenol” as used herein refers to a natural product having multiple hydroxyl groups on aromatic rings. For example, a polyphenol may refer to a water-soluble compound having a molecular weight of about 500 to about 4000 Da with greater than 12 phenolic hydroxyl groups with from 5 to 7 aromatic rings per 1000 Da and/or a compound derived from the shikimate/phenylpropanoid pathway and/or the polyketide pathway, which comprises more than one phenolic unit and is deprived of nitrogen-based functions. Polyphenols include hydrolysable tannins which are phytochemicals of the non-flavonoid polyphenol group, that include ellagitannins and gallotannins. In an embodiment, at least a portion of the polyphenol from the polyphenol-containing natural material is other than tannic acid.

The term “MXene” as used herein refers to a two-dimensional material of the general formula Mₙ₊₁XₙTₓ wherein n is an integer from 1 to 3, M represents an early transition metal, X is carbon and/or nitrogen, T denotes surface termination groups such as fluorine (F), hydroxyl (OH), oxygen (O) and chlorine (Cl) and x represents the number of surface functionalities. In an embodiment, M comprises Ti, Mo, Zr, or W such as W, Mo, Cr, Ta, V, Nb, Hf, Zr, Ti, Y, Sc or combinations thereof. In an embodiment, M is Ti. In another embodiment, X is C. In a further embodiment the MXene is a Ti₃C₂ MXene. MXenes are typically prepared by the selective etching of the A layers from a precursor MAX phase (Mₙ₊₁AXₙ), where M, X and n are as defined for the MXene and A is an element from groups 12-16 (such as Cd, Al, Si, P, S, Ga, Ge, As, In, Sn, Tl or Pb) and the A layer is generally sandwiched within octahedral Mₙ₊₁Xₙ, with a strong M-X bond and relatively weak M-A bond. For example, Ti₃C₂ MXene can be prepared by selectively etching the Al atoms from a layered hexagonal ternary carbide, Ti₃AlC₂ with hydrofluoric acid at room temperature. Alternatively, MXenes are available from suitable commercial sources.

The term “nanoparticle” as used herein refers to a particle wherein the average diameter is on the nanometer scale (e.g., an average diameter of less than 1 μm). The term “nanoparticle” as used herein includes materials wherein all particles have a diameter on the nanometer scale but may also include materials wherein minor amounts of particles are in non-nanoparticle form; e.g., materials wherein the particles consist essentially of particles having a diameter on the nanometer scale as well as particles outside the nanometer scale.

The term “alkyl” as used herein, whether it is used alone or as part of another group, means straight or branched chain, saturated alkyl groups.

The term “per- and polyfluoroalkyl substances” and the abbreviation “PFAS” as used herein refers to compounds comprising multiple fluorine atoms attached to an alkyl chain and include fluorotelomer sulfonates, fluorotelomer thioethers, GenX™ organofluorine compounds such as the ammonium salt of hexafluoropropylene oxide dimer acid (HFPO-DA) and related fluorochemicals. For example, a PFAS can be defined as a fluorinated substance that contains at least one perfluorinated methyl group (—CF₃) or at least one perfluorinated methylene group (—CF₂—). PFAS can be cationic, anionic, zwitterionic and/or neutral.

### II. Methods of Removing Environmental Contaminants

The present disclosure includes a method of removing an environmental contaminant from media comprising the environmental contaminant, the method comprising:
contacting the media comprising the environmental contaminant with a nanoparticle prepared from a polyphenol-containing natural material and a metal salt.

The polyphenol-containing natural material can be any suitable polyphenol-containing natural material. In an embodiment, the polyphenol-containing natural material is a polyphenol-containing plant material, a polyphenol-containing animal material, a polyphenol-containing algal material, a polyphenol-containing fungal material or combinations thereof. In another embodiment, the polyphenol-containing natural material is a polyphenol-containing plant material. It will be appreciated by a person skilled in the art that the occurrence of the polyphenol in the natural material such as the plant material may depend, for example, on the identity of the polyphenol and/or the natural material e.g., the plant material. In an embodiment, the polyphenol-containing plant material is a polyphenol-containing fruit, bark, leaf, vegetable, grain or combinations thereof. In an embodiment, the polyphenol-containing natural material is a fruit. In another embodiment, the polyphenol-containing fruit is of Cyanococcus, Fragaria spp., Rubus spp., Phyllanthus emblica or combinations thereof. In a further embodiment, the polyphenol-containing fruit is of Phyllanthus emblica. In an embodiment, the polyphenol-containing natural material comprises Phyllanthus emblica fruit powder. In another embodiment, the polyphenol-containing plant material is a polyphenol-containing tree material such as bark, leaves or combinations thereof. In another embodiment, the polyphenol-containing tree material is of Moringa oleifera, Mangifera indica or combinations thereof. In another embodiment, the polyphenol-containing plant material is a polyphenol-containing containing vegetable material. In an embodiment, the polyphenol-containing vegetable material is of a chili pepper. In another embodiment, the polyphenol-containing plant material is a grain. The polyphenol-containing natural material can be in any suitable form, the selection of which can readily be made by a person skilled in the art. In an embodiment, the polyphenol-containing natural material is in the form of a powder. The preparation of the nanoparticle from the polyphenol-containing natural material and the metal salt can comprise any suitable method. In an embodiment, the preparation of the nanoparticle comprises combining the polyphenol-containing natural material in the form of a polyphenol-containing extract from the natural material with the metal salt. The polyphenol-containing extract can be prepared from the polyphenol-containing natural material by any suitable method, which may depend, for example, on the particular polyphenol-containing natural material and/or its form, but the selection of which can nevertheless be readily made by a person skilled in the art. In an embodiment, the polyphenol-containing natural material is in the form of a polyphenol-containing extract prepared by contacting the polyphenol-containing natural material (e.g., in powdered form) with water for a time (e.g., about 5 minutes to about 12 hours or about 30 minutes to about 2 hours or about 1 hour) and at a temperature (e.g., at ambient temperature such as at about 4° C. to about 40° C. or about 20° C. to about 25° C.) suitable for extraction of the polyphenols into the water to proceed to a sufficient extent (e.g., greater than about 5, 10, 15, 20, 25, 30, 35, 40, 45, 50, 55, 60, 65, 70, 75, 80, 85, 90, 95 or 100% of the polyphenols are extracted into the water), optionally while agitating (e.g., mixing) at a suitable rate, for example, from about 500 rpm to about 1,500 rpm or about 1,000 rpm.

The metal salt can be any suitable salt. For example, it would be appreciated by a person skilled in the art that the combination of the metal in the metal salt and the counteranion (or combination thereof) may depend, for example, on the identity of the particular metal and counteranion (or combination thereof). It will also be appreciated by a person skilled in the art that the metal salt can be in any suitable hydrated form. In an embodiment, the metal salt is a metal nitrate, sulfate, chloride or combination thereof. In another embodiment, the metal salt is a metal sulfate, chloride or combination thereof. In another embodiment, the metal salt is a metal sulfate. In another embodiment, the metal salt is a metal chloride. In an embodiment, the metal of the metal salt is iron, silver, gold or combinations thereof. In another embodiment, the metal of the metal salt is iron. In another embodiment, the metal salt comprises ferric sulfate, ferric chloride, auric chloride or silver nitrate. In another embodiment, the metal salt comprises HAuCl₄ or FeCl₃. In a further embodiment, the metal salt comprises FeCl₃. In a further embodiment, the metal salt comprises FeSO₄. In another embodiment, the metal salt is FeSO₄·7H₂O.

In some embodiments of the present disclosure, the nanoparticle is in a composite material comprising the nanoparticle and a substrate. The substrate can comprise any suitable substrate. In an embodiment, the substrate comprises a high surface area inorganic substrate. In an embodiment, the substrate comprises sand, gravel, clay, hydrogel, carbon (e.g., activated carbon), mined material, sediment, polymer, a metal organic framework, a zeolite, MXene, a biomaterial (e.g., chitosan) or combinations thereof. In an embodiment, the MXene is a Ti₃C₂ MXene. In an embodiment, the substrate is a porous substrate. In an embodiment, the substrate comprises an ion-exchange resin or an ion-exchange membrane. A person skilled in the art would readily be able to select a suitable ion-exchange resin or ion-exchange membrane. In an embodiment, the ion-exchange resin or ion-exchange membrane comprises cationic functional groups. In an embodiment, the substrate comprises a PFAS specific resin or a PFAS specific membrane (e.g., comprises a complex amino functional group or alternative suitable functional groups such as a tributyl amine group). A person skilled in the art would be able to readily select a suitable PFAS specific membrane or resin. For example, Purofine™ A694E and Purolite™ A592 are examples of commercially available PFAS specific resins having complex amino functional groups, and AmberLite™ PSR2 Plus ion exchange resin is one example of a commercially available PFAS specific resin with tri-n-butyl amine functional groups. In an embodiment, the substrate comprises a polymeric resin comprising a quaternary ammonium functional group or a multi-alkylamine such as a trialkylamine (e.g., tributylamine) functional group or a polymeric membrane comprising a quaternary ammonium functional group or a multi-alkylamine such as a trialkylamine (e.g., tributylamine) functional group. In an embodiment, the substrate comprises a polymeric resin comprising a quaternary ammonium functional group. In an embodiment, the resin comprises a polystyrenic resin or a polyacrylic resin. In another embodiment, the resin comprises a polystyrenic resin. In a further embodiment, the resin comprises a polyacrylic resin. In another embodiment, the substrate comprises a polymeric membrane comprising a quaternary ammonium functional group. In an embodiment, the substrate comprises a polystyrenic resin comprising a quaternary ammonium functional group. In another embodiment, the substrate comprises a polyacrylic resin comprising a quaternary ammonium functional group.

The method for preparing the composite material comprising the nanoparticle and the substrate can be any suitable method which may depend, for example, on the identity and/or the form of the particular substrate. In an embodiment, the method comprises combining the nanoparticle with the desired substrate such that the nanoparticle is deposited onto a surface of the substrate and/or incorporated into a network (e.g., porous) structure of the substrate. In another embodiment, the addition is carried out at a pH of about 2 to about 8, about 5 to about 8 or about 3 to about 6. In an embodiment, the method comprises preparation of the composite material without isolation of the nanoparticles. For example, in an embodiment, the method comprises combining the polyphenol-containing natural material (e.g., in the form of a polyphenol-containing extract from the natural material) with the metal salt for a suitable time and temperature followed by addition of the composite material then allowing the deposition of the nanoparticles onto the surface and/or incorporation into the network structure to proceed for a suitable time and at a suitable temperature to prepare the composite material. The nature of the nanoparticles deposited onto the surface of the substrate and/or incorporated into the network structure of the substrate may be varied depending on the time. For example, selecting a longer time may result in the formation of larger nanoparticles. In an embodiment, the polyphenol-containing natural material (e.g., in the form of a polyphenol-containing extract from the natural material) and the metal salt are combined in an aqueous solution or suspension for a time of about 10 seconds to about 1 hour or about 30 seconds at ambient temperature (e.g., about 4° C. to about 40° C. or about 20° C. to about 25° C.) followed by addition of the composite material then the deposition of the nanoparticles onto the surface and/or incorporation into the network structure allowed to proceed for a time of about 1 hours to about 2 days, about 16 hours to about 32 hours or about 24 hours at ambient temperature (e.g., about 4° C. to about 40° C. or about 20° C. to about 25° C.), optionally while agitating (e.g., mixing) at a suitable rate, for example, from about 50 rpm to about 200 rpm or about 150 rpm. In an embodiment, the nanoparticles are deposited onto the surface and/or incorporated into the network structure in the form of a film coating comprising the nanoparticles. In a further embodiment, subsequent to deposition and/or incorporation, the method further comprises removing excess solvent by any suitable means (e.g., via filtration) followed by washing with a suitable solvent (e.g., water, methanol or a mixture of water and methanol) and drying by any suitable method and/or means (e.g., under ambient conditions, by a method comprising vacuum filtration or combinations thereof).

In an embodiment, the ratio of nanoparticles to the substrate is no more than 200 mg nanoparticles over 1000 mg of substrate. In another embodiment, the ratio of nanoparticles to the substrate is no more than 25 mg nanoparticles over 1000 mg of substrate. In an embodiment, the ratio of nanoparticles to the substrate is no more than 10 mg nanoparticles over 1000 mg of substrate. In another embodiment, the ratio of nanoparticles to the substrate is no more than 7 mg nanoparticles over 1000 mg of substrate.

In an embodiment, the nanoparticles are raw; i.e., are not in a composite material.

In an embodiment, the environmental contaminant comprises PFAS, natural organic matter or combinations thereof. In another embodiment, the environmental contaminant comprises PFAS. In another embodiment, the environmental contaminant comprises anionic PFAS, cationic PFAS, neutral and zwitterionic PFAS or combinations thereof. In an embodiment, the PFAS comprises at least one zwitterionic PFAS. In an embodiment, the environmental contaminant comprises a long chain perfluorocarboxylic acid, a short chain perfluorocarboxylic acid, a long chain perfluoroalkane sulfonic acid, a short chain perfluoroalkane sulfonic acid, GenX™, a fluorotelomer sulfonic acid (betaine) or combinations thereof.

In an embodiment, the media comprises air, a liquid, a solid, a gel, a slurry or combinations thereof. In another embodiment, the media comprises water. In another embodiment, the water is drinking water. In another embodiment, the water is groundwater. In another embodiment, the water is groundwater, wastewater (e.g., municipal wastewater, industrial wastewater or combinations thereof), a regenerant concentrate, from reverse osmosis or a brine. In a further embodiment, the media comprises soil, an adsorbent, consumer products, biosolids (e.g., wastewater biosolids) or combinations thereof.

In an embodiment, subsequent to contacting, the method further comprises separating the nanoparticle from the media. A person skilled in the art would readily appreciate that the separation will depend, for example, on the environmental contaminant, the media and/or the form of the nanoparticle (e.g., raw or in the composite material) and could readily select a suitable method and/or means for separating. For example, in embodiments wherein the nanoparticle is in a composite material comprising the nanoparticle and a substrate that is in the form of a membrane and the contacting comprises passing the media (e.g., water) through the membrane, or the nanoparticle is in a composite material comprising the nanoparticle and a substrate that is in the form of a resin and the contacting comprising passing the media (e.g., water) through the resin housed in a suitable vessel, e.g. a column, no additional means for separation may be required. Alternatively, in embodiments wherein the contacting is carried out in a free solution or suspension, suitable means such as filtration may be used.

In an embodiment, the nanoparticle is in the composite material comprising the nanoparticle and a substrate and the method further comprises regenerating the composite material. The term “regenerating” and the like as used herein in reference to regenerating the composite material includes methods comprising recovery of the environmental contaminant from the composite material and/or methods wherein at least a portion of the environmental contaminant is broken down into smaller by-products and/or destroyed (e.g., defluorinated) via the method used for the regeneration. Any suitable method for regenerating the composite material can be used, the selection of which can be made by a person skilled in the art. In an embodiment, the method comprises regenerating the composite material with an aqueous solution comprising an inorganic salt, inorganic acid, inorganic base, organic solvent or combinations thereof to obtain a regenerated composite material and a regeneration concentrate comprising the environmental contaminant and/or by-products thereof. The organic solvent can be any suitable organic solvent or combinations thereof. In another embodiment, the composite material is regenerated with an aqueous solution comprising an inorganic salt, inorganic acid, inorganic base or combinations thereof to obtain a regenerated composite material and an aqueous regeneration concentrate comprising the environmental contaminant and/or by-products thereof. In such embodiments, the inorganic salt, inorganic acid, inorganic base or combinations thereof can be any suitable inorganic salt, inorganic acid, inorganic base or combinations thereof, the selection of which can be made by a person skilled in the art. In an embodiment, the inorganic salt, inorganic acid, inorganic base or combinations thereof comprises an inorganic chloride (e.g. sodium, potassium and/or calcium chloride), an inorganic hydroxide (e.g., sodium, potassium and/or calcium hydroxide), an inorganic sulfite (e.g., sodium, potassium and/or calcium sulfite), an inorganic sulfate (e.g., sodium, potassium and/or calcium sulfate), an inorganic bicarbonate (e.g., sodium, potassium and/or calcium bicarbonate), hydrochloric acid, or combinations thereof. In another embodiment, the inorganic salt, inorganic acid, inorganic base or combinations thereof comprises sodium chloride, sodium hydroxide, sodium sulfite, sodium sulfate, sodium bicarbonate, hydrochloric acid, or combinations thereof. In another embodiment, the inorganic salt, inorganic acid, inorganic base or combinations thereof comprises sodium chloride or sodium sulfite. In another embodiment, the inorganic salt, inorganic acid, inorganic base or combinations thereof comprises sodium sulfite. In another embodiment, the inorganic salt, inorganic acid, inorganic base or combinations thereof comprises a source of sulfate radical. The term “source of sulfate radical” as used herein refers to a compound such as but not limited to sodium persulfate that, when subjected to suitable conditions (e.g., photolysis, thermolysis, electrolysis or other suitable conditions) is capable of forming a sulfate radical. In an embodiment, the inorganic salt, inorganic acid, inorganic base or combinations thereof comprises a sulfite salt, a sulfate salt or combinations thereof.

In an embodiment, the method further comprises treatment of the regeneration concentrate to degrade and/or destroy the environmental contaminant and/or by-products thereof. In some embodiments, at least a portion of the environmental contaminant and/or by-products thereof remain in the contacted media. Accordingly, in an embodiment, subsequent to contacting, the method further comprises treatment of the contacted media to degrade and/or destroy remaining environmental contaminant and/or by-products thereof. The term “degrade” as used herein with respect to such treatment refers to breaking down the environmental contaminant and/or by-products thereof into smaller by-products, optionally wherein the smaller by-products are non-toxic. The term “destroy” as used herein with respect to such treatment refers to a process such as PFAS defluorination in which the final form no longer contains smaller by-products of the original structure e.g., the PFAS is mineralized. The treatment can comprise any suitable treatment, the selection of which can be made by a person skilled in the art having reference to the present disclosure. In an embodiment, the treatment comprises a thermal, electrochemical and/or ultraviolet process, the selection of which can be readily made by a person skilled in the art. In an embodiment, the environmental contaminant comprises PFAS and/or by-products thereof and the treatment comprises defluorination. In an embodiment, the treatment comprises treatment with ultraviolet light or an electrochemical process. In another embodiment, the treatment comprises treatment with ultraviolet light. In another embodiment, the treatment comprises treatment with an electrochemical process. In another embodiment, the environmental contaminant comprises PFAS or by-products thereof and the treatment comprises contact with a nanoparticle prepared from a polyphenol-containing natural material and a metal salt as described herein alone, or optionally together with another means of defluorination such as a thermal, electrochemical and/or ultraviolet process.

In an embodiment, the method further comprises recycling the regenerated composite material for use in contacting a further portion of media comprising the environmental contaminant. In an embodiment, the method comprises a plurality of cycles of contacting and regeneration, e.g., 2, 3, 4, 5, 6, 7, 8, 9, 10 or more cycles.

In an embodiment, prior to contacting the media comprising the environmental contaminant with the nanoparticle, the method comprises oxidizing the environmental contaminant. It will be appreciated by a person skilled in the art that the conditions for oxidation may depend, for example, on the nature of the environmental contaminant and/or the media but suitable conditions can be readily selected by a person skilled in the art. In some embodiments, wherein the environmental contaminant comprises certain PFAS (e.g., zwitterionic and/or cationic PFAS), the oxidizing comprises contacting the media with raw nanoparticles prepared from a polyphenol-containing natural material and a metal salt as described herein. This could be optionally carried out, for example, in such embodiments prior to contacting, for example, with a nanoparticle prepared from a polyphenol-containing natural material and a metal salt as described herein in the form of a composite material as described herein.

It will be appreciated by a person skilled in the art that in some embodiments, depending, for example, on the nature of the media and/or the environmental contaminant, the method may also comprise optional additional methods and/or means to remove at least a portion, optionally all of certain environmental contaminants prior to contacting the media comprising the remaining environmental contaminants with the nanoparticle and optionally the oxidation of the remaining environmental contaminants. Such methods and/or means are well known in the art and may include, for example, separation (by any suitable methods and/or means e.g., filtration) of particles above a certain size (e.g., above about 5 microns) from the media and/or removal of at least a portion of dissolved organic matter (by any suitable methods and/or means e.g., contact with a suitable absorbent such as passing the media through a suitable column).

It will be also appreciated by a person skilled in the art that the contacting the media comprising the environmental contaminant with the nanoparticle may depend, for example, on the environmental contaminant, the media and/or the form of the nanoparticle (e.g., raw or in the composite material) and a suitable method and/or means for contacting could be readily selected by the skilled person. In an embodiment, the method is continuous. For example, such continuous methods can include but are not limited to embodiments wherein the nanoparticle is in a composite material comprising the nanoparticle and a substrate that is in the form of a membrane and the contacting comprises passing the media (e.g., a liquid media such as water) through the membrane or wherein the nanoparticle is in a composite material comprising the nanoparticle and a substrate that is in the form of a resin and the contacting comprises passing the media (e.g., a liquid media such as water) through the resin in a suitable vessel (e.g., a column) housing the resin. However, embodiments wherein the method is semi-continuous or batch may also be included in the methods of removing an environmental contaminant from media of the present disclosure. For example, in an embodiment the contacting comprises providing the media to a vessel containing the nanoparticle (optionally in the composite material comprising the nanoparticle and a substrate) or providing the nanoparticle (optionally in the composite material comprising the nanoparticle and a substrate) to a vessel comprising the media. In another embodiment (e.g., in certain embodiments wherein the media comprises a resin saturated with the environmental contaminant or a biosolid comprising the environmental contaminant) the contacting comprises coating the media with the nanoparticles. The time for contact of the media comprising the environmental contaminant with the nanoparticle (optionally in the composite material comprising the nanoparticle and the substrate) may depend, for example, on the nature of the environmental contaminant, the nature of the nanoparticle (including, for example, the form of the substrate, if present) and/or the nature of the method (e.g., continuous, semi-continuous or batch) but can be selected by a person skilled in the art having regard to the present disclosure. In an embodiment, the duration of contact of the media with the nanoparticle (optionally in the composite material comprising the nanoparticle and a substrate) is no more than 2 hours. In another embodiment, the duration of contact with the nanoparticle (optionally in the composite material comprising the nanoparticle and a substrate) is less than 30, less than 20, less than 10, less than 5 or less than 3 minutes.

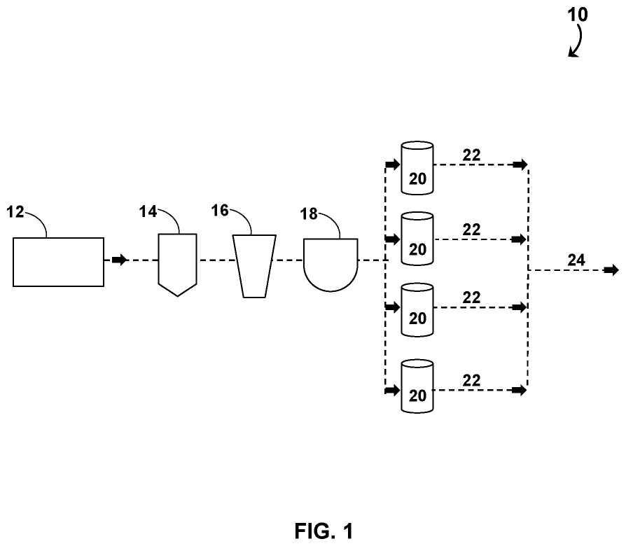

FIG. 1 shows a schematic of an embodiment of a method 10 of removing an environmental contaminant from media comprising the environmental contaminant of the present disclosure. Referring to FIG. 1, in the method 10 shown therein, the media 12 comprises water (e.g., groundwater) which is optionally filtered 14 (e.g., via a method comprising a bag filter) to remove particles above a certain size prior to optional removal 16 of dissolved organic matter and optional oxidation 18 of the environmental contaminant. In the embodiment of the method 10 shown in FIG. 1 the nanoparticle (prepared from the polyphenol-containing natural material and the metal salt) is in a composite material comprising the nanoparticle and a substrate that is in the form of a resin and the media is contacted 20 with the nanoparticle prepared from the polyphenol-containing natural material and a metal salt by a method comprising passing the media through the resin in a suitable vessel housing the resin such as a column. In the embodiment of the method 10 shown in FIG. 1, the media is contacted 20 with the nanoparticle in four parallel streams. However, it will be appreciated by a person skilled in the art that in other embodiments, a different number of streams (e.g., a single stream or other numbers of multiple streams) may be used and alternative methods of contacting 20 the media with the nanoparticle are contemplated. The method optionally includes additional treatment 22 of the media subsequent to contact 20 and prior to discharge 24 e.g., to degrade and/or destroy remaining environmental contaminant and/or by-products thereof.

The application of anionic organic scavenger ion exchange (IX) resins (A860), nonionic IX resins (XAD4 and XAD7), PFAS-specific resins (A694 and A592) and Ti₃C₂ MXenes (two-dimensional metal carbides) for the removal of select fluorotelomer Z-PFAS from natural waters was investigated. The cumulative removal of Z-PFAS at pH about 7 follows the order: Ti₃C₂ MXenes>A694>A592>A860>XAD4˜XAD7. Finally, treatment with about 180 J/cm² UV dosage in the 4 mM Na₂SO₃ regenerant brine solution yielded >99.9% reduction in the Z-PFAS concentration indicating that UV-sulfite systems exhibit promising potential for the treatment of Z-PFAS regenerants.

Accordingly, the present disclosure also includes a method of removing a zwitterionic PFAS from media comprising the zwitterionic PFAS, the method comprising:
contacting the media comprising the zwitterionic PFAS with a MXene.

In an embodiment, the MXene comprises Ti₃C₂ MXene.

In an embodiment, the MXene is in a composite material comprising the MXene and a substrate. The substrate can comprise any suitable substrate. In an embodiment, the substrate comprises sand, gravel, clay, hydrogel, carbon (e.g., activated carbon), mined material, sediment, polymer, a metal organic framework, a zeolite, a biomaterial (e.g., chitosan) or combinations thereof. In an embodiment, the substrate is a porous substrate. In an embodiment, the substrate comprises an ion-exchange resin or an ion-exchange membrane. A person skilled in the art would readily be able to select a suitable ion-exchange resin or ion-exchange membrane. In an embodiment, the ion-exchange resin or ion-exchange membrane comprises cationic functional groups. In an embodiment, the substrate comprises a PFAS specific resin or a PFAS specific membrane (e.g., comprises a complex amino functional group or alternative suitable functional groups such as a tributyl amine group). A person skilled in the art would be able to readily select a suitable PFAS specific membrane or resin. For example, Purofine™ A694E and Purolite™ A592 are examples of commercially available PFAS specific resins having complex amino functional groups, and AmberLite™ PSR2 Plus ion exchange resin is one example of a commercially available PFAS specific resin with tri-n-butyl amine functional groups. In an embodiment, the substrate comprises a polymeric resin comprising a quaternary ammonium functional group or a multi-alkylamine such as a trialkylamine (e.g., tributylamine) functional group or a polymeric membrane comprising a quaternary ammonium functional group or a multi-alkylamine such as a trialkylamine (e.g., tributylamine) functional group. In an embodiment, the substrate comprises a polymeric resin comprising a quaternary ammonium functional group. In an embodiment, the resin comprises a polystyrenic resin or a polyacrylic resin. In another embodiment, the resin comprises a polystyrenic resin. In a further embodiment, the resin comprises a polyacrylic resin. In another embodiment, the substrate comprises a polymeric membrane comprising a quaternary ammonium functional group. In an embodiment, the substrate comprises a polystyrenic resin comprising a quaternary ammonium functional group. In another embodiment, the substrate comprises a polyacrylic resin comprising a quaternary ammonium functional group.

In an embodiment, the MXene or the composite comprising the MXene further comprises a plurality of nanoparticles. In an embodiment, the nanoparticles are nanoparticles prepared from a polyphenol-containing natural material and a metal salt as described herein.

In another embodiment, the MXene is raw; i.e. is not in the form of a composite comprising the MXene and does not further comprise the plurality of nanoparticles.

In an embodiment, the media further comprises an additional environmental contaminant. In another embodiment, the additional environmental contaminant comprises anionic, cationic and/or neutral PFAS, natural organic matter or combinations thereof.

In an embodiment, the media comprises air, a liquid, a solid, a gel, a slurry or combinations thereof. In another embodiment, the media comprises water. In another embodiment, the water is drinking water. In another embodiment, the water is groundwater. In another embodiment, the water is groundwater, wastewater (e.g., municipal wastewater, industrial wastewater or combinations thereof), a regenerant concentrate, from reverse osmosis or a brine. In a further embodiment, the media comprises soil, an adsorbent, consumer products, biosolids (e.g., wastewater biosolids) or combinations thereof.

In an embodiment, subsequent to contacting, the method further comprises separating the MXene from the media. A person skilled in the art would readily appreciate that the separation will depend, for example, on the media and/or the form of the MXene (e.g., raw or in the composite material) and could readily select a suitable method and/or means for separating. For example, in embodiments wherein the MXene is in a composite material comprising the MXene and a substrate that is in the form of a membrane and the contacting comprises passing the media (e.g., water) through the membrane, or the MXene is in a composite material comprising the MXene and a substrate that is in the form of a resin and the contacting comprising passing the media (e.g., water) through the resin housed in a suitable vessel, e.g. a column no additional means for separation may be required. Alternatively, in embodiments wherein the contacting is carried out in a free solution or suspension, suitable means such as filtration may be used.

In an embodiment, method further comprises regenerating the MXene (optionally in the composite material). The term “regenerating” and the like as used herein in reference to regenerating the MXene (optionally in the composite material) includes methods comprising recovery of the zwitterionic PFAS (and optionally the additional environmental contaminant) from the MXene/composite material and/or methods wherein at least a portion of the zwitterionic PFAS (and optionally the additional environmental contaminant) is broken down into smaller by-products and/or destroyed (e.g., defluorinated) via the method used for the regeneration. Any suitable method for regeneration can be used, the selection of which can be made by a person skilled in the art. In an embodiment, method comprises regenerating the MXene (optionally in the composite material) with an aqueous solution comprising an inorganic salt, inorganic acid, inorganic base, organic solvent or combinations thereof to obtain a regenerated MXene (optionally in the composite material) and regeneration concentrate comprising the zwitterionic PFAS (and optionally the additional environmental contaminant) and/or by-products thereof. The organic solvent can be any suitable organic solvent or combinations thereof. In another embodiment, the MXene (optionally in the composite material) is regenerated with an aqueous solution comprising an inorganic salt, inorganic acid, inorganic base or combinations thereof to obtain a regenerated MXene (optionally in the composite material) and an aqueous regeneration concentrate comprising the zwitterionic PFAS (and optionally the additional environmental contaminant) and/or by-products thereof. In such embodiments, the inorganic salt, inorganic acid, inorganic base or combinations thereof can be any suitable inorganic salt, inorganic acid, inorganic base or combinations thereof, the selection of which can be made by a person skilled in the art. In an embodiment, the inorganic salt, inorganic acid, inorganic base or combinations thereof comprises an inorganic chloride (e.g. sodium, potassium and/or calcium chloride), an inorganic hydroxide (e.g., sodium, potassium and/or calcium hydroxide), an inorganic sulfite (e.g., sodium, potassium and/or calcium sulfite), an inorganic sulfate (e.g., sodium, potassium and/or calcium sulfate), an inorganic bicarbonate (e.g., sodium, potassium and/or calcium bicarbonate), hydrochloric acid, or combinations thereof. In an embodiment, the inorganic salt, inorganic acid, inorganic base or combinations thereof comprises sodium chloride, sodium hydroxide, sodium sulfite, sodium sulfate, sodium bicarbonate, hydrochloric acid, or combinations thereof. In another embodiment, the inorganic salt, inorganic acid, inorganic base or combinations thereof comprises sodium chloride or sodium sulfite. In another embodiment, the inorganic salt, inorganic acid, inorganic base or combinations thereof comprises sodium sulfite. In another embodiment, the inorganic salt, inorganic acid, inorganic base or combinations thereof comprises a source of sulfate radical. The term “source of sulfate radical” as used herein refers to a compound such as but not limited to sodium persulfate that, when subjected to suitable conditions (e.g., photolysis, thermolysis, electrolysis or other suitable conditions) is capable of forming a sulfate radical. In an embodiment, the inorganic salt, inorganic acid, inorganic base or combinations thereof comprises a sulfite salt, a sulfate salt or combinations thereof.

In an embodiment, the method further comprises treatment of the regeneration concentrate to degrade and/or destroy the zwitterionic PFAS (and optionally the additional environmental contaminant) and/or by-products thereof. In some embodiments, at least a portion of the zwitterionic PFAS (and optionally the additional environmental contaminant) and/or by-products thereof remain in the contacted media. Accordingly, in an embodiment, subsequent to contacting, the method further comprises treatment of the contacted media to degrade and/or destroy remaining zwitterionic PFAS and optionally additional environmental contaminant (e.g., an additional environmental contaminant comprising anionic, cationic and/or neutral PFAS). The term “degrade” as used herein with respect to such treatment refers to breaking down the zwitterionic PFAS (and optionally the additional environmental contaminant) and/or by-products thereof into smaller by-products, optionally wherein the smaller by-products are non-toxic. The term “destroy” as used herein with respect to such treatment refers to a process such as PFAS defluorination in which the final form no longer contains smaller by-products of the original structure e.g., the PFAS is mineralized. The treatment can comprise any suitable treatment, the selection of which can be made by a person skilled in the art having reference to the present disclosure. In an embodiment, the treatment comprises a thermal, electrochemical and/or ultraviolet process, the selection of which can be readily made by a person skilled in the art. In another embodiment, the treatment comprises defluorination. In an embodiment, the treatment comprises treatment with ultraviolet light or an electrochemical process. In another embodiment, the treatment comprises treatment with ultraviolet light. In another embodiment, the treatment comprises treatment with an electrochemical process. In another embodiment, the treatment comprises contact with a nanoparticle prepared from a polyphenol-containing natural material and a metal salt as described herein alone, or optionally together with another means of defluorination such as a thermal, electrochemical and/or ultraviolet process.

In an embodiment, the method further comprises recycling the regenerated MXene (optionally in the composite material) for use in contacting a further portion of media comprising the zwitterionic PFAS. In an embodiment, the method comprises a plurality of cycles of contacting and regeneration, e.g., 2, 3, 4, 5, 6, 7, 8, 9, 10 or more cycles.

In an embodiment, prior to contacting the media comprising the zwitterionic PFAS (and optionally the additional environmental contaminant) with the MXene, the method comprises oxidizing the zwitterionic PFAS (and optionally the additional environmental contaminant, e.g., where the additional environmental contaminant comprises a cationic PFAS). It will be appreciated by a person skilled in the art that the conditions for oxidation may depend, for example, on the nature of the zwitterionic PFAS (and optionally the additional environmental contaminant) and/or the media but suitable conditions can be readily selected by a person skilled in the art. In some embodiments, the oxidizing comprises contacting the media with raw nanoparticles prepared from a polyphenol-containing natural material and a metal salt as described herein. This could be optionally carried out, for example, in such embodiments prior to contacting, for example, with MXene in the form of a composite material as described herein.

It will be appreciated by a person skilled in the art that in some embodiments, depending, for example, on the nature of the media and/or the nature of any additional environmental contaminants, the method may also comprise optional additional methods and/or means to remove at least a portion, optionally all of certain environmental contaminants prior to contacting the media with the MXene and optionally the oxidation. Such methods and/or means are well known in the art and may include, for example, separation (by any suitable methods and/or means e.g., filtration) of particles above a certain size (e.g., above about 5 microns) from the media and/or removal of at least a portion of dissolved organic matter (by any suitable methods and/or means e.g., contact with a suitable absorbent such as passing the media through a suitable column).

It will be also appreciated by a person skilled in the art that the contacting the media comprising the zwitterionic PFAS with the MXene may depend, for example, on the media, the nature of any additional environmental contaminants and/or the form of the MXene (e.g., raw or in the composite material) and a suitable method and/or means for contacting could readily be selected by the skilled person. In an embodiment, the method is continuous. For example, such continuous methods can include but are not limited to embodiments wherein the MXene is in a composite material comprising the MXene (and optionally the nanoparticles) and a substrate that is in the form of a membrane and the contacting comprises passing the media (e.g., a liquid media such as water) through the membrane or embodiments wherein the MXene is in a composite material comprising the MXene (and optionally the nanoparticles) and a substrate that is in the form of a resin and the contacting comprises passing the media (e.g., a liquid media such as water) through the resin in a suitable vessel (e.g., a column) housing the resin. However, embodiments wherein the method is semi-continuous or batch may also be included in the methods of removing a zwitterionic PFAS from media comprising the zwitterionic PFAS of the present disclosure. For example, in an embodiment the contacting comprises providing the media to a vessel containing the MXene (optionally in the composite material and/or comprising the nanoparticles) or providing the MXene (optionally in the composite material and/or comprising the nanoparticles) to a vessel comprising the media. The time for contact of the media comprising the zwitterionic PFAS with the MXene may depend, for example, on the nature of the zwitterionic PFAS (and optionally the additional environmental contaminant, if present), the nature of the MXene (including, for example, the form of the substrate, if present and/or the presence of nanoparticles) and/or the nature of the method (e.g., continuous, semi-continuous or batch) but can be selected by a person skilled in the art having regard to the present disclosure. In an embodiment, the duration of contact of the media with the MXene (optionally in the composite material and/or comprising the nanoparticles) is no more than 2 hours. In another embodiment, the duration of contact with the MXene (optionally in the composite material and/or comprising the nanoparticles) is less than 30, less than 20, less than 10, less than 5 or less than 3 minutes.

### III. Method of Preparing Composites, Composites and Uses

The present disclosure also includes a method of preparing a composite material, the method comprising:
preparing a nanoparticle from a polyphenol-containing natural material and a metal salt; and
combining the nanoparticle with a substrate.

The polyphenol-containing natural material can be any suitable polyphenol-containing natural material. In an embodiment, the polyphenol-containing natural material is a polyphenol-containing plant material, a polyphenol-containing animal material, a polyphenol-containing algal material, a polyphenol-containing fungal material or combinations thereof. In another embodiment, the polyphenol-containing natural material is a polyphenol-containing plant material. It will be appreciated by a person skilled in the art that the occurrence of the polyphenol in the natural material such as the plant material may depend, for example, on the identity of the polyphenol and/or the natural material e.g., the plant material. In an embodiment, the polyphenol-containing plant material is a polyphenol-containing fruit, bark, leaf, vegetable, grain or combinations thereof. In an embodiment, the polyphenol-containing natural material is a fruit. In another embodiment, the polyphenol-containing fruit is of Cyanococcus, Fragaria spp., Rubus spp., Phyllanthus emblica or combinations thereof. In a further embodiment, the polyphenol-containing fruit is of Phyllanthus emblica. In an embodiment, the polyphenol-containing natural material comprises Phyllanthus emblica fruit powder. In another embodiment, the polyphenol-containing plant material is a polyphenol-containing tree material such as bark, leaves or combinations thereof. In another embodiment, the polyphenol-containing tree material is of Moringa oleifera, Mangifera indica or combinations thereof. In another embodiment, the polyphenol-containing plant material is a polyphenol-containing containing vegetable material. In an embodiment, the polyphenol-containing vegetable material is of a chili pepper. In another embodiment, the polyphenol-containing plant material is a grain. The polyphenol-containing natural material can be in any suitable form, the selection of which can readily be made by a person skilled in the art. In an embodiment, the polyphenol-containing natural material is in the form of a powder. The preparation of the nanoparticle from the polyphenol-containing natural material and the metal salt can comprise any suitable method. In an embodiment, the preparation of the nanoparticle comprises combining the polyphenol-containing natural material in the form of a polyphenol-containing extract from the natural material with the metal salt. The polyphenol-containing extract can be prepared from the polyphenol-containing natural material by any suitable method, which may depend, for example, on the particular polyphenol-containing natural material and/or its form, but the selection of which can nevertheless be readily made by a person skilled in the art. In an embodiment, the polyphenol-containing natural material is in the form of a polyphenol-containing extract prepared by contacting the polyphenol-containing natural material (e.g., in powdered form) with water for a time (e.g., about 5 minutes to about 12 hours or about 30 minutes to about 2 hours or about 1 hour) and at a temperature (e.g., at ambient temperature such as at about 4° C. to about 40° C. or about 20° C. to about 25° C.) suitable for extraction of the polyphenols into the water to proceed to a sufficient extent (e.g., greater than about 5, 10, 15, 20, 25, 30, 35, 40, 45, 50, 55, 60, 65, 70, 75, 80, 85, 90, 95 or 100% of the polyphenols are extracted into the water), optionally while agitating (e.g., mixing) at a suitable rate, for example, from about 500 rpm to about 1,500 rpm or about 1,000 rpm.

The metal salt can be any suitable salt. For example, it would be appreciated by a person skilled in the art that the combination of the metal in the metal salt and the counteranion (or combination thereof) may depend, for example, on the identity of the particular metal and counteranion (or combination thereof). It will also be appreciated by a person skilled in the art that the metal salt can be in any suitable hydrated form. In an embodiment, the metal salt is a metal nitrate, sulfate, chloride or combination thereof. In another embodiment, the metal salt is a metal sulfate, chloride or combination thereof. In another embodiment, the metal salt is a metal sulfate. In another embodiment, the metal salt is a metal chloride. In an embodiment, the metal of the metal salt is iron, silver, gold or combinations thereof. In another embodiment, the metal of the metal salt is iron. In another embodiment, the metal salt comprises ferric sulfate, ferric chloride, auric chloride or silver nitrate. In another embodiment, the metal salt comprises HAuCl₄ or FeCl₃. In a further embodiment, the metal salt comprises FeCl₃. In a further embodiment, the metal salt comprises FeSO₄. In another embodiment, the metal salt is FeSO₄·7H₂O.

The substrate can comprise any suitable substrate. In an embodiment, the substrate comprises a high surface area inorganic substrate. In another embodiment, the substrate comprises sand, gravel, clay, hydrogel, carbon (e.g., activated carbon), mined material, sediment, polymer, a metal organic framework, a zeolite, MXene, a biomaterial (e.g., chitosan) or combinations thereof. In an embodiment, the MXene is a Ti₃C₂ MXene. In an embodiment, the substrate is a porous substrate. In an embodiment, the substrate comprises an ion-exchange resin or an ion-exchange membrane. A person skilled in the art would readily be able to select a suitable ion-exchange resin or ion-exchange membrane. In an embodiment, the ion-exchange resin or ion-exchange membrane comprises cationic functional groups. In an embodiment, the substrate comprises a PFAS specific resin or a PFAS specific membrane (e.g., comprises a complex amino functional group or alternative suitable functional groups such as a tributyl amine group). A person skilled in the art would be able to readily select a suitable PFAS specific membrane or resin. For example, Purofine™ A694E and Purolite™ A592 are examples of commercially available PFAS specific resins having complex amino functional groups, and AmberLite™ PSR2 Plus ion exchange resin is one example of a commercially available PFAS specific resin with tri-n-butyl amine functional groups. In an embodiment, the substrate comprises a polymeric resin comprising a quaternary ammonium functional group or a multi-alkylamine such as a trialkylamine (e.g., tributylamine) functional group or a polymeric membrane comprising a quaternary ammonium functional group or a multi-alkylamine such as a trialkylamine (e.g., tributylamine) functional group. In an embodiment, the substrate comprises a polymeric resin comprising a quaternary ammonium functional group. In another embodiment, the substrate comprises a polymeric membrane comprising a quaternary ammonium functional group. In an embodiment, the resin comprises a polystyrenic resin or a polyacrylic resin. In another embodiment, the resin comprises a polystyrenic resin. In a further embodiment, the resin comprises a polyacrylic resin. In an embodiment, the substrate comprises a polystyrenic resin comprising a quaternary ammonium functional group. In another embodiment, the substrate comprises a polyacrylic resin comprising a quaternary ammonium functional group.

The conditions for combining the nanoparticles with the substrate can comprise any suitable conditions which may depend, for example, on the identity and/or the form of the particular substrate. In an embodiment, the method comprises combining the nanoparticles with the desired substrate such that the nanoparticles are deposited onto a surface of the substrate and/or incorporated into a network (e.g., porous) structure of the substrate. In another embodiment, the addition is carried out at a pH of about 2 to about 8, about 5 to about 8 or about 3 to about 6. In an embodiment, the method comprises preparation of the composite material without isolation of the nanoparticles. For example, in an embodiment, the method comprises combining the polyphenol-containing natural material (e.g., in the form of a polyphenol-containing extract from the natural material) with the metal salt for a suitable time and temperature followed by addition of the composite material then allowing the deposition of the nanoparticles onto the surface and/or incorporation into the network structure to proceed for a suitable time and at a suitable temperature to prepare the composite material. The nature of the nanoparticles deposited onto the surface of the substrate and/or incorporated into the network structure of the substrate may be varied depending on the time. For example, selecting a longer time may result in the formation of larger nanoparticles. In an embodiment, the polyphenol-containing natural material (e.g., in the form of a polyphenol-containing extract from the natural material) and the metal salt are combined in an aqueous solution or suspension for a time of about 10 seconds to about 1 hour or about 30 seconds at ambient temperature (e.g., about 4° C. to about 40° C. or about 20° C. to about 25° C.) followed by addition of the composite material then the deposition of the nanoparticles onto the surface and/or incorporation into the network structure allowed to proceed for a time of about 1 hours to about 2 days, about 16 hours to about 32 hours or about 24 hours at ambient temperature (e.g., about 4° C. to about 40° C. or about 20° C. to about 25° C.), optionally while agitating (e.g., mixing) at a suitable rate, for example, from about 50 rpm to about 200 rpm or about 150 rpm. In an embodiment, the nanoparticles are deposited onto the surface and/or incorporated into the network structure in the form of a film coating comprising the nanoparticles. In a further embodiment, subsequent to deposition and/or incorporation, the method further comprises removing excess solvent by any suitable means (e.g., via filtration) followed by washing with a suitable solvent (e.g., water, methanol or a mixture of water and methanol) and drying by any suitable method and/or means (e.g., under ambient conditions, by a method comprising vacuum filtration or combinations thereof).

In an embodiment, the ratio of nanoparticles to the substrate is no more than 200 mg nanoparticles over 1000 mg of substrate. In another embodiment, the ratio of nanoparticles to the substrate is no more than 25 mg nanoparticles over 1000 mg of substrate. In another embodiment, the ratio of nanoparticles to the substrate is no more than 10 mg nanoparticles over 1000 mg of substrate. In another embodiment, the ratio of nanoparticles to the substrate is no more than 7 mg nanoparticles over 1000 mg of substrate.

The present disclosure also includes a composite material prepared by a method of preparing a composite material as described herein. It will be appreciated by a person skilled in the art that embodiments of such composite materials can be varied, as appropriate, as described herein for the methods of preparing such composite materials as described herein. The present disclosure also includes a use of such a composite material for removal of an environmental contaminant from media comprising the environmental contaminant. The present disclosure also includes a nanoparticle prepared from a polyphenol-containing natural material and a metal salt as described herein for use in removal of an environmental contaminant from media comprising the environmental contaminant. It will be appreciated by a person skilled in the art that embodiments of such uses can be varied, as appropriate, as described herein for the methods of removing an environmental contaminant from media comprising the environmental contaminant as described herein.

### IV. Additional Embodiments

The present disclosure also includes a material for removing per- or poly-fluoroalkyl substances (PFAS) or natural organic matter (NOM) from water comprising a high surface area substrate. In an embodiment, the substrate is chosen from a zeolite, a MXene, MXene-composite, polymeric substrate, resins or combination thereof. In another embodiment, the substrate is Ti₃C₂ MXene. In a further embodiment, the substrate further comprises a plurality of nanoparticles attached to the substrate. In an embodiment, the nanoparticles are iron oxide nanoparticles. In another embodiment, the ratio of nanoparticle to the substrate is no more than 1:10 by weight.

The present disclosure also includes a method of removing per- or poly-fluoroalkyl substances (PFAS) or natural organic matter (NOM) from water by first providing the water to a vessel containing a filtration medium, allowing the water to be in contact with the medium, then separating the treated water from the filtration medium by a filter. In an embodiment, the filtration medium comprises a high surface area inorganic substrate. In another embodiment, the filtration medium comprises MXene. In a further embodiment, the filtration medium further comprises iron oxide nanoparticles that are attached to the substrate. In another embodiment, the PFAS and/or NOM laden filtration medium is subsequently regenerated by contacting it with an aqueous solution containing inorganic salt. In a further embodiment, the PFAS and/or NOM laden regenerant is subsequently exposed to ultraviolet (UV) light to degrade PFAS and/or NOM. In an embodiment, the solution contains either sodium chloride, sodium hydroxide, sodium sulfite, sodium sulfate, sodium bicarbonate, hydrochloric acid, or combination thereof.

The present disclosure also includes a system for removing per- or poly-fluoroalkyl substances (PFAS) or natural organic matter (NOM) in water comprising a vessel with a filtration medium where the water is to be treated, an aqueous salt solution as regenerants of the filtration medium, and a device that emits ultraviolet (UV) radiation to degrade PFAS and/or NOM from PFAS and/or NOM-laden regenerants. In an embodiment, the filtration medium is a high surface area inorganic substrate. In another embodiment, the high surface area inorganic substrate is MXene. In a further embodiment, the high surface area inorganic substrate is Ti₃C₂ MXene. In an embodiment, the substrate is decorated with nanoparticles. In another embodiment, the aqueous salt solution comprises either sodium chloride, sodium hydroxide, sodium sulfite, sodium sulfate, sodium bicarbonate, hydrochloric acid, or combination thereof.

The present disclosure also includes a material for treating water to filter per- or poly-fluoroalkyl substances (PFAS) or natural organic matter (NOM) comprising a porous substrate with a plurality of nanoparticles attached to the substrate. In an embodiment, the nanoparticles comprise iron oxide nanoparticles, gold nanoparticles, silver nanoparticles, or combination thereof. In an embodiment, the nanoparticles are prepared using at least one fruit extract. In another embodiment, the fruit extracts comprising a high gallic acid equivalent. In a further embodiment, the gallic acid equivalent content in the fruit extract is larger than 6 mg/g. In an embodiment, the fruit extract comprises Phyllanthus emblica (PE) extract. In an embodiment, the substrate was chosen from either a polymeric resin or a polymeric hydrogel. The present disclosure also includes a method of treating water using such a material.

The present disclosure also includes a material for removing per- or poly-fluoroalkyl substances (PFAS) or natural organic matter (NOM) from water comprising a high surface area organic substrate with a plurality of nanoparticles attached to the substrate. In an embodiment, the nanoparticles are iron oxide nanoparticles. In an embodiment, the iron oxide nanoparticles are prepared using at least one fruit extract. In another embodiment, the fruit extracts comprising a high gallic acid equivalent. In a further embodiment, the gallic acid equivalent content in the fruit extract is larger than 6 mg/g. In an embodiment, the fruit extract comprises Phyllanthus emblica (PE) extract. In an embodiment, the substrate is a polymeric resin. In an embodiment, the substrate is a polymeric membrane. In an embodiment, the ratio of nanoparticle to the substrate is no more than 10 mg nanoparticles over 1000 mg of resin. In another embodiment, the ratio of nanoparticle to the substrate is no more than 7 mg nanoparticles over 1000 mg of resin. The present disclosure also includes a method of treating water by contacting the water with such a material in a vessel.

The following are non-limiting examples of the present disclosure:

### EXAMPLES

### Example 1

In recent years, emerging classes of zwitterionic per- and polyfluoroalkyl substances (Z-PFAS) have been increasingly detected in aquatic environments. The magnitude of their concentration and increased frequency of detection worldwide raises questions on their inadvertent presence in drinking water and associated health risk. Significant advancements in PFAS removal techniques can directly improve the lives of millions of individuals exposed to contaminated waters worldwide. Scientific knowledge on the identification of treatment technologies to effectively capture such Z-PFAS from contaminated water sources remains largely unknown. The present study examines the zwitterionic PFAS removal capabilities of Ti₃C₂ MXenes. Several Z-PFAS such as fluorotelomer sulfonamidopropyl betaines (6:2/8:2/10:2 FTAB) and fluorotelomer betaines (5:1:2/7:1:2/9:1:2/11:1:2 FTB and 5:3/7:3/9:3 FTB) were tested. Comparative studies were performed with anionic IX resins (such as Purolite A860), nonionic IX resins (such as XAD4 and XAD7) and PFAS-specific resins (such as Purofine PFA694E). The effect of DOM characteristics was evaluated by using standard Suwannee River DOM isolates from the International Humic Substance Society (IHSS). Subsequently, the kinetics of uptake were studied to analyze the rate-controlling steps of zwitterionic PFAS removal. Regeneration and reusability studies were also performed by testing the MXenes over multiple cycles to evaluate optimized operating conditions. Finally, we examined the applicability of ultraviolet (UV)-based advanced reduction processes to degrade zwitterionic PFAS in the harmful regenerant for efficient brine management practices. The results of this study are therefore expected to be of high value for the scientific and engineering community as well as water and wastewater treatment utilities worldwide.

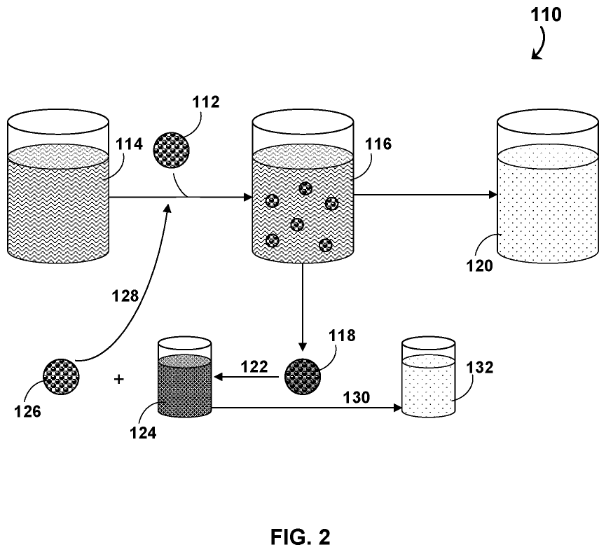

FIG. 2 shows a schematic of an embodiment of a method 110 of the present disclosure. Referring to FIG. 2, porous substrate 112 can be added to contaminated water (e.g., with PFAS) 114. Subsequent to contacting 116 of the contaminated water and porous substrate, the saturated substrate (e.g., with PFAS) 118 can be removed, leaving a first portion of treated water 120. The saturated substrate 118 can be regenerated 122 with salt solution (not shown) to provide regeneration concentrate (e.g., with PFAS) 124 and regenerated (fresh) substrate 126 which can be recycled 128 for use in contacting 116 of the contaminated water. Ultraviolet (UV) treatment 130 of regeneration concentrate 124 can provide a second portion of treated water 132.

### I. Materials and Methods

### (a) Chemicals and Materials

PFAS. High-purity certified standards of 6:2 FTAB (product reference: N-CMAmP-6:2FOSA), 5:1:2 FTB, and 5:3 FTB were obtained from Wellington Labs (Guelph, ON, Canada). Ansulite (3%, Ansul Inc.) AFFF concentrate was donated by the Fire & Emergency Department of a Canadian airport, while the Arctic Foam 203A AFFF concentrate was kindly shared by an anonymous supplier. However, Arctic Foam 203A AFFF is readily available from commercial sources. Negative ion mode isotope-labelled internal standards were obtained from Wellington Labs (Guelph, ON, Canada). Custom-order synthesis N-trimethylammonio propyl perfluorooctaneamide (TAmPr-FOAd, obtained from Beijing Surfactant Institute, Beijing, China) was used as positive ion mode internal standard.

Anionic organic scavenger resin (Purolite® A860, polyacrylic with quaternary ammonium functional groups, capacity: 0.8 meq/mL, 1 mL=221 mg) and PFAS-specific resins (A694E and A592 with complex amino functional group and capacity of 1-1.4 eq/L) were obtained from Purolite® (Bala Cynwyd, PA, USA). Nonionic IX resins such as Amberlite XAD4 and XAD7 were obtained from Sigma Aldrich (Oakville, ON, Canada). Ti₃C₂ MXene was obtained from Nanochemzone Incorporation (Waterloo, ON, Canada) and used as received. Further details on the resin and MXene properties are provided in Table 1 (adsorbent properties). Suwannee River Natural Organic Matter (SRNOM) was obtained from the International Humic Substances Society (St. Paul, MN, USA).

TABLE 1
Particle size distribution, charge density and functional
groups for A860, A592, A694, XAD 4, XAD 7 and Ti₃C₂ MXene.

| | Particle | | Charge | | |
|---|---|---|---|---|---|
| | Diameter | Functional | Density | Density | |
| Pore Size | (μm) | Group | (eq/L) | (g/cm³) | Reference |
| A860 | 750 | Quaternary | 0.8 | about 0.7 | 32 |
| | | ammonium | | | |
| A592 | 750 | Complex | 1-1.2 | about 0.7 | 33 |
| | | Amino | | | |
| A694 | 675 | Complex | 1.2-1.4 | about 0.7 | 34 |
| | | Amino | | | |
| XAD 4 | 400 | — | — | about 0.6 | 35 |
| XAD 7 | 400 | — | — | about 0.6 | 36 |
| Ti₃C₂ | 0.1-2.5 | — | — | 3.6-3.8* | 37, 38, 39 |
| MXene | | | | 3.2** | |

*Reported in the literature.
**Examined in this study.

### (b) Synthetic and Surface Water Preparation

PFAS Stock. All Z-PFAS listed in Table 2 were obtained from Université de Montréal (UdeM) and were used as received at the University of British Columbia.

TABLE 2
Z-PFAS, DOM and inorganic ions concentration for synthetic
water studies and for studies in recycled wastewater.

| Compound | Concentration | |
|---|---|---|
| Cumulative Z-PFAS | 10 ± 0.1 | μg/L |

Synthetic Water Studies

| | | |
|---|---|---|
| SRNOM | 5 ± 0.1 | mg C/L |

Recycled Wastewater

| | | |
|---|---|---|
| DOM | 5.0 ± 0.3 | mg/L |
| Nitrate | 26.1 ± 0.2 | mg/L |
| Phosphate | 10.4 ± 0.3 | mg/L |
| Sulfate | 32.3 ± 0.5 | mg/L |

The aqueous stock mixture of FTABs and FTBs was prepared to target an approximate concentration of 10 μg/mL for those dominant species present in the AFFF source materials (6:2 FTAB and 5:1:2 FTB in Arctic Foam AFFF and Ansulite AFFF, respectively). The aqueous stock mixture was prepared by amending 45 mL of HPLC-grade water with 32 μL of Arctic Foam 203A and 100 μL of Ansulite AFFF concentrates. The solution was gently rotated for homogenization but avoiding foaming; it was then aliquoted into three 15-mL polypropylene tubes. The triplicate aliquots were characterized on a Thermo UHPLC-HRMS Orbitrap Q-Exactive at a 1/500 dilution factor in MeOH. All samples were analyzed in duplicates. The 6:2 FTAB, 5:1:2 FTB, and 5:3 FTB were quantified using the corresponding authentic high-purity standards obtained from Wellington Labs (Guelph, ON, Canada) and other FTAB and FTB analogues semi-quantified using suspect-screening. Table 3 shows concentrations of FTABs and FTBs in the aqueous stock solution. Each of the three aliquots was prepared and analyzed in duplicate by LC-MS after applying a 1/500 dilution in MeOH. The 11:3 FTB was only present at low concentrations and was not targeted for the rest of this study. Measured concentrations of the major components 6:2 FTAB and 5:1:2 FTB were within ±20% of nominal target values (Table 3).

TABLE 3
Quantified (Qn) or semi-quantified (sQ) concentrations (μg/mL)
of FTABs and FTBs in the aqueous stock solutions.

| | Concentration in the stock solution (ppm) after accounting for the 1/500 dilution factor | | | | | | |
|---|---|---|---|---|---|---|---|
| | Quality | | | | | | |
| | level | Aliquot 1-a | Aliquot 1-b | Aliquot 2-a | Aliquot 2-b | Aliquot 3-a | Aliquot 3-b |
| 6:2 FTAB | Qn | 8.906 | 9.008 | 9.659 | 9.880 | 8.852 | 9.090 |
| 8:2 FTAB | sQ | 0.740 | 0.753 | 0.762 | 0.811 | 0.753 | 0.736 |
| 10:2 FTAB | sQ | 0.224 | 0.214 | 0.217 | 0.227 | 0.219 | 0.170 |
| 5:1:2 FTB | Qn | 10.692 | 10.805 | 10.958 | 12.235 | 11.414 | 11.652 |
| 7:1:2 FTB | sQ | 7.896 | 8.557 | 9.542 | 9.538 | 8.787 | 9.528 |
| 9:1:2 FTB | sQ | 2.465 | 2.735 | 2.850 | 2.955 | 2.746 | 2.484 |
| 11:1:2 FTB | sQ | 0.919 | 0.936 | 1.023 | 0.992 | 0.979 | 0.845 |
| 5:3 FTB | Qn | 2.186 | 2.521 | 2.470 | 2.539 | 2.419 | 2.759 |
| 7:3 FTB | sQ | 1.654 | 1.913 | 2.016 | 2.051 | 1.932 | 2.013 |
| 9:3 FTB | sQ | 0.522 | 0.593 | 0.609 | 0.636 | 0.576 | 0.584 |
| 11:3 FTB | sQ | 0.125 | 0.129 | 0.128 | 0.128 | 0.127 | 0.120 |

DOM Stock. SRNOM was utilized as it exhibited a similar molecular weight distribution in comparison to the natural surface waters in British Columbia and has been utilized as a surrogate for synthetic water studies globally.^{40.41} The received SRNOM was prepared into a DOM stock at about 500 mg/L and then was filtered through 0.45 μm pre-rinsed filters (Millex-HV Syringe Filters, Catalog number: SLHV033RS, Duluth, GA, USA). The final pH of the stock was adjusted by buffering with NaHCO₃ (0.5 mM), NaCl (0.02 mM), NaOH (0.1 M) and, if needed, HCl (0.1 M) as previously described.⁴² The stock solution was stored in the dark at 4° C. for up to four weeks.

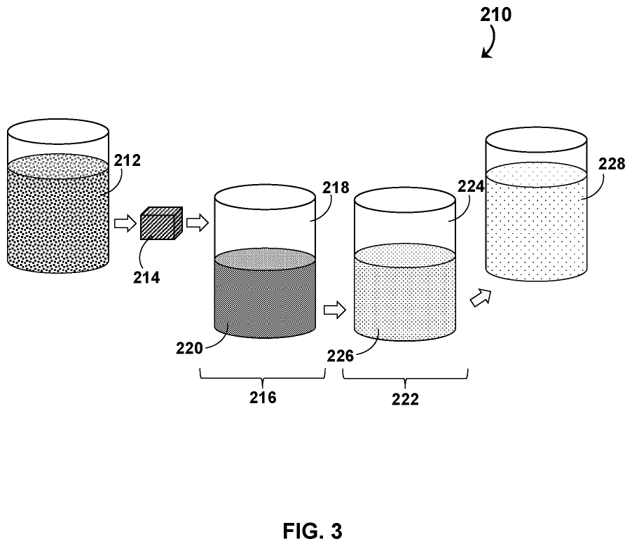

Recycled wastewater. The wastewater was collected from the secondary wastewater treatment facility (comprised of a membrane bioreactor) at the Vancouver Convention Centre (referred to as treated wastewater effluent). At the Vancouver Convention Centre (VCC) Plant, the VCC treatment process comprises a biological nutrient removal process followed by treatment with a membrane bioreactor. The plant treats grey and black water from the building at an operating capacity of 100,000 Liters/day. The treated water is reused in washrooms for toilet flushing and rooftop irrigation during summer and warmer months. The process 210 schematic is illustrated in FIG. 3. Shown in FIG. 3 are wastewater source 212, screen 214, nutrient removal 216, first anaerobic chamber 218, first aerobic chamber 220, additional nutrient removal 222, second anaerobic chamber 224, second aerobic chamber 226, and membrane bioreactor with GE-polyvinylidene fluoride (PVDF) membranes 228. The characteristics of the recycled wastewater are summarized in Table 2. Water samples were pre-filtered with 0.45 μm pre-rinsed membrane filters (Millex-HV Syringe Filters, Catalog number: SLHV033RS, Duluth, GA, USA) and stored in the dark at 4° C. for up to three weeks. Prior to all experiments, the water was passed through microfiltration (0.3 μm, GE Osmonics Flat Sheet, JX, PVDF, MF (Sterlitech Corporation, Kent, WA, USA)) and ultrafiltration membranes (200 kDa μm, Synder Flat Sheet, V5, PVDF, UF (Sterlitech Corporation, Kent, WA, USA), operated on a CF042 cascade at 15 mL/min (or 200 LMH) at operating pressures of 5 to 25 psi to mimic potable reuse scenarios.^{43,4} Of note, the MF-UF pre-treatment was only performed on wastewater effluents and not on deionized (DI) water spiked with SRNOM.

### (c) Experimental Approach

Kinetic Studies. 100 mg of resin/MXene (dry weight) was mixed with 1 L of water in circular beakers agitated with a Phipps & Bird 9900 Jar tester (Richmond, VA, USA) for contact times varying from 2 min up to 24 h at 150 rpm (0.1-10 μg individual PFAS/L), as previously described.^{45,46,47} Studies were performed in DI water (with spiked PFAS and SRNOM) adjusted at pH 7.0±0.2 with diluted NaOH.

Isotherm Studies. 10-1000 mg of resins/MXenes were mixed for 48 hours (equilibrium) with 1 L of source water having 0.1-10 μg/L individual PFAS and 5 mg C/L initial concentration of SRNOM. The DOM concentration was adopted as a representative concentration of organic matter concentration for a natural drinking water source in British Columbia.^{48,49,50,51}

Multiple Loading Tests (MILTs). Studies were performed via multiple loading tests, as previously described.^{52,45,53} Adsorbent dosage of 100 mg was mixed with 1 L of water (spiked with Z-PFAS and SRNOM) in a circular 1-L beaker in a Phipps & Bird 9900 Jar tester (Richmond, VA, USA) operated at 150 rpm (PFAS, C0=0.1-10 μg/L). The resins were regenerated (details herein) and then transferred to a new 1-L beaker (referred to as 1 cycle of operation). Note that the experiments were performed and analyzed in duplicates for every experimental condition. A control sample that included a contaminated solution without resin was included in all the tests.

Regeneration Experiments. Adsorbent regeneration was performed by conservatively mixing 100 mg of saturated adsorbent with 5 mL of 4 mM solution of either sodium chloride (NaCl), sodium sulfite (Na₂SO₃) and sodium sulfate (Na₂SO₄) for 120 minutes of contact time. Regeneration was also performed with acid (0.1 N HCl) and base (0.1 N NaOH) to examine the optimal regeneration condition (100 mg with 5 mL for 120 minutes of contact time). Duplicate experiments were performed, and all samples were analyzed twice.

UV-catalyzed Reduction Experiments. Experiments were performed using a UV apparatus as previously described.^{54,55} A sample volume of 17 mL (C₀,Z−P_{FAS}=100 g/L, C_{Na}_{₂}so₃=4 mM) contained in a closed transparent Spectrosil® quartz cell (Stama Cells Inc, Atascadero CA USA) was irradiated with a 24W low pressure UV lamp, emitting light at 254 nm (HVA357T5L, Light Source Inc., New Hudson, MI). The average fluence delivered was 185.8 J/cm² which was determined using iodide-iodate actinometry.⁵⁶ Iodide/iodate actinometry was performed to determine the 254 nm irradiance, and the final UV fluence was then determined by applying correction factors (such as the Petri factor, water factor, reflection factor, and divergence factor as described previously).^{55,57,58}

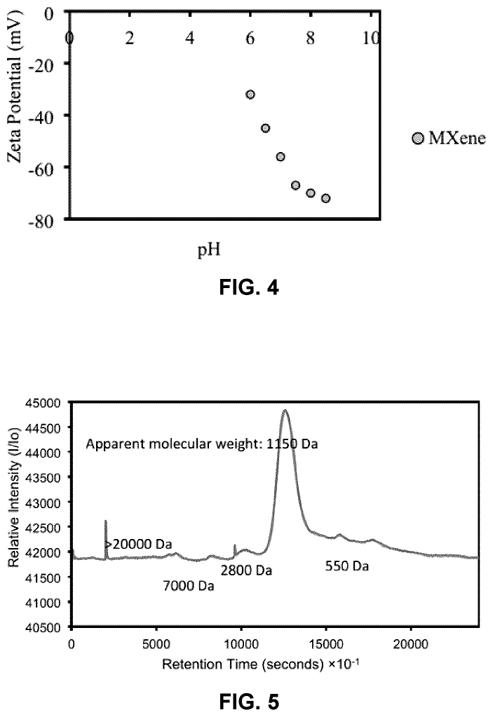

Zeta Potential ofMXene. FIG. 4 shows the Zeta potential of MXene (tested at a dose of 50 mg/L) using a Malvern Zetasizer Nano ZS-NIB (U.K.). The negative values indicate that the MXene is negatively charged during the operational pH range of 6-8.5.

LCOCD data for natural waters. LCOCD was performed using HPLC (Perkin Elmer, Canada) with 900 Turbo Portable OC Analyzer (detection range: 0.2-10 mg C/L, GE Sievers, Canada) for analysis of the source water NOM using the previously described method^{59,46,60}. Note, the LCOCD graphs for wastewaters were obtained using a Waters C-8 column, while the LCOCD graphs for NOM isolates and surface waters were obtained on a Waters C-18 column resulting in different elution times for corresponding molecular weights. FIG. 5 shows LCOCD data for Vancouver Convention Centre Water before IX treatment.

### (d) Isotherm and Kinetic Modeling

Isotherm Modeling. The experimental data were fitted to the Freundlich-isotherm model:^{61,62}

$${q}_{e} = {K}_{f} . {C}_{e}^{1 / n} \qquad ( 1 )$$

Here, qₑ (μg/mg) is the equilibrium uptake capacity and Cₑ (μg/L) is the concentration of Z-PFAS at equilibrium. The term K_{f} (μg/mg/μg/L)^{1/n} and 1/n are Freundlich isotherm parameters.

Kinetic Modeling. The pseudo-second-order kinetic model that considers that the rate is directly proportional to the number of active sites is given as:^{61,63}

$$\frac{t}{{q}_{t}} = \frac{1}{{k}_{2} {q}_{e}} + \frac{t}{{q}_{e}} \qquad ( 2 )$$

Here k₂ (μg/ng/min) is the pseudo-second-order rate constant.

Further studies were performed to evaluate the extent of film and pore diffusion involved during the uptake process by estimating the dimensionless mass transfer Biot number (Bi), which is the ratio of internal mass transfer (i.e., pore diffusion) to external mass transfer (i.e., film diffusion) resistances, as previously described.⁴¹

$$B i = \frac{{k}_{f} {R}_{p}}{{D}_{p e}} \qquad ( 3 )$$

Here Rp is the radius of the adsorbent (m), k_{f} (cm/s) is the external mass transfer coefficient (k_{f}=D_{f}/δ), D_{f} is the film diffusion coefficient (cm²/s), Dₚₑ is the pore diffusion coefficient (cm²/s), and δ is the film thickness (considered as 10⁻³ cm for the mixing conditions in our 1-reactor).⁴² Dₚₑ and D_{f} were calculated by performing non-linear optimization schemes, as previously described.⁴¹

Pseudo-first-order Kinetic Model. The pseudo-first-order kinetic model is given as⁶³:

$$log ( {q}_{e} - {q}_{t} ) = log ( {q}_{e} ) - ( \frac{{k}_{1}}{2.303} ) t$$

where qₑ and qₜ are the amounts of adsorbed PFAS ions on IX resin at equilibrium and time t, respectively. The correlation coefficients (R²<0.9) do not indicate a good fit to kinetic data.

Pseudo-second-order Kinetic Model. As noted above, the pseudo-second-order kinetic model, which considers that the rate is directly proportional to the number of active sites, is given as^{63,64}:

$$\frac{t}{{q}_{t}} = \frac{1}{{k}_{2} {q}_{e}} + \frac{t}{{q}_{e}} \qquad ( 2 )$$

where k₂ is the pseudo-second-order rate constant. The plots of t/qt vs t for Z-PFAS are linear with high correlation coefficients (R²>0.9), indicating a good fit to the model.

R_{adj}² (adjusted) estimation. The formula is⁶⁵:

$${R}_{adj}^{2} = \frac{( 1 - {r}^{2} ) ( n - 1 )}{n - k - 1}$$

where n is the number of data points in the sample and k is the number of variables in the model (excluding constants).

Estimation of diffusion coefficients and Biot number: The following equations describe the analytical solution for the intraparticle diffusion model (IDM) for adsorbents in a completely stirred tank reactor:

$$U t = \frac{{C}_{o} - {C}_{t}}{{C}_{o} - {C}_{e}} = \frac{\text{?}}{\text{?}} = 1 - \sum \text{?} ω \frac{6 ( ω + 1 )}{9 + 9 ω + β \text{?} ω \text{?}} \times exp ( - \frac{D \text{?} β \text{?}}{R \text{?}} ) \qquad ( 4 )$$

$$\text{?} \text{indicates text missing or illegible when filed}$$

ω is calculated from:

$$\frac{\text{?}}{V C \text{?}} = \frac{1}{1 + ω} \qquad ( 5 )$$

$$\text{?} \text{indicates text missing or illegible when filed}$$

βₙ are non—zero roots of the equation:

$$tan {β}_{n} , = \frac{3 {β}_{n}}{1 + w β \text{?}} \qquad ( 6 )$$

$$\text{?} \text{indicates text missing or illegible when filed}$$

Where U(t) is the fractional attainment of equilibrium and C₀, Cₜ and Cₑ are concentrations of solute (mg/L) at time t=0, t, and at equilibrium, respectively. Rₚ is the radius of the adsorbent, and D_{a,1} is the apparent diffusivity ((cm²/s).

As opposed to intraparticle diffusion, the following equation represents the changes in the PFAS concentration for the case of film diffusion-controlled removal:

$$U ( t ) = 1 - exp ( - \frac{3. \text{?} ( {V}^{′} {C}^{′} + V C \text{?}}{R \text{?} C \text{?} V \text{?}} ) \qquad ( 7 )$$

$$\text{?} \text{indicates text missing or illegible when filed}$$

Where δ is the film thickness (10⁻³ cm⁶⁶), C₀ is the initial solute concentration (meq/L), V is the solution volume (L), V′ is the resin volume (L), D_{f} is the film diffusion coefficient (cm²/s).

For both IPD and film diffusion models, D_{f} or D_{a,1} are assumed to be constant and are estimated based on nonlinear optimization schemes.

The curve fitted for D_{f} agreed well with the experimental data (0.95<R²<0.98), while the quality of fit for the pore diffusion model (0.96<R²<0.99) was well fitted under the dilute condition assumption, as described elsewhere.⁶⁶

The rate-controlling step was further investigated using the dimensionless Biot number (Bi), which is the ratio of internal mass transfer (i.e., pore diffusion) to external mass transfer (i.e., film diffusion) resistances.⁶⁷

$$B i = \frac{{k}_{f} {R}_{p}}{{D}_{p e}} \qquad ( 8 )$$

where k_{f}(cm/s) is the external mass transfer coefficient (k_{f}=D_{f}/δ), D_{f} (cm²/s) is the film diffusion coefficient, and Dₚₑ (cm²/s) is the effective pore diffusion coefficient (δ is film thickness about 10⁻³ cm)⁶⁸. The Bi«1 indicates film diffusion as the rate-limiting step, where Bi»1 shows pore diffusion to be the rate-limiting step.

Dₐ accounts for free liquid diffusion (Dl) and sorption to resins resistances and tortuous diffusion pathway through inside the resins and is correlated to effective pore diffusivity (D_{p,e}) as follows^{69,49}:

$$D \text{?} = \frac{{D}_{1} ε / τ}{\text{?} - \text{?} {ρ}_{s} {K}_{D} + ε \text{?}} = \frac{D \text{?}}{⌈ \text{?} - ε \text{?} {ρ}_{s} {K}_{D} + ε ⌉} \qquad ( 9 )$$

$$\text{?} \text{indicates text missing or illegible when filed}$$

Where K_{D} is the linear equilibrium partition coefficient, ε is the adsorbent porosity (assumed about 0.46 for all adsorbents)⁴², τ is the tortuosity of the resin and is estimated to be about 3^{42,70,71}, ρₛ is solid phase density (manufacturer specified), and D_{p,e} is effective pore diffusion coefficient (cm²/s). ε/τ accounts for the reduction in D₁ because of the tortuosity of the diffusion path, and the term [(1-ε) ρₛ K_{D}+ε] is referred to as retardation factor, by which the liquid diffusivity is reduced due to local microscale partitioning. Assuming a linear distribution of PFAS between the solid and liquid phases was plausible because of the low concentrations of the solute (i.e., about 0.1-100 μg 6:2 FTAB/L). The R² values obtained for the linear correlation were between 0.92-0.98^{72,66}.

### (e) Analytical Methods

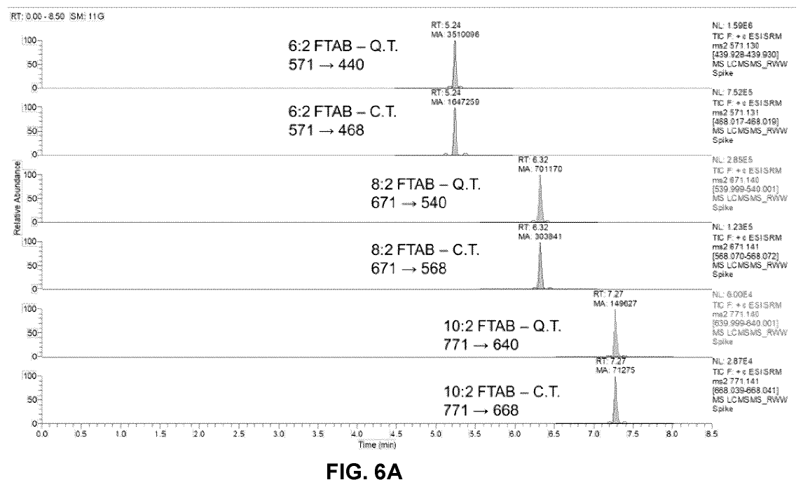

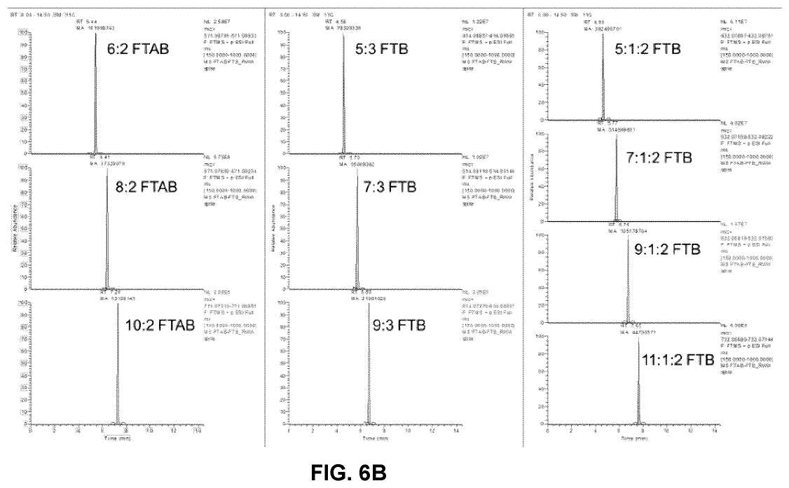

PFAS. Sample analysis involved liquid chromatography tandem mass spectrometry (LC-MS/MS Thermo TSQ Quantiva or Waters Micromass ZQ) and liquid chromatography high-resolution mass spectrometry (LC-HRMS Thermo Orbitrap Q-Exactive), using C₁₈ columns (Waters XTerra MS C18 or Thermo Hypersil Gold C18) and ammonium acetate or formic acid-based HPLC mobile phases.^{73,47,49} Representative LC-MS/MS and LC-HRMS chromatograms of Z-PFAS are provided in FIG. 6A and FIG. 6B, respectively. Solid-phase extraction was performed using Oasis WAX 3 cc, 60 mg sorbent cartridges (Waters Corporation, Milford, MA, USA).⁷⁴ The absolute recovery of the SPE approach was determined using AFFF spikes to SRNOM solution and recycled wastewater matrixes. Analytical methodperformance: SPE recoveries of Z-PFAS were within suitable or acceptable ranges using either LC-MS/MS or LC-HRMS (Table 4 and Table 5, respectively).

TABLE 4
Absolute extraction recoveries (average and standard deviation,
n = 3) of Z-PFAS on Oasis WAX SPE cartridges, using
AFFF spikes to DOM stock (SRNOM) and recycled wastewater
(RWW). Values were determined by LC-MS/MS analysis.

| | |
|---|---|
| Absolute SPE | Absolute |
| recovery %, SRNOM | recovery %, RWW |

| | Mean | STDEV | Mean | STDEV |
|---|---|---|---|---|
| 5:3 FTB | 85.2 | 8.5 | 76.6 | 3.9 |
| 7:3 FTB | 82.1 | 7.1 | 82.0 | 4.4 |
| 9:3 FTB | 62.2 | 4.0 | 67.0 | 2.9 |
| 5:1:2 FTB | 82.0 | 4.5 | 86.3 | 4.2 |
| 7:1:2 FTB | 81.4 | 6.5 | 83.2 | 2.3 |
| 9:1:2 FTB | 60.4 | 4.7 | 65.7 | 3.1 |
| 11:1:2 FTB | 48.6 | 5.1 | 58.4 | 2.8 |
| 6:2 FTAB | 85.7 | 2.6 | 90.6 | 7.9 |
| 8:2 FTAB | 62.7 | 3.3 | 66.8 | 3.9 |
| 10:2 FTAB | 48.2 | 4.5 | 61.5 | 5.0 |

TABLE 5
Absolute extraction recoveries (average and standard deviation,
n = 3) of Z-PFAS on Oasis WAX SPE cartridges, using
AFFF spikes to DOM stock (SRNOM) and recycled wastewater
(RWW). Values were determined by LC-HRMS analysis.

| | |
|---|---|
| Absolute SPE | Absolute |
| recovery %, SRNOM | recovery %, RWW |

| | Mean | STDEV | Mean | STDEV |
|---|---|---|---|---|
| 5:3 FTB | 80.8 | 0.9 | 92.0 | 1.2 |
| 7:3 FTB | 84.2 | 3.3 | 83.7 | 3.6 |
| 9:3 FTB | 59.5 | 1.9 | 72.7 | 0.9 |
| 5:1:2 FTB | 75.9 | 2.3 | 88.5 | 1.6 |
| 7:1:2 FTB | 75.1 | 3.1 | 83.9 | 4.0 |
| 9:1:2 FTB | 57.0 | 1.9 | 69.1 | 2.8 |
| 11:1:2 FTB | 46.6 | 4.1 | 63.0 | 1.7 |
| 6:2 FTAB | 84.7 | 2.2 | 90.3 | 1.2 |
| 8:2 FTAB | 67.6 | 3.7 | 71.4 | 1.3 |
| 10:2 FTAB | 49.7 | 6.0 | 63.7 | 1.7 |

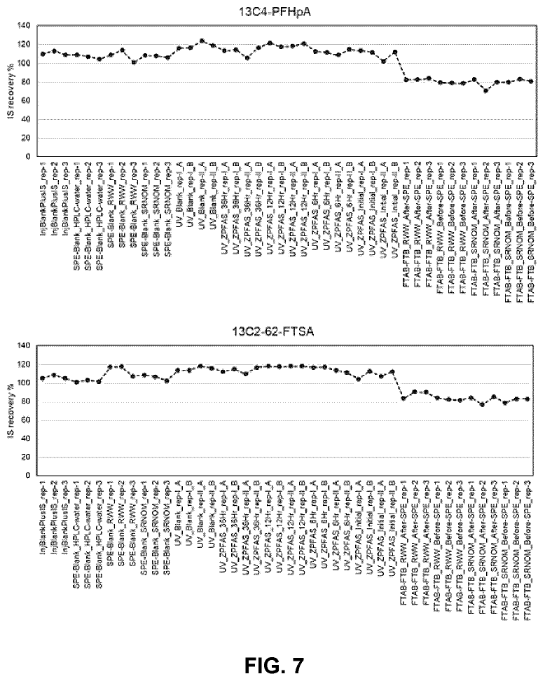

Instrument injection blanks and SPE blanks run with HPLC-water, SRNOM, and recycled wastewater remained free of Z-PFAS. Internal calibration curves were prepared in the range of 0.02-100 ng/mL with certified Z-PFAS (6:2 FTAB, 5:3 FTB, and 5:1:2 FTB) and displayed suitable determination coefficients (Table 6). Continued calibration verification (CCV) standards had accuracies in the range of 75.8-113.5% (Table 6), compliant with the acceptance criterion of 70-130% set by USEPA methods. Satisfactory internal standard recoveries were also obtained across the different sample types (FIG. 7).

TABLE 6
LC-MS/MS and LC-HRMS linearity, including linear range and determination coefficients
(R²) of calibration curves constructed with certified Z-PFAS, and accuracy
% of continued calibration verification standards (IC V/CC V).

| | 5:3 FTB | | 5:1:2 FTB | | 6:2 FTAB | |
|---|---|---|---|---|---|---|
| | LC-MS/MS | LC-HRMS | LC-MS/MS | LC-HRMS | LC-MS/MS | LC-HRMS |
| Linearity range (ng/mL) | 0.02-100 | 0.02-100 | 0.02-100 | 0.02-100 | 0.02-50 | 0.05-100 |
| R² | 0.9948 | 0.9984 | 0.9931 | 0.9980 | 0.9947 | 0.9971 |
| Accuracy % - ICV | 89.2 | 106.0 | 84.8 | 104.7 | 75.8 | 96.8 |
| Accuracy % - CCV 1 | 85.7 | 96.9 | 83.7 | 103.2 | 84.4 | 95.7 |
| Accuracy % - CCV 2 | 90.7 | 101.9 | 90.2 | 98.9 | 89.2 | 92.2 |
| Accuracy % - CCV 3 | 93.8 | 104.2 | 95.1 | 94.2 | 108.5 | 100.9 |
| Accuracy % - CCV 4 | 91.1 | 97.9 | 90.0 | 100.8 | 113.5 | 86.0 |
| Accuracy % - CCV 5 | 89.3 | 104.8 | 88.9 | 94.0 | 81.3 | 88.3 |
| Accuracy % (overall) | 90.0 ± 2.7 | 102.0 ± 3.8 | 88.8 ± 4.1 | 99.3 ± 4.5 | 92.1 ± 15.3 | 93.3 ± 5.6 |

Water quality parameters. Total organic carbon (TOC) and dissolved organic carbon (DOC) were measured using a TOC analyzer (GE Sievers M5310 C, Boulder, CO, USA), as previously described.⁴⁵ Chloride, sulfate, nitrate and phosphate were measured using an ion chromatograph (Dionex ICS-1100, USA), according to the USEPA 300.0 reference method.

### II. Results and Discussion

### (a) Effect of Adsorbent Media

The removal of eleven different Z-PFAS was studied in DOM-rich waters (C₀=5 mg C/L; similar to the DOM concentration of recycled wastewater) adjusted to pH about 7.0 and treated with 100 mg/L adsorbent dosage (see details on adsorbent densities in Table 1). Two PFAS-specific IX resins (A592E and A694E), one anionic organic scavenger IX resin (A860), two non-ionic IX resins (XAD4 and XAD7) and an MXene (Ti₃C₂) sorbent were adopted for the adsorption experiments. These materials were adopted considering their efficacy towards removing anionic PFAS and other dissolved organic and inorganic moieties from drinking water sources.^{75′76} Note that except A694E (previously studied for 6:2 FTAB),⁷⁶ none of the selected adsorbent materials have been examined for the removal of the Z-PFAS.

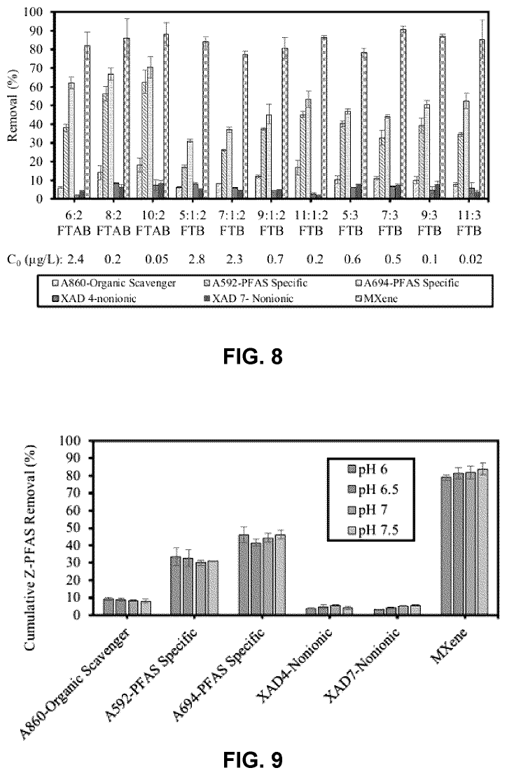

FIG. 8 depicts the removal of Z-PFAS using the selected adsorbent media with a one-hour contact time. As shown, the A592 (PFAS-specific resin) was able to remove a higher fraction of Z-PFAS in comparison to the non-ionic IX resins (XAD4 and XAD7) and organic scavenger resin (A860). For instance, the A592 removed about 40% of 6:2 FTAB (C₀=2.4 μg/L) in one-hour contact time while A860, XAD4 and XAD7 removed <10% of 6:2 FTAB. Similarly, A592 removed about 30% of 7:3 FTB (C₀=0.5 μg/L) while A860, XAD4 and XAD 7 were able to capture <12% 7:3 FTB. However, the other PFAS-specific A694, exhibited superior performance and captured about 62% of 6:2 FTAB and about 45% 7:3 FTB (1.5-fold higher removal in comparison to A592 PFAS-specific resin). For compounds at similar initial concentrations, the PFAS-specific resins captured a higher fraction Z-PFAS with FTAB structures (say about 70% removal of 8:2 FTAB (C₀=0.2 μg/L) and about 60% removal of 6:2 FTAB (C₀=2.4 μg/L) by A694) in comparison to FTB structures (about 50% removal of 11:1:2 FTB (C₀=0.2 μg/L) and about 40% removal of 7:1:2 FTB (C₀=2.3 μg/L) by A694). Similarly, A592 removed about 40% of 6:2 FTAB (C₀=2.4 μg/L) in comparison to about 25% removal of 7:1:2 FTB (C₀=2.3 μg/L), indicating a preferential removal of Z-PFAS with FTAB structures over FTB structures. Yet, Ti₃C₂ MXenes were by far the best adsorbent media capturing >80% of all Z-PFAS species under similar testing conditions. Thus, the cumulative removal of Z-PFAS at pH about 7 follows the order: Ti₃C₂ MXenes>A694>A592>A860>XAD4˜XAD7 (see details in FIG. 8). Note that the density of MXenes is higher than for resins (see Table 1). This implies that the performance on a volume basis in packed bed systems would be even higher (the present study was conducted in a suspended mode of operation). Further studies were performed to examine the removal mechanism and identify the rate-controlling steps for the Z-PFAS removal using the selected adsorbent media.

### (b) Effect of pH

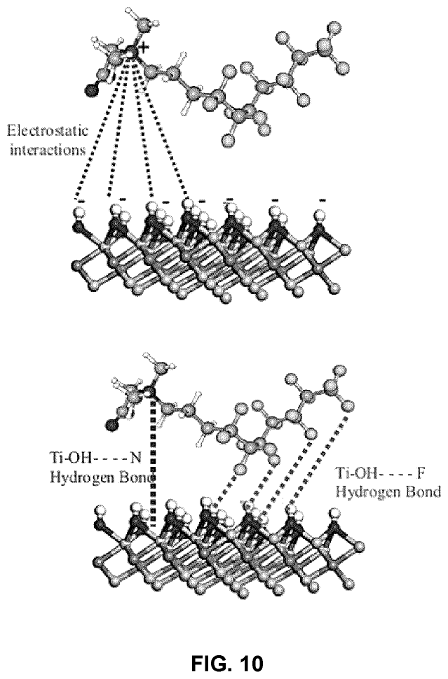

FIG. 9 depicts the cumulative removal of all tested Z-PFAS on various adsorbents within the pH range of 6 to 7.5 (characteristic of drinking water sources).^{49,77} The predicted pKa₁ of FTAB is around 2.3 and pKa₂ around 11,^{78,79} while the pKa of FTB is around 2.3, indicating that the compounds exist entirely as zwitterionic compounds in the environment (and in the tested range of pH). The cumulative Z-PFAS removal remains consistent for individual adsorbents in the pH range of 6.0-7.5 with background SRNOM of 5 mg C/L. For instance, A694 captured about 45 (±5) % of the influent Z-PFAS within this pH range. Similarly, A860 captured about 10 (±5) % Z-PFAS under similar operating conditions. The removal of Z-PFAS via A860 can be attributed to the interactions between the positively charged resin functional groups (quaternary ammonium (A860)) and the negatively charged carboxylic/sulfonic groups on Z-PFAS. In previous studies, it was demonstrated that the ion exchange mechanism plays a vital role in governing the uptake of anionic PFAS at high concentrations, where equivalent release of chloride ions and PFAS charged equivalents were observed.⁵² However, the test concentration of Z-PFAS in that study was set so low (C₀<10 μg/L) that the resultant chloride concentration in the treated water was below the Cl⁻detection limit of the ion chromatograph (detection limit about 100 μg/L). Moreover, A860 captured <10% of all Z-PFAS, indicating that the ion exchange mechanism does not impact the removal of Z-PFAS under the tested conditions. PFAS-specific resins such as A592 are expected to capture PFAS via a combination of ion exchange and chemisorption.^{75,52} Note that processes such as chemisorption, adsorption and hydrophobic interactions play a crucial role in removing PFAS via ion exchange resins.⁷⁵ However, since the hydrophobic properties of most of the tested Z-PFAS are yet to be established and reported in the literature, we did not investigate these phenomena in detail during this study. Note that the nonionic XAD4 and XAD7 IX resins removed <5% for Z-PFAS over the entire operational range of pH 6.0 to 7.5. The Ti₃C₂ MXenes outperformed the nonionic, anionic and PFAS-specific IX resins and were able to capture about 80 (±5) % of the total Z-PFAS over the operational pH range of 6.0-7.5. Thus, the performance of Ti₃C₂ MXenes is expected to remain consistent during real world applications. Several adsorption mechanisms such as electrostatic interactions, ion exchange, Van der Waals forces and hydrogen bonding have been investigated in literature for the contaminant uptake on MXenes.^{80,81} While not wishing to be limited by theory, FIG. 10 depicts the hypothesized removal mechanism of 7:3 FTB via electrostatic interactions and hydrogen bonding. While not wishing to be limited by theory, this can be verified with advancements in the understanding of the hydrophobic properties of the Z-PFAS.

### (c) Isotherm and Kinetic Studies

Table 7 provides the isotherm parameters for the uptake of the commonly detected Z-PFAS (i.e., 6:2 FTAB) in the presence of six different adsorbent media (A860, A692, A694, XAD4, XAD7 and MXene) at 5 mg C/L SRNOM concentration (pH about 7 and T=23° C.). All four isotherms conform to Freundlich-type behavior (qₑ=K_{f}·Cₑ^{1/n·62} R²>0.90, parameters are provided in Table 7). The 1/n values decreased from 0.8 for Ti₃C₂ MXenes (pH 7) to 0.7 for A694 (PFAS specific resin), 0.6 for A860 (organic scavenger resin) and 0.5 for XAD4 and XAD7 (nonionic IX resin). The most important effect was observed on the values of K_{f}, which declined from about 3.5 (μg/mg/μg/L)^{1/n} for Ti₃C₂ MXenes to about 1.7 (μg/mg/μg/L)^{1/n} for A592 (2-fold decrease for PFAS-specific resins) and only about 0.2 (μg/mg/μg/L)^{1/n} for XAD4 and XAD7 (about 20-fold decrease for nonionic IX resins).

TABLE 7
Kinetic and isotherm parameters for Z-
PFAS removal using A694 and Ti₃C₂ MXenes.

| | MXene | | A694 PFAS Specific | |
|---|---|---|---|---|
| Z-PFAS | k₂ (μg/ng/min) | R_{adj}² | k₂ (μg/ng/min) | R_{adj}² |
| 6:2 FTAB | 76.5 ± 0.3 | 0.99 | 32.4 ± 0.3 | 0.96 |
| 8:2 FTAB | 58.8 ± 0.6 | 0.92 | 26.7 ± 0.3 | 0.94 |
| 10:2 FTAB | 27.9 ± 0.2 | 0.99 | 12.8 ± 0.2 | 0.97 |
| 5:1:2 FTB | 56.1 ± 0.1 | 0.99 | 24.8 ± 0.3 | 0.93 |
| 7:1:2 FTB | 49.5 ± 0.1 | 0.99 | 20.5 ± 0.1 | 0.98 |
| 9:1:2 FTB | 40.8 ± 0.2 | 0.97 | 18.7 ± 0.2 | 0.95 |
| 11:1:2 FTB | 35.6 ± 0.2 | 0.94 | 12.5 ± 0.2 | 0.94 |
| 5:3 FTB | 50.2 ± 0.2 | 0.98 | 24.1 ± 0.1 | 0.96 |
| 7:3 FTB | 28.3 ± 0.1 | 0.99 | 12.9 ± 0.2 | 0.93 |
| 9:3 FTB | 22.2 ± 0.2 | 0.97 | 10.6 ± 0.1 | 0.97 |
| 11:3 FTB | 19.6 ± 0.1 | 0.98 | 7.9 ± 0.1 | 0.92 |

Isotherm data for 6:2 FTAB

| | K_{f} × 10⁻⁵ | | |
|---|---|---|---|
| Adsorbent | (μg/mg/μg/L)^{1/n} | 1/n | R_{adj}² |
| A860 | 1.4 ± 0.1 | 0.6 | 0.91 |
| A592 | 1.7 ± 0.1 | 0.6 | 0.90 |
| A694 | 2.1 ± 0.1 | 0.7 | 0.94 |
| XAD 4 | 0.2 ± 0.03 | 0.5 | 0.96 |
| XAD 7 | 0.2 ± 0.03 | 0.5 | 0.98 |
| MXene | 3.5 ± 0.1 | 0.8 | 0.93 |

*Data reported with 95^{th} confidence intervals of the respective parameters.

The kinetics of Z-PFAS uptakes were performed to evaluate the extent of film and pore diffusion involved during the uptake process. The experimental data were fitted with the intraparticle diffusion models (IPD, R²<0.7, data not shown), pseudo-first order kinetic (PFO, R²<0.8, data not shown), and the pseudo-second order kinetic (PSO, R²>0.9), and as previously described^{61, 82}. Of the models tested, the PSO model exhibited the best fit and the results are described in details in Table 7 (for Ti₃C₂ MXenes and A694, the two most effective Z-PFAS adsorbing media based on the above results). Note that the k₂ values for Ti₃C₂ MXenes were about 2-fold higher than that of A694. For instance, the k₂ value during 6:2 FTAB removal for Ti₃C₂ MXenes was about 75 (μg/ng/min), nearly 2.3-fold higher than the reported k₂ value with A694 (about 30 (μg/ng/min)). Similarly, the k₂ value during the removal of 9:1:2 FTB was about 40 (μg/ng/min) with Ti₃C₂ MXenes and about 20 (μg/ng/min) A694, indicating better performance of Ti₃C₂ MXenes over other commercial PFAS-specific resins.

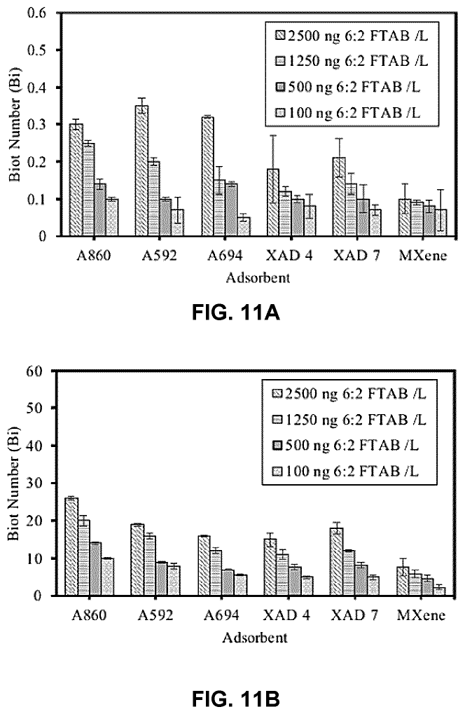

Kinetic data were further analyzed using the film diffusion model (FDM) and the pore diffusion model (PDM). This was done by analyzing the rate-controlling step and investigating the dimensionless mass transfer Biot number (Bi), as previously described.^{42,72} Note that the Biot number is the ratio of internal mass transfer (i.e., pore diffusion) to external mass transfer (i.e., film diffusion) resistances, and is often adopted for examining the rate-limiting step for ion exchange resins. For low Biot numbers (Bi<1), external mass transfer controls the uptake rate, and for Bi>30, the uptake is governed by surface diffusion. For 1<Bi<30, the uptake is governed by pore diffusion. Note that the initial Z-PFAS concentration was varied between about 10 μg/L-0.4 μg/L (resulting in an initial 6:2 FTAB concentration between 2.5 μg/L-0.1 μg/L). As depicted in FIG. 11A, the Bi for 6:2 FTAB were below 1 for all adsorbents, indicating that the uptake is controlled by film diffusion in DI waters. This result implies that the removal performance reported in this study is valid for the mixing conditions prevailing in our reactor, given that the mixing conditions are expected to impact film diffusion. In the presence of organic constituents (e.g., background DOM), the uptake is controlled by pore diffusion (for example at adsorbent dosage: 100 mg/L with 5 mg C/L SRNOM as background DOM at pH: 7 and T=23° C.; FIG. 111B). This agrees with our past studies where pore diffusion is identified as the rate-controlling step during the uptake of anionic micropollutants on ion exchange resins (such as A860 and A592) with background dissolved organic matter.^{52,72} Note that this study was performed in a stirred tank batch reactor (film layer: 10-3 cm), a condition for which the system is considered to be well mixed. The kinetics in a packed bed or column tests could therefore vary depending upon the operating conditions, which impact the external mass transfer.

### (d) Studies in Natural Waters

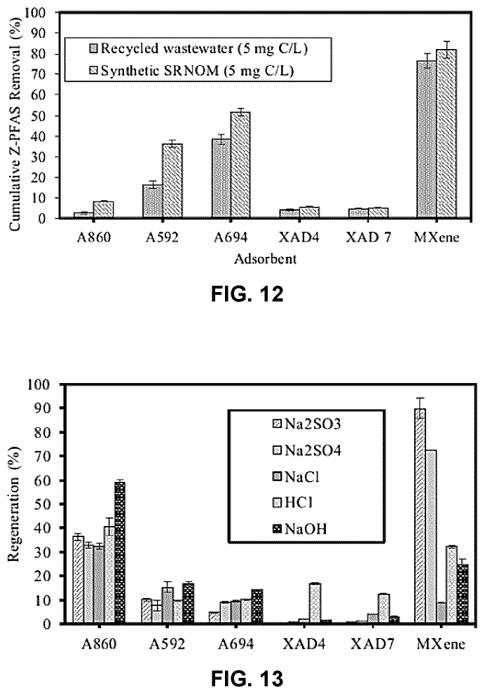

In addition to DOM, Z-PFAS in natural waters co-occur with a wide range of inorganic ions (such as sulphate, nitrate, etc.). Organic scavenger resins and PFAS-specific resins such as A592 are capable of removing inorganic ions in addition to DOM.⁴¹ However, the inorganic ion removal capabilities of PFAS-specific resins such as A694 and Ti₃C₂ MXenes are unknown. Additionally, this part of the study was also performed to compare the performances of A860, A592, A694, XAD4, XAD7 and Ti₃C₂ MXenes, with natural recycled wastewater. As depicted in FIG. 12, the Z-PFAS removal efficacy for the organic scavenger A860 and PFAS-specific resins were lower in the recycled wastewater than spiked synthetic SRNOM with similar background DOM concentration (5 mg C/L). For example, the removal for Z-PFAS decreased from about 50% (in SRNOM) to <40% (in recycled wastewater) for A694. Similarly, the Z-PFAS removal efficacy of A592 decreased from about 38% to <18% (an about 2-fold decrease) under similar conditions. This decline in performance can be attributed to the competitive interactions with other inorganic species in the recycled wastewater, such as sulfates (about 30 mg/L), nitrates (about 26 mg/L) and phosphates (about 10 mg/L), which were all reduced to <7.5 mg/L after treatment with A860, A592 and A694 (Table 8). Note that the Ti₃C₂ MXenes did not remove >5% inorganic ions or DOM from the recycled wastewater (Table 8) and the removal efficacy for Z-PFAS remained consistent (about 80% removal) in both water matrices, indicating the potential for their practical application due to the lower interference from the background water matrix.

TABLE 8
Inorganic ion removal from recycled wastewater: Inorganic
and organic ions characteristics (in mg/L) of VCC

| Inorganic ion | Nitrate | Sulphate | Phosphate | DOM |
|---|---|---|---|---|
| Initial | 26.1 ± 0.2 | 32.3 ± 0.5 | 10.4 ± 0.3 | 5.0 ± 0.3 |
| Concentration | | | | |

Concentration after treatment

| | | | | |
|---|---|---|---|---|
| A860 | 7.2 ± 0.5 | 2.6 ± 0.6 | 1.8 ± 0.2 | 0.8 ± 0.2 |
| A592 | 5.8 ± 0.6 | 4.8 ± 0.8 | 2.1 ± 0.3 | 3.6 ± 0.4 |
| A694 | 4.6 ± 0.5 | 3.4 ± 0.2 | 1.5 ± 0.5 | 4.1 ± 0.2 |
| Ti₃C₂ MXene | 25.6 ± 0.6 | 30.6 ± 0.4 | 9.8 ± 0.6 | 4.9 ± 0.3 |

* Data reported with 95^{th} confidence intervals of the respective parameters (adsorbent dosage: 100 mg/L).

### (e) Regeneration

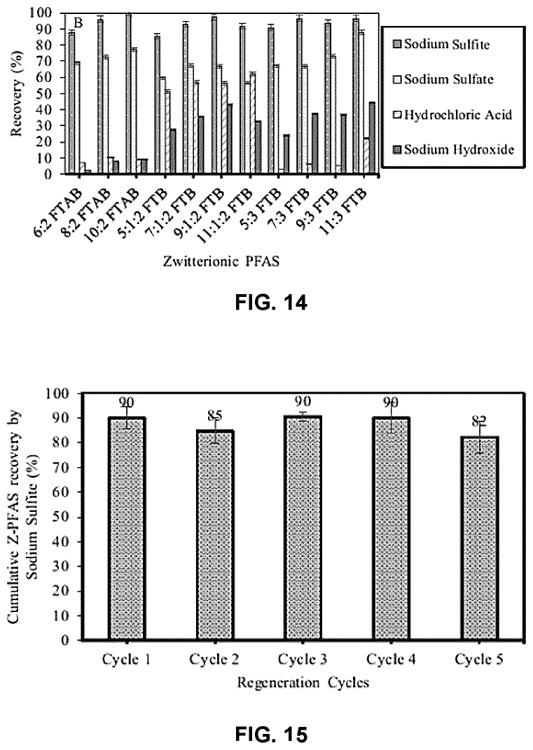

Recovery and regeneration of PFAS adsorbents could significantly reduce the operating costs, lower the adsorbent requirements and consequently lessen the environmental burden associated with the production and disposal of the adsorbent materials.^{45,83,84} In the present study, Z-PFAS elution studies on A860, A592, A694, XAD4, XAD7 and Ti₃C₂ MXenes were performed on saturated resins using salts (4 mM of NaCl, Na₂SO₃ and Na₂SO₄), acid (0.1 N HCl) and base (0.1 N NaOH). For regeneration, 100 mg of saturated adsorbent was mixed with 5 mL of the regenerant solution for a contact time of 2 hours (T=23° C. and mixed at 150 rpm). This regeneration condition was adopted based on prior literature studies on commonly examined regenerating agents and optimized anionic PFAS recovery protocols on ion exchange resins.^{75,45} Moreover, salts such as Na₂SO₃ and Na₂SO₄ were selected as they have been previously reported to aid the degradation of PFAS in aqueous matrices during ultraviolet (UV) treatment.⁸⁵ Among the tested ion exchange resins, A860 (organic scavenger) exhibited the highest regeneration efficacy with 30-60% recovery of Z-PFAS using the tested regenerant media (see FIG. 13). Regeneration efficacy of all other IX resins (PFAS-specific and nonionic) remained below 20% under all test conditions. Note that the regeneration efficacy of the most effective Z-PFAS capturing media (i.e., Ti₃C₂ MXenes) varied with a regenerating agent. Na₂SO₃ was identified as the most effective regenerating agent with Z-PFAS recovery of about 90% followed by Na₂SO₄ (about 70% recovery), HCl (30%), NaOH (25%) and NaCl (about 10%). FIG. 14 reports on the individual Z-PFAS recovery using the four most effective regenerating agents (Na₂SO₃, Na₂SO₄, HCl and NaOH). Note that Na₂SO₄ exhibited recovery of >70% for commonly studied Z-PFAS such as 6:2 FTAB. However, regenerating agents such as HCl and NaOH could only capture <10% of 6:2 FTAB. The highest recovery with HCl was reported for 11:1:2 FTB (about 60%), while the highest recovery with NaOH was recorded for 11:3 FTB (about 45%). Nonetheless, a regeneration with 10% Na₂SO₃ ensured >85% recovery of all tested Z-PFAS. More importantly, the regeneration performance with Na₂SO₃ remained consistent for five cycles of regeneration/reuse operations in recycled wastewater indicating that Ti₃C2MXenes exhibit potential for Z-PFAS removal during practical water treatment operations (see FIG. 15).

### (f) Z-PFAS Degradation in Regenerant Solution

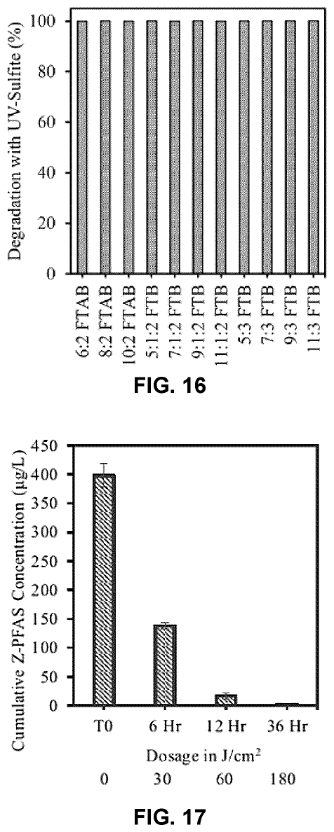

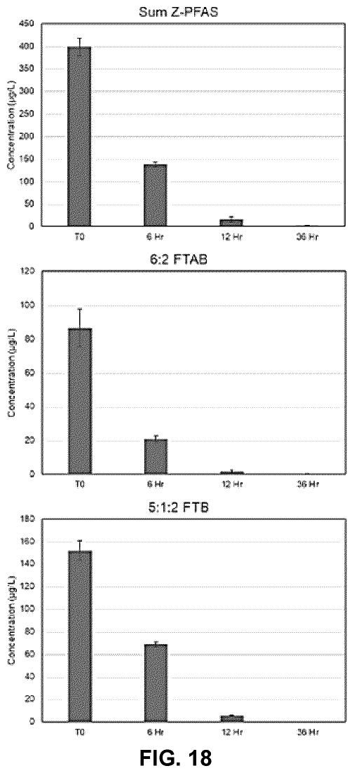

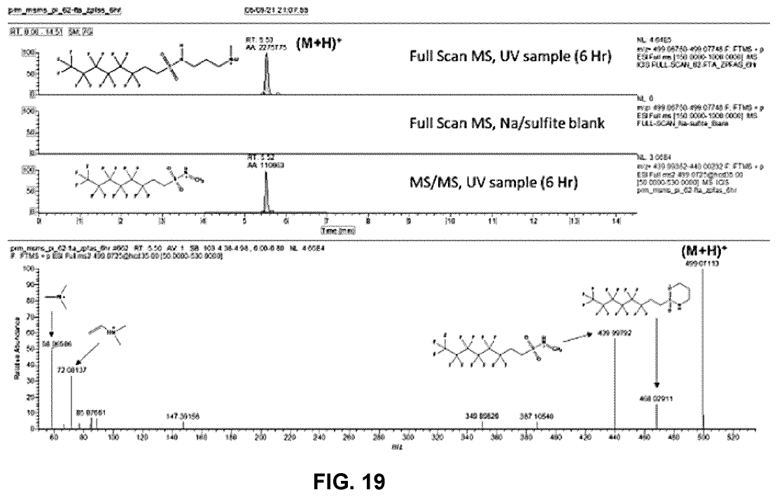

The degradation of Z-PFAS in the Na₂SO₃ regenerant is illustrated in FIG. 16. The degradation was studied at a UV dosage of about 180 J/cm² in DI water with Na₂SO₃ (4 mM) and a total Z-PFAS concentration of 500 μg/L. These conditions were selected to examine the feasibility of Z-PFAS degradation in the presence of Na₂SO₃. Existing studies on PFAS degradation using UV-sulfite have only been limited to anionic PFAS.⁸⁵ The efficacy of this process for Z-PFAS has not been reported in the literature. The primary aim with this experiment was to identify whether UV-sulfite systems can be adopted for Z-PFAS photo-reductive degradation in regenerant solutions. The selected dosage of about 180 J/cm² achieved >3 log reduction of Z-PFAS with background Na₂SO₃ (4 mM), confirming that UV-sulfite systems exhibit promising potential for the treatment of regenerants. We investigated consequent by-products formation in a follow-up UV-sulfite experiment. Summed Z-PFAS had decreased by about 65% by 6 hours (about 30 J/cm²), about 95% by 12 hours (about 60 J/cm²), and >99.9% by 36 hours (about 180 J/cm², see FIG. 17 and FIG. 18), confirming our earlier findings. No perfluoroalkyl carboxylates were detected, but we did find 9 fluorotelomer degradation products resulting from UV-sulfite treatment of predominant Z-PFAS (Schemes 1-4; FIG. 19; Tables 9-11).

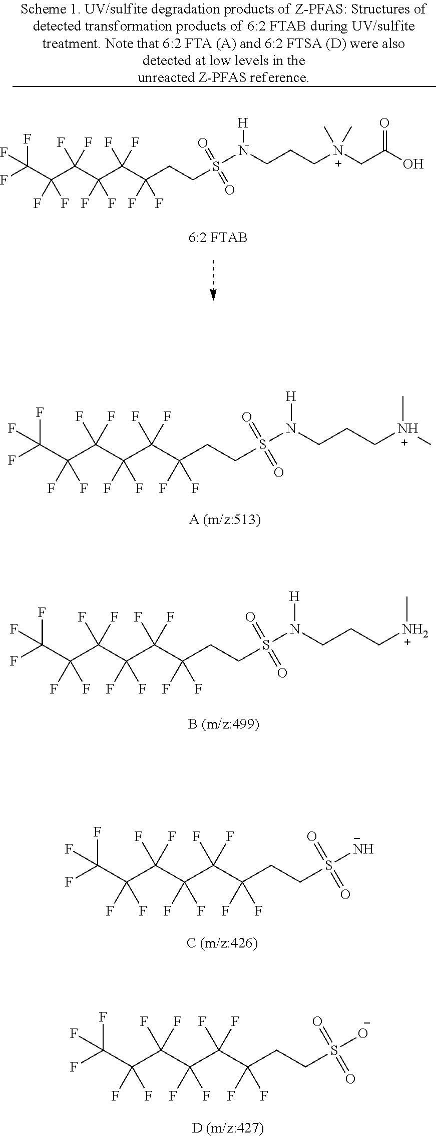 [SMILES: C[N+](C)(CCCNS(=O)(=O)CCC(F)(F)C(F)(F)C(F)(F)C(F)(F)C(F)(F)C(F)(F)F)CC(=O)O ; C[NH+](C)CCCNS(=O)(=O)CCC(F)(F)C(F)(F)C(F)(F)C(F)(F)C(F)(F)C(F)(F)F ; C[NH2+]CCCNS(=O)(=O)CCC(F)(F)C(F)(F)C(F)(F)C(F)(F)C(F)(F)C(F)(F)F ; [NH-]S(=O)(=O)CCC(F)(F)C(F)(F)C(F)(F)C(F)(F)C(F)(F)C(F)(F)F ; O=S(=O)([O-])CCC(F)(F)C(F)(F)C(F)(F)C(F)(F)C(F)(F)C(F)(F)F]

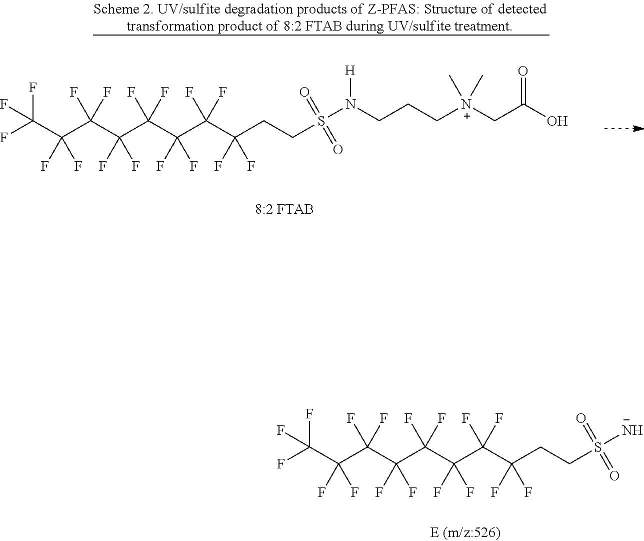 [SMILES: C[N+](C)(CCCNS(=O)(=O)CCC(F)(F)C(F)(F)C(F)(F)C(F)(F)C(F)(F)C(F)(F)C(F)(F)C(F)(F)F)CC(=O)O ; [NH-]S(=O)(=O)CCC(F)(F)C(F)(F)C(F)(F)C(F)(F)C(F)(F)C(F)(F)C(F)(F)C(F)(F)F]

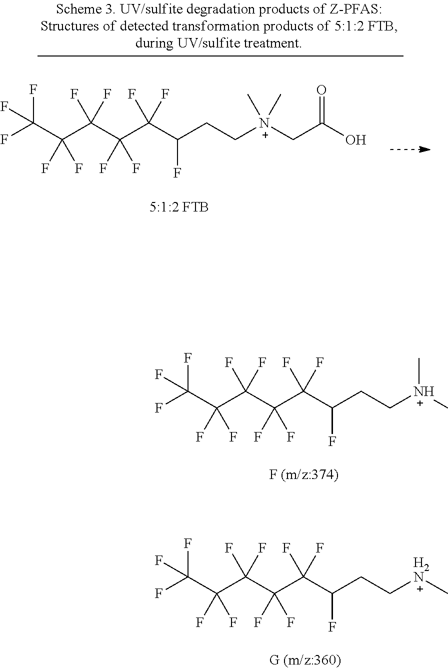

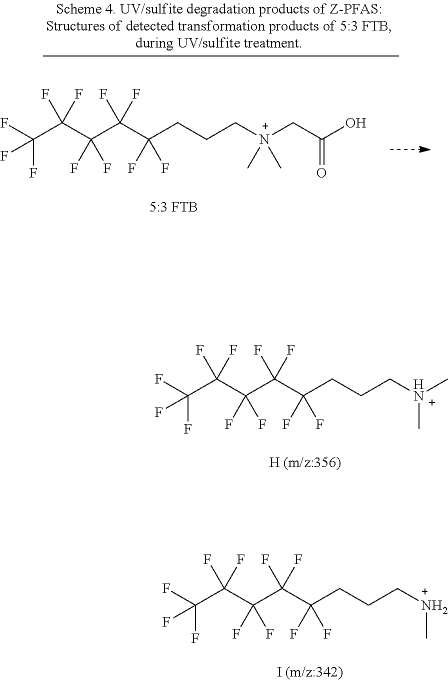

TABLE 9
Retention time and m/z of Z-PFAS
UV/sulfite degradation products.

| Compound | | | Retention | |
|---|---|---|---|---|
| structure | | Ion | time | |
| (Schemes 1-4) | Acronym | mode | (min) | Exact m/z |
| A | 6:2 FTA | ESI(+) | 5.50 | 513.08814 |
| B | 6:2 demethyl-FTA | ESI(+) | 5.42 | 499.07249 |
| C | 6:2 FTSA-PrA | ESI(−) | 6.52 | 425.98334 |
| D | 6:2 FTSA | ESI(−) | 5.50 | 426.96866 |
| E | 8:2 FTSA-PrA | ESI(−) | 7.55 | 525.97695 |
| F | 5:1:2 FTB TP-1 | ESI(+) | 4.78 | 374.07781 |
| G | 5:1:2 FTB TP-2 | ESI(+) | 4.67 | 360.06216 |
| H | 5:3 FTB TP-1 | ESI(+) | 4.72 | 356.08723 |
| I | 5:3 FTB TP-2 | ESI(+) | 4.61 | 342.07158 |

TABLE 10
Quantified or semi-quantified concentrations (μg/L) of detected transformation
products upon UV/sulfite treatment of Z-PFAS for up to 36 h¹.

| | Transformation products μg/L² | | | | | | | | |
|---|---|---|---|---|---|---|---|---|---|
| | A | B | C | D | E | F | G | H | I |
| Na-sulfite_Blank_rep-I_a | nd | nd | nd | nd | nd | nd | nd | nd | nd |
| Na-sulfite_Blank_rep-I_b | nd | nd | nd | nd | nd | nd | nd | nd | nd |
| Na-sulfite_Blank_rep-II_a | nd | nd | nd | nd | nd | nd | nd | nd | nd |
| Na-sulfite_Blank_rep-II_b | nd | nd | nd | nd | nd | nd | nd | nd | nd |
| ZPFAS_Initial_rep-I_a | 1.39 | nd | nd | 2.18 | nd | nd | nd | nd | nd |
| ZPFAS_Initial_rep-I_b | 1.23 | nd | nd | 2.29 | nd | nd | nd | nd | nd |
| ZPFAS_Initial_rep-II_a | 1.11 | nd | nd | 2.03 | nd | nd | nd | nd | nd |
| ZPFAS_Initial_rep-II_b | 1.19 | nd | nd | 2.10 | nd | nd | nd | nd | nd |
| ZPFAS_6 Hr_rep-I_a | 1.68 | 0.19 | 0.72 | 2.44 | nd | 0.22 | 1.23 | 0.35 | 0.34 |
| ZPFAS_6 Hr_rep-I_b | 1.67 | 0.19 | 0.70 | 2.52 | nd | 0.23 | 1.22 | 0.39 | 0.46 |
| ZPFAS_6 Hr_rep-II_a | 0.49 | 0.060 | 0.63 | 2.37 | nd | nd | 0.21 | nd | 0.072 |
| ZPFAS_6 Hr_rep-II_b | 0.58 | 0.056 | 0.65 | 2.43 | nd | nd | 0.19 | nd | 0.082 |
| ZPFAS_12 Hr_rep-I_a | 0.11 | nd | 1.51 | 4.19 | nd | nd | 0.38 | nd | 0.18 |
| ZPFAS_12 Hr_rep-I_b | 0.11 | nd | 1.56 | 4.28 | nd | nd | 0.40 | nd | 0.21 |
| ZPFAS_12 Hr_rep-II_a | 0.85 | 0.11 | 2.11 | 4.55 | 0.094 | nd | 0.13 | nd | 0.038 |
| ZPFAS_12 Hr_rep-II_b | 0.82 | 0.096 | 2.16 | 4.63 | 0.088 | nd | 0.14 | nd | 0.050 |
| ZPFAS_36 Hr_rep-I_a | nd | nd | 2.18 | 6.49 | nd | nd | 0.27 | 0.044 | 0.13 |
| ZPFAS_36 Hr_rep-I_b | nd | nd | 2.15 | 6.61 | nd | nd | 0.31 | 0.063 | 0.18 |
| ZPFAS_36 Hr_rep-II_a | nd | nd | 2.81 | 7.24 | 0.10 | nd | 0.060 | nd | nd |
| ZPFAS_36 Hr_rep-II_b | nd | nd | 2.89 | 7.13 | 0.11 | nd | 0.062 | nd | nd |

¹Each experimental duplicate (rep-I, rep-II) was aliquoted twice (a, b) for LC-HRMS analysis.
²Capitalized bold letters correspond to the structures presented in Schemes 1-4.

TABLE 11
The exact mass accuracy (δ (ppm)) of parent (M + H)⁺ and elucidated
MS/MS fragment ions from species depicted in FIG. 19.

| | Theoretical m/z | Observed m/z | δ (ppm) |
|---|---|---|---|
| Parent (M + H)⁺ | 499.07249 | 499.07113 | 2.73 |
| Fragment 1 | 439.99899 | 439.99792 | 2.43 |
| Fragment 2 | 58.06567 | 58.06586 | −3.27 |
| Fragment 3 | 72.08132 | 72.08137 | −0.69 |
| Fragment 4 | 468.03029 | 468.02911 | 2.52 |

N-deacetylated, N-demethylated products of 5:3 FTB and 5:1:2 FTB were observed at low concentrations (0.06-1.2 mol %) and decreased with increasing treatment time. Degradation products of 6:2 FTAB were similar to those identified in a previous photolysis study.⁸⁶ In particular, the 6:2 fluorotelomer sulfonamide (6:2 FTSA-PrA) and 6:2 fluorotelomer sulfonate (6:2 FTSA) showed a gradual buildup of concentrations over the time-course experiment, reaching respectively 3.9 mol % and 7.3 mol % of the parent Z-PFAS by 36 h.

### (g) Environmental Implications

Fluorotelomer zwitterionic PFAS are present in various formulations, including current-use AFFF, and as such, are starting to be reported in monitoring surveys at levels surpassing those of historic anionic PFAS.^{73,87,88,89} The fluorosurfactants with betaine and ammonium head groups are of great concern due to their environmental persistence.⁹⁰ Short-chain dominant Z-PFAS, such as 6:2 FTAB, 5:3 FTB, and 5:1:2 FTB, are highly relevant in a water treatment perspective due to their higher likelihood than long-chain homologs to reach water production sources.⁸⁷ As adsorption treatment technologies designed at removing anionic PFAS may not be equally suited at removing Z-PFAS,^{76,91} a specific study focused on a range of fluorotelomer Z-PFAS was needed. The present study explored the removal potential of a range of adsorbents at removing Z-PFAS from artificial and real water. Our findings indicate that the uptake of 6:2 FTAB is controlled by film diffusion on all tested adsorbent media in DI waters, and by pore diffusion in the presence of dissolved organic matter. 2D MXene metal carbides presented the best removal performance of Z-PFAS, and efficacy was little affected by compound-specific chain length, water pH, and water matrix.

Among the other tested adsorbents, two PFAS-specific resins (A694 and A592) performed reasonably well at removing fluorotelomer Z-PFAS while ion exchange resins did not, concurring with observations for electrochemical fluorination zwitterionic PFAS.^{76,92} Ion-exchange resins might still be viable options for ex-situ water treatment of waters contaminated by Z-PFAS, but may require pre-emptive in-situ chemical oxidation of Z-PFAS to form anionic PFAS, for instance, using heat-activated persulfate.⁹³ Na₂SO₃ and Na₂SO₄ were the most effective adsorbent regenerating agents and Ti₃C₂ MXenes exhibited a consistent regeneration/reuse operation for five cycles in recycled wastewater, indicating the potential for Z-PFAS removal during practical water treatment applications. We found that UV treatment of the Na₂SO₃ brine regenerant could achieve >3 log reduction of Z-PFAS, but also led to the significant accumulation of photolytic degradation intermediates such as 6:2 FTSA and 6:2 FTSA-PrA. This is not unexpected, as UV/sulfite mechanism produces hydrated electrons efficient for reductive defluorination of perfluoroalkyl chains but less so for fluorotelomer chains.^{94,95} Implementing hydroxyl radical postoxidation or other treatment steps may therefore be required to attain greater abatement of fluorotelomer degradation by-products.

### Example 2

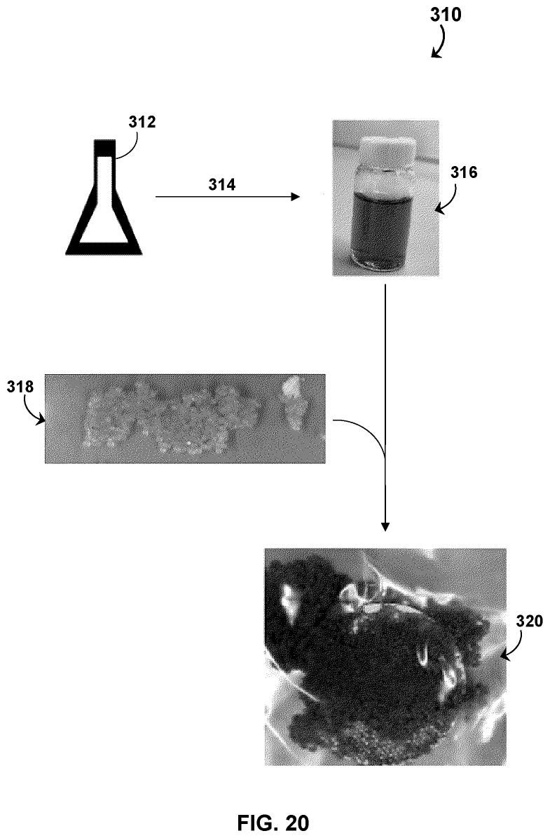

A method for removing toxic per- and poly-fluoroalkyl substances (PFAS) and/or natural organic matter (NOM) from water includes adding a coating on a substrate to capture PFAS from the liquid. The substrate may include any existing adsorbent media, ion exchange resins or low/high pressure membranes which are commonly adopted in water treatment operations. The coating may be referred to as PFAS Plus. This method for removing PFAS from a liquid includes a surface deposition of PFAS Plus on any substrate media to enhance the PFAS removal kinetics. The substrate media may comprise ion exchange resins or low/high pressure membranes which are commonly adopted in water treatment operations. PFAS Plus may be synthesized using Phyllanthus emblica extract with ferric sulfate or ferric chloride, auric chloride solution or silver nitrate, using established protocols: WO2013104976A1. PFAS Plus is added to the selected substrate. This may cause the PFAS Plus to deposit onto the surfaces of the substrate, or be incorporated into the network structure of the substrate. This process may occur within the pH range of 5-8, depending upon the substrate. The excess solvent is removed via filtration and the substrate is washed at least once with copious amounts of solvent. For instance, the substrate is washed ten times with 100 bed volumes (1 bed volume=1 mL substrate treated with 1 mL water) of water/methanol and dried by air to obtain PFAS Plus coated substrates. FIG. 20 illustrates an exemplary method flow diagram for preparing PFAS Plus coated substrate. The schematic illustrated in FIG. 20 is of PFAS plus synthesis and its application on commercially available water treatment substrates. Referring to FIG. 20, in the method 310 shown therein, a metal stock solution (e.g., FeCl₃+HAuCl₄) 312 and Phyllanthus emblica powder (not shown) can be combined 314 and PFAS Plus 316 obtained. The PFAS Plus 316 can then be added to the substrates for water treatment (e.g., polyacrylic ion exchange resin) 318 to obtain augmented substrates 320. PFAS Plus coated substrate media exhibit similar regeneration protocols compared to non-modified substrates. For instance, the PFAS Plus coated substrates may be regenerated using a regenerant solution containing salts (e.g., sodium chloride).

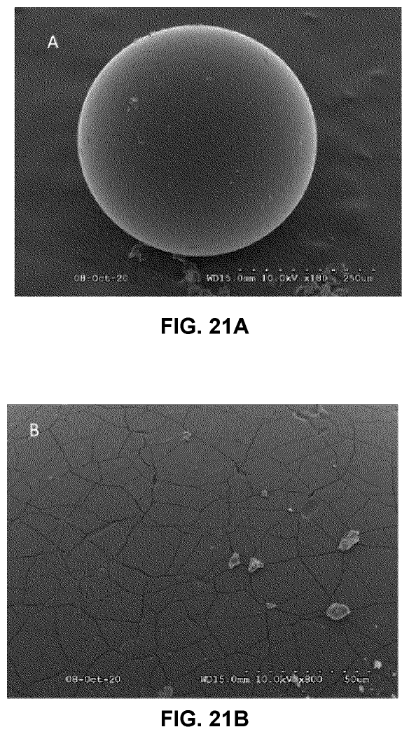

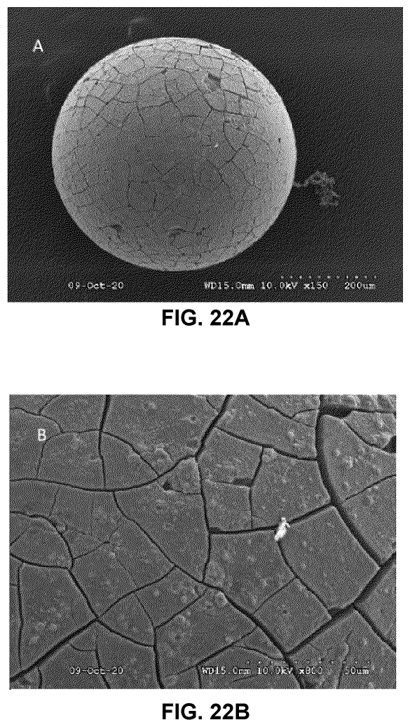

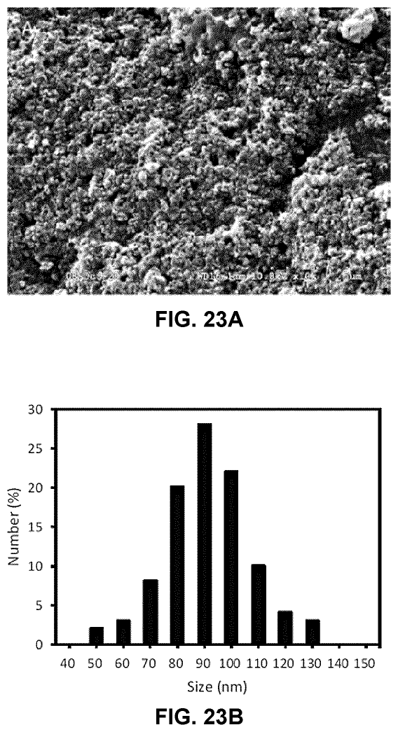

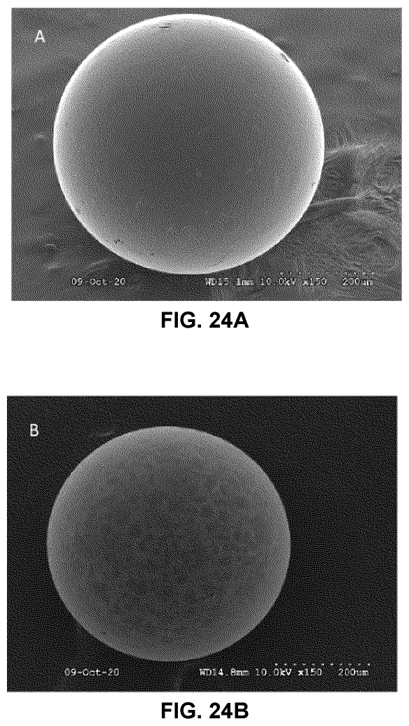

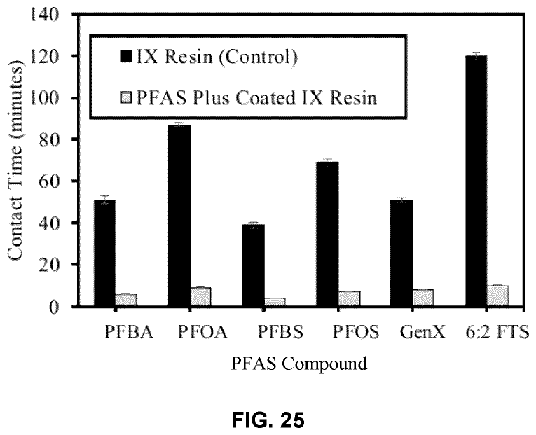

FIG. 21A is a SEM image of commercially available polyacrylic ion exchange resin at 250 μm resolution and FIG. 21B at 50 μm resolution. FIG. 22A is a SEM image of PFAS Plus coated polyacrylic ion exchange resin at 250 μm resolution and FIG. 22B at 50 μm resolution. FIG. 23A is a SEM image of PFAS Plus coated polyacrylic ion exchange resin at 5 μm resolution. An exemplary dynamic light scattering image shows an average Fe particle size of 91.3±12.1 nm (FIG. 23B). FIG. 24A is a SEM image of polystyrenic ion exchange resin at 250 μm resolution as fresh resin and FIG. 24B is a SEM image of polystyrenic ion exchange resin at 250 μm resolution with PFAS Plus coating. FIG. 25 shows the contact time required to achieve PFAS removal below limit of detection (to <10 ng/L from C₀=10 μg/L) in presence of 5 mg C/L (Suwannee River Natural Organic Matter Standard) with 0.4 mL IX resin/L (black, control) or 0.4 mL PFAS Plus coated IX resin (grey).

The method and material presented herein has several advantages. For instance, it presents a method that can easily retrofit existing commercial products for capturing PFAS. The synthesized PFAS Plus coating can be applied to any existing water treatment system to enhance PFAS removal capabilities without changing in the existing infrastructure and operational protocol. Also, PFAS Plus coating may enhance the PFAS removal rates by up to 10-fold. The comparison of PFAS removal rates for IX resin as an exemplary substrate has been illustrated in FIG. 25.

### Example 3

### I. Materials and Methods

Materials: Phyllanthus emblica (PE) powder was purchased from Rootalive (Whitby, ON). Iron (II) sulfate heptahydrate (FeSO₄·7H₂O) was purchased from VWR (Edmonton, AB; CAS Number: 7782-63-0). Anionic organic scavenger resin (Purolite® A860, polyacrylic with quaternary ammonium functional groups, capacity: 0.8 meq/mL, 1 mL=221 mg) and PFAS-specific resins (A694E and A592 with complex amino functional group and capacity of 1-1.4 eq/L) were obtained from Purolite® (Bala Cynwyd, PA, USA). All materials were used as received.

Synthesis: 400±10 mg PE powder was mixed in 1 L deionized (DI) water at 1000 rpm for 1 hour to extract the phenolic compounds. Subsequently, the aqueous solution was filtered through 0.45 μm pre-rinsed filters (Millex-HV Syringe Filters, Catalog number: SLHV033RS, Duluth, GA, USA) to remove undissolved particulates. 2000±10 mg of FeSO₄·7H₂O was then added to the filtered solution and agitated at 150 rpm using a Phipps & Bird 9900 Jar tester (Richmond, VA, USA) for 30 seconds. This was followed by addition of 25 g (dry weight) of the A860/A592, A694E. The system was continuously agitated at 150 rpm for 24 hours to initiate, propagate and complete the MPNs coating formation on the resin. After 24 hours, the aqueous mixture was filtered with 0.45 μm pre-rinsed filters to recover the coated resins (A860/A694E). The coated resins were thoroughly washed with DI water (about 4 L) to prevent potential leaking of organics (dissolved organic carbon <0.2 mg C/L), loose chloride ions (<0.5 mg Cl/L) and metals (<0.2 mg Fe/L). Subsequently, the materials were vacuum filtered with 0.45 μm filters to both separate them from their wash solution, and to remove any excess moisture. The coated materials were stored in the dark at 4° C. for up to ten weeks prior to application. For the Tannic Acid (TA) particles, 100±10 mg TA (obtained from Sigma Aldrich (Oakville, ON); dosage selected to match the generated MPNs UV Absorbance at 570 nm with PE) was used and the synthesis carried out similar to that described above for the natural MPNs.

### II. Results and Discussion

Polyphenol-containing material: Phyllanthus emblica (PE) is one of the berries which exhibits the highest tannins content (about 600 mg/g)⁹⁶. The tannin content is higher in dry fruit powder (35%) in comparison to fresh weight fruit (about 4%)⁹⁷. Multiple fruit (dry) powders (Cyanococcus, Fragaria spp., Rubus spp.,) were tested during preliminary tests and could be used to prepare MPNs. However, the PE performed the best.

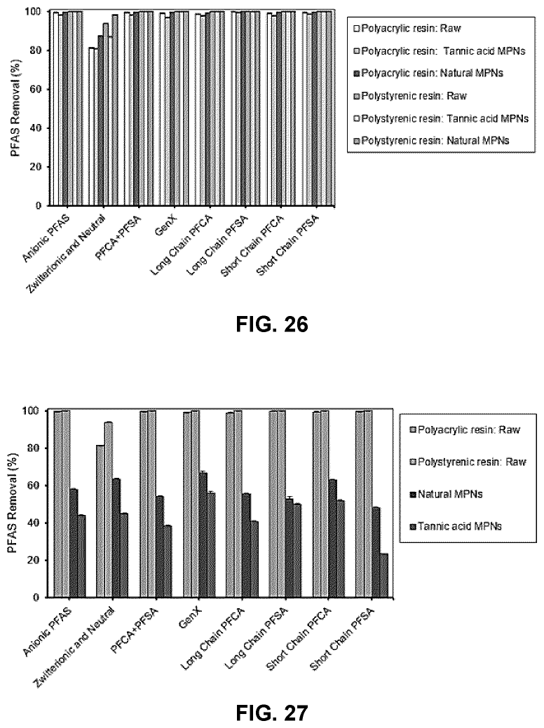

PFAS removal efficiency: FIG. 26 shows the results of a comparison of PFAS removal by different ion exchange (IX) resins (minimum detection limit: 200 μg/L; initial individual PFAS concentration (C₀) in the range of 0.02 μg/L to 200 μg/L (environmentally relevant concentration)) in presence of 10 mg C/L (dissolved organic matter (DOM)) with 0.4 mL IX/L (100 mg/L dry resin weight). Target PFAS: were 77 different PFAS compounds (including regulated and non-regulated compounds with different headgroup charges (anionic, zwitterionic, etc.)). Acronyms: PFCA: Perfluorinated carboxylic acids, PFSA: Perfluorinated sulfonic acids, MPNs: Metal phenol networks, GenX: Hexafluoropropylene oxide dimer acid (HFPO-DA), long chain PFSA (C>6) and long chain PFCA (C>7). Raw resins which were fresh resins from the manufacturer were compared to tannic acid MPNs; i.e., MPNs synthesized using an extract (tannic acid) and natural MPNs (i.e., an example of a PFAS Plus or nanoparticle prepared from a polyphenol-containing natural material and a metal salt) which were coated resins with MPNs synthesized using natural dried fruit powder as described above.

FIG. 27 shows PFAS removal by different virgin adsorbents in presence of 10 mg C/L with 100 mg IX (or Fe)/L and initial individual PFAS concentration (C₀) in the range of 0.02 μg/L to 200 μg/L. Target PFAS were 77 different PFAS compounds (including regulated and non-regulated compounds with different headgroup charges (anionic, zwitterionic, etc.)). Note: Natural MPNs and Tannic acid MPNs were not coated on the resins in these studies.

Studies were performed on commercially available polyacrylic and polystyrenic resins (the two major types of media used for making PFAS capturing ion exchange resins). PFAS removal followed the order: Raw resin <Resin coated with tannic acid MPNs<Resin coated with natural MPNs. The addition of natural MPNs on polystyrenic resins significantly enhanced the removal of zwitterionic PFAS which was not achieved by raw resin or resins coated with tannic acid extracts. Coating both, polyacrylic and polystyrenic resins with natural MPNs can enable 4-log (99.99) removal of anionic PFAS and regulated long and short chained PFCA and PFSA. The resins coated with natural MPNs can also achieve >6-log (99.9999%) removal of GenX (a regulated PFAS alternative) and simultaneous >80% removal of cationic and zwitterionic PFAS which no other adsorbent has been able to achieve, to date. The results in this section are in natural water (with coexisting organic matter 10 mg C/L) whereas the results in literature are often depicted in deionized waters with no competing anions. The present data relates directly to how the resins will perform in the field under realistic conditions (usually PFAS contaminated drinking waters have a dissolved organic concentration of 3 mg/L or less). In deionized waters we observed >4-log (99.99%) removal of all compounds.

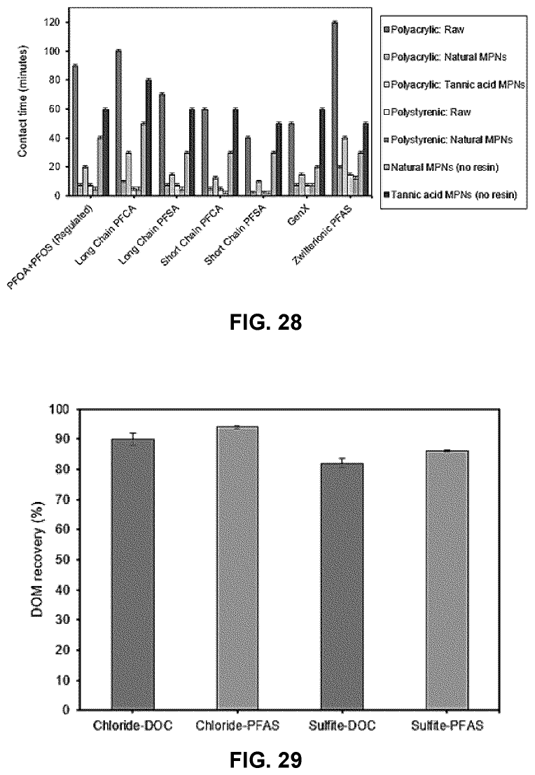

Contact time: FIG. 28 shows studies of the contact time to achieve 4-log removal of PFAS in the presence of 5 mg C/L with 100 mg IX (or Fe)/L and initial individual PFAS concentration (C₀) in the range of 0.02 μg/L to 200 μg/L. Target PFAS were 77 different PFAS compounds (including regulated and non-regulated compounds). Polyacrylic resins coated with tannic acid MPNs had a 4-fold decrease in contact time required to achieve 4-log removal of regulated PFAS (PFOA+PFOS). In contrast, polyacrylic resins coated with natural MPNs had a 12-fold decrease in contact time required to achieve 4-log removal of regulated PFAS (PFOA+PFOS). This reduction in contact time, may for example, be of high significance from operational and/or capital costs (OPEX and CAPES).

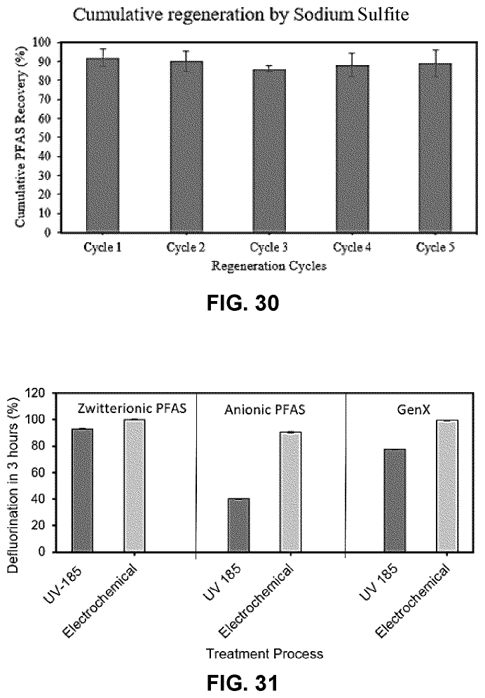

Regeneration and reuse: During practical applications, resins often get saturated with dissolved organic matter (DOM) which is usually in mg/L and about 10⁶-fold higher in comparison to PFAS (usually ng/L). For resins to be regenerated and reused an efficient DOM recovery is warranted. Saturated polyacrylic resin (coated with natural MPNs) was regenerated with 10 bed volumes of sodium chloride (10 wt %) or sodium sulfite (10 wt %) Chloride ions exhibited >90% regeneration of DOM and PFAS (FIG. 29). Sulfite ions exhibited >85% recovery PFAS (FIG. 29). The presence of sulfite ions in the regenerant enables efficient defluorination (complete destruction) of PFAS with UV or electrochemical processes. FIG. 30 shows cumulative regeneration by sodium sulfite over five cycles.

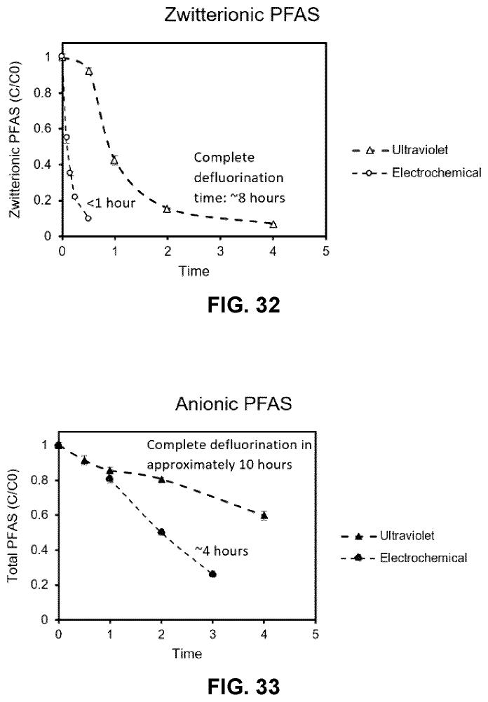

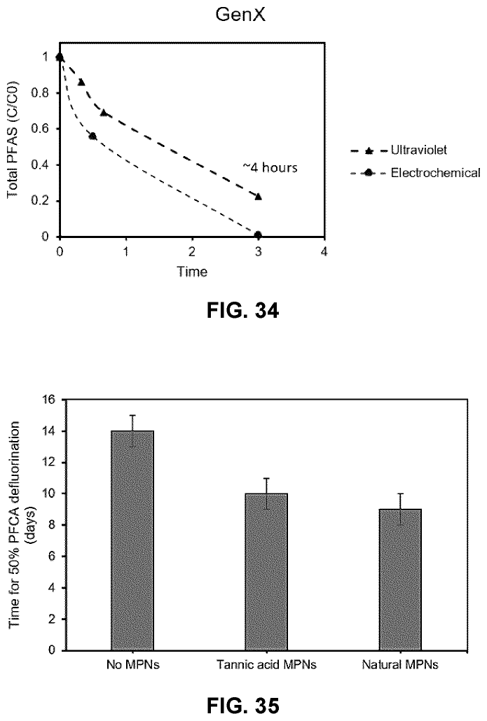

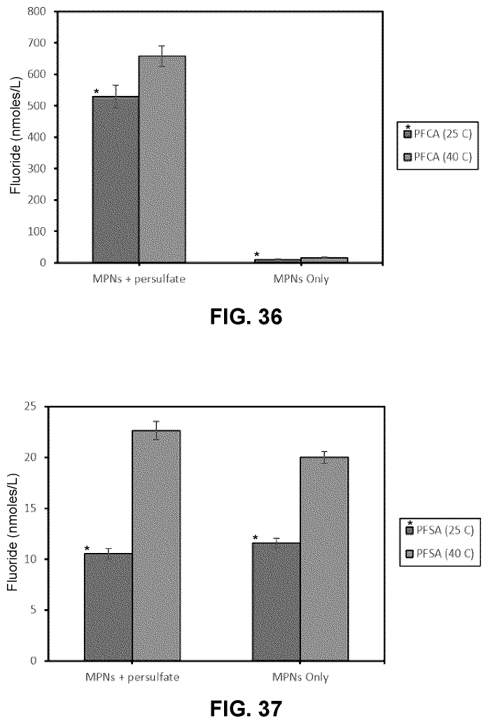

Treatment of PFAS concentrates brines: Electrochemical-based defluorination of PFAS in presence of 4 mM sulfite concentration can enable complete PFAS defluorination in 4 hours. However, it would take about 10 hours for a UV-based protocol to achieve the same degree of defluorination under similar operational conditions; about 26 J/cm², highly energy intensive (FIGS. 31-34). For low energy defluorination, PFCA can be mineralized at 40° C. with 50 mM sodium persulfate. However, this low-energy process is time consuming. Addition of natural MPNs enables PFCA defluorination at 1.5-fold faster rate (FIG. 35). FIG. 36 indicates that PFCA-laden adsorbents can be treated with persulfate ions (clear indication of defluorination with the detection of fluoride ions). FIG. 37 indicates that PFSA can be defluorinated with MPNs (although about 40-fold lower concentration of fluorine ions is released in comparison to PFCA) and addition of persulfate ions does not enhance the defluorination process. This finding has implications for treating PFAS-laden media: for example, saturated adsorbents, soils, PFAS-laden consumer products or wastewater biosolids could be coated with the natural MPNs (universal adhesive) and then kept in a sodium persulfate containing solution at 40° C. (or lower) to defluorinate PFCA. PFSA could be defluorinated by electrochemical or UV-sulfite based (energy intensive) processes and a small degree of defluorination could be achieved on the MPNs coated surfaces. This advantageously could address the destruction of PFAS under feasible conditions (e.g., at room temperatures (such as 25° C.)). Literature studies have reported low-energy persulfate oxidation is only relevant for PFCA and their precursor zwitterionic compounds. To date, no study has disclosed defluorination of PFSA with the persulfate ions (as evident in FIG. 37 where MPNs are only responsible for defluorination). Defluorination refers to destruction of PFAS into C, F and O in contrast to degradation which often relates to breakdown of PFAS into smaller (yet potentially toxic) by-products.

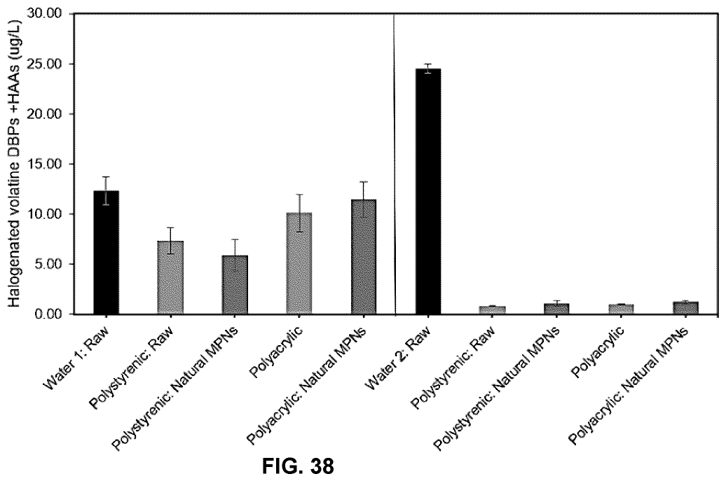

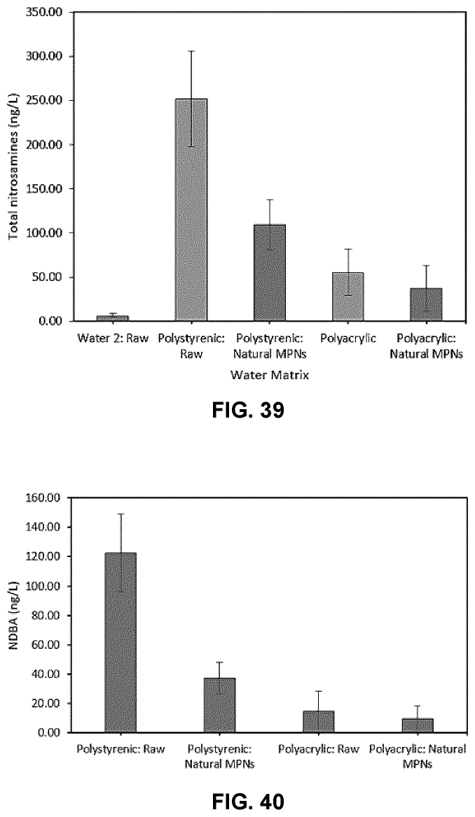

Toxicity reduction: Disinfection by-products (DBPs): FIG. 38 is a plot showing reduction in formation of halogenated disinfection by-products (DBPs) and haloacetic acids (HAAs) (μg/L) for different natural water sources. A coating with MPNs significantly reduces the nitrosamine (regulated DBPs including highly toxic NDMA) formation potential of PFAS adsorbing media (FIG. 39). New PFAS adsorbents also result in formation of NDBA which has not been previously documented in drinking water systems. Formation of NDBA reduces with the MPNs coating (FIG. 40). Thus, addition of such a coating could significantly reduce the toxicity of PFAS adsorbing media that are currently available in the market.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR REFERENCES REFERRED TO IN THE DESCRIPTION

¹ Gagliano, E.; Sgroi, M.; Falciglia, P. P.; Vagliasindi, F. G. A.; Roccaro, P. Removal of Poly- and Perfluoroalkyl Substances (PFAS) from Water by Adsorption: Role of PFAS Chain Length, Effect of Organic Matter and Challenges in Adsorbent Regeneration. Water Research. 2020. https://doi.org/10.1016/j.watres.2019.115381.
² Appleman, T. D.; Higgins, C. P.; Quiñones, O.; Vanderford, B. J.; Kolstad, C.; Zeigler-Holady, J. C.; Dickenson, E. R. V. Treatment of Poly- and Perfluoroalkyl Substances in U.S. Full-Scale Water Treatment Systems. Water Res. 2014, 51, 246-255. https://doi.org/10.1016/j.watres.2013.10.067.
³ Sajid, M.; Ilyas, M. PTFE-Coated Non-Stick Cookware and Toxicity Concerns: A Perspective. Environ. Sci. Pollut. Res. 2017, 24 (30), 23436-23440. https://doi.org/10.1007/s11356-017-0095-y.
⁴ Kotthoff, M.; MOller, J.; JOrling, H.; Schlummer, M.; Fiedler, D. Perfluoroalkyl and Polyfluoroalkyl Substances in Consumer Products. Environ. Sci. Pollut. Res. 2015, 22 (19), 14546-14559. https://doi.org/10.1007/s11356-015-4202-7.
⁵ Goodrum, P. E.; Anderson, J. K.; Luz, A. L.; Ansell, G. K. Application of a Framework for Grouping and Mixtures Toxicity Assessment of PFAS: A Closer Examination of Dose-Additivity Approaches. Toxicol. Sci. 2021, 179 (2), 262-278. https://doi.org/10.1093/toxsci/kfaal23.
⁶ Cui, D.; Li, X.; Quinete, N. Occurrence, Fate, Sources and Toxicity of PFAS: What We Know so Far in Florida and Major Gaps. TrAC Trends Anal. Chem. 2020, 130, 115976. https://doi.org/10.1016/j.trac.2020.115976.
⁷USEPA. GenXandPFBSDraft Toxicity Assessments; 2019.
⁸ Yong, Z. Y.; Kim, K. Y.; Oh, J.-E. The Occurrence and Distributions of Per- and Polyfluoroalkyl Substances (PFAS) in Groundwater after a PFAS Leakage Incident in 2018. Environ. Pollut. 2020, 115395. https://doi.org/10.1016/j.envpol.2020.115395.
⁹ Health Canada. Perfluorooctanoic Acid (PFOA) in Drinking Water. 2016.
¹⁰ European Commission. Proposal for a Directive of the European Parliament and of the Council on the Quality of Water Intended for Human Consumption; Brussels, 2018.
¹¹EPA. Fact Sheet: PFOA & PFOS Drinking Water Health Advisories; 2016.
¹² NJDEP. Site remediation Program, New Jersey Department of Environmental Protection (NJDEP).
¹³ DECV. Per and polyfluoroalkyl substances (PFAS)—Department of Environmental Conservation Vermont (DECV) https://dec.vermont.gov/water/drinking-water/water-quality-monitoring/pfas.
¹⁴ EPA Press Office, “EPA Announces New Drinking Water Health Advisories for PFAS Chemicals, $1 Billion in Bipartisan Infrastructure Law Funding to Strengthen Health Protections” Jun. 15, 2022 https://www.epa.gov/newsreleases/epa-announces-new-drinking-water-health-advisories-pfas-chemicals-1-billion-bipartisan.
¹⁵ Boiteux, V.; Bach, C.; Sagres, V.; Hemard, J.; Colin, A.; Rosin, C.; Munoz, J.-F.; Dauchy, X. Analysis of 29 Per- and Polyfluorinated Compounds in Water, Sediment, Soil and Sludge by Liquid Chromatography-Tandem Mass Spectrometry. Int. J. Environ. Anal. Chem. 2016, 96 (8), 705-728. https://doi.org/10.1080/03067319.2016.1196683.
¹⁶ Carter, K. E.; Farrell, J. Removal of Perfluorooctane and Perfluorobutane Sulfonate from Water via Carbon Adsorption and Ion Exchange. Sep. Sci. Technol. 2010, 45 (6), 762-767. https://doi.org/10.1080/01496391003608421.
¹⁷ Park, M.; Daniels, K. D.; Wu, S.; Ziska, A. D.; Snyder, S. A. Magnetic Ion-Exchange (MIEX) Resin for Perfluorinated Alkylsubstance (PFAS) Removal in Groundwater: Roles of Atomic Charges for Adsorption. Water Res. 2020, 181, 115897. https://doi.org/10.1016/j.watres.2020.115897.
¹⁸ Purolite A592E https://www.purolite.com/product/a592e.
¹⁹ Purolite. Purofine A694E https://www.purolite.com/product/pfa694e. 20 Ihsanullah, I. MXenes (Two-Dimensional Metal Carbides) as Emerging Nanomaterials for Water Purification: Progress, Challenges and Prospects. Chem. Eng. J. 2020, 388 (December 2019), 124340. https://doi.org/10.1016/j.cej.2020.124340.
²¹ Hart, J. L.; Hantanasirisakul, K; Lang, A. C.; Anasori, B.; Pinto, D.; Pivak, Y.; van Omme, J. T.; May, S. J.; Gogotsi, Y.; Taheri, M. L. Control of MXenes' Electronic Properties through Termination and Intercalation. Nat. Commun. 2019, 10 (1), 1-10. https://doi.org/10.1038/s41467-018-08169-8.
²² Zhan, X.; Si, C.; Zhou, J.; Sun, Z. MXene and MXene-Based Composites: Synthesis, Properties and Environment-Related Applications. Nanoscale Horizons 2020, 5 (2), 235-258. https://doi.org/10.1039/C₉NH00571D.
²³ George, S. M.; Kandasubramanian, B. Advancements in MXene-Polymer Composites for Various Biomedical Applications. Ceramics International. Elsevier Ltd May 2020, pp 8522-8535. https://doi.org/10.1016/j.ceramint.2019.12.257.
²⁴ Sajid, M. MXenes: Are They Emerging Materials for Analytical Chemistry Applications?—A Review. Anal. Chim. Acta 2020. https://doi.org/10.1016/j.aca.2020.08.063.
²⁵ Al-Hamadani, Y. A. J.; Jun, B. M.; Yoon, M.; Taheri-Qazvini, N.; Snyder, S. A.; Jang, M.; Heo, J.; Yoon, Y. Applications of MXene-Based Membranes in Water Purification: A Review. Chemosphere 2020, 254, 126821. https://doi.org/10.1016/j.chemosphere.2020.126821.
²⁶ Levi, M. D.; Lukatskaya, M. R.; Sigalov, S.; Beidaghi, M.; Shpigel, N.; Daikhin, L.; Aurbach, D.; Barsoum, M. W.; Gogotsi, Y. Solving the Capacitive Paradox of 2D MXene Using Electrochemical Quartz-Crystal Admittance and in Situ Electronic Conductance Measurements. Adv. Energy Mater. 2015, 5 (1). https://doi.org/10.1002/aenm.201400815.
²⁷ Amiri, A.; Chen, Y.; Bee Teng, C.; Naraghi, M. Porous Nitrogen-Doped MXene-Based Electrodes for Capacitive Deionization. Energy Storage Mater. 2020, 25, 731-739. https://doi.org/10.1016/j.ensm.2019.09.013.
²⁸ Ding, L.; Li, L.; Liu, Y.; Wu, Y.; Lu, Z.; Deng, J.; Wei, Y.; Caro, J.; Wang, H. Effective Ion Sieving with Ti3C2Tx MXene Membranes for Production of Drinking Water from Seawater. Nat. Sustain. 2020, 3 (4), 296-302. https://doi.org/10.1038/s41893-020-0474-0.
²⁹ Jun, B.-M.; Heo, J.; Taheri-Qazvini, N.; Park, C. M.; Yoon, Y. Adsorption of Selected Dyes on Ti3C2Tx MXene and Al-Based Metal-Organic Framework. Ceram. Int. 2020, 46 (3), 2960-2968. https://doi.org/10.1016/j.ceramint.2019.09.293.
³⁰ Jun, B.-M.; Jang, M.; Park, C. M.; Han, J.; Yoon, Y. Selective Adsorption of Cs+ by MXene (Ti3C2Tx) from Model Low-Level Radioactive Wastewater. Nucl. Eng. Technol. 2020, 52 (6), 1201-1207. https://doi.org/10.1016/j.net.2019.11.020.
³¹ Dong, Y.; Sang, D.; He, C.; Sheng, X.; Lei, L. Mxene/Alginate Composites for Lead and Copper Ion Removal from Aqueous Solutions. RSC Adv. 2019, 9 (50), 29015-29022. https://doi.org/10.1039/C9RA05251H.
³² Purolite. A860 https://www.purolite.com/product/a860.
³³ Purolite A592E https://www.purolite.com/product/a592e.
³⁴ Purolite. Purofine A694E https://www.purolite.com/product/pfa694e.
³⁵ Amberlite®. XAD4
https://www.sigmaaldrich.com/catalog/product/sigma/xad4?lang=en&region=CA&gclid=CjwKCAjw6fCCBhBNEiwAem5SOwCZCxe8JxNS5pCGSHt21Z843apRgjCVYxUx-trLuwHKft-cTt3aPhoC7t4QAvD_BwE.
³⁶ Amberlite®. XAD7HP
https://www.sigmaaldrich.com/catalog/product/sigma/xad7?lang=en&region=CA&gclid=CjwK CAjw6fCCBhBNEiwAem5SO-K8rAiyxmPX1086zRW1OalwOPVv6FFxwNmIh9MOmsgtO_Y6caK8aRoCcmwQAvD_BwE.
³⁷ Shi, X.; Xiao, H.; Azarabadi, H.; Song, J.; Wu, X.; Chen, X.; Lackner, K. S. Sorbents for the Direct Capture of CO₂ from Ambient Air. Angewandte Chemie—International Edition. Wiley-VCH Verlag April 2020, pp 6984-7006. https://doi.org/10.1002/anie.201906756.
³⁸ Eom, W.; Shin, H.; Ambade, R. B.; Lee, S. H.; Lee, K. H.; Kang, D. J.; Han, T. H. Large-Scale Wet-Spinning of Highly Electroconductive MXene Fibers. Nat. Commun. 2020, 11 (1), 2825. https://doi.org/10.1038/s41467-020-16671-1.
³⁹ Ghidiu, M.; Lukatskaya, M. R.; Zhao, M.-Q.; Gogotsi, Y.; Barsoum, M. W. Conductive Two-Dimensional Titanium Carbide ‘Clay’ with High Volumetric Capacitance. Nature 2014, 516 (7529), 78-81. https://doi.org/10.1038/naturel3970.
⁴⁰ Parker, K. M.; Reichwaldt, E. S.; Ghadouani, A.; Mitch, W. A. Halogen Radicals Promote the Photodegradation of Microcystins in Estuarine Systems. Environ. Sci. Technol. 2016, 50 (16), 8505-8513. https://doi.org/10.1021/acs.est.6b01801.
⁴¹ Dixit, F.; Barbeau, B.; Mohseni, M. Removal of Microcystin-LR from Spiked Natural and Synthetic Waters by Anion Exchange. Sci. Total Environ. 2019, 655, 571-580. https://doi.org/10.1016/j.scitotenv.2018.11.117.
⁴² Bazri, M. M.; Mohseni, M. Impact of Natural Organic Matter Properties on the Kinetics of Suspended Ion Exchange Process. Water Res. 2016, 91, 147-155. https://doi.org/10.1016/j.watres.2015.12.036.
⁴³ Gerrity, D.; Owens-Bennett, E.; Venezia, T.; Stanford, B. D.; Plumlee, M. H.; Debroux, J.; Trussell, R. S. Applicability of Ozone and Biological Activated Carbon for Potable Reuse. Ozone Sci. Eng. 2014, 36 (2), 123-137. https://doi.org/10.1080/01919512.2013.866886.
⁴⁴ Stanford, B. Controlling Trace Organic Compounds Using Alternative, NON-FAT Technology for Potable Water Reuse; 2017.
⁴⁵ Dixit, F.; Barbeau, B.; Mostafavi, S. G.; Mohseni, M. Removal of Legacy PFAS and Other Fluorotelomers: Optimized Regeneration Strategies in DOM-Rich Waters. Water Res. 2020, 183, 116098. https://doi.org/10.1016/j.watres.2020.116098.
⁴⁶ Dixit, F.; Barbeau, B.; Mohseni, M. Characteristics of Competitive Uptake between Microcystin-LR and Natural Organic Matter (NOM) Fractions Using Strongly Basic Anion Exchange Resins. Water Res. 2018, 139, 74-82. https://doi.org/10.1016/j.watres.2018.03.074.
⁴⁷ Dixit, F.; Barbeau, B.; Mostafavi, S. G.; Mohseni, M. Efficient Removal of GenX (HFPO-DA) and Other Perfluorinated Ether Acids from Drinking and Recycled Waters Using Anion Exchange Resins. J Hazard. Mater. 2020, 384, 121261. https://doi.org/10.1016/j.jhazmat.2019.121261.
⁴⁸ Hopkins, Z. R.; Sun, M.; DeWitt, J. C.; Knappe, D. R. U. Recently Detected Drinking Water Contaminants: GenX and Other Per- and Polyfluoroalkyl Ether Acids. J Am. Water Works Assoc. 2018, 110 (7), 13-28. https://doi.org/10.1002/awwa.1073.
⁴⁹ Dixit, F.; Barbeau, B.; Mostafavi, S. G.; Mohseni, M. PFOA and PFOS Removal by Ion Exchange for Water Reuse and Drinking Applications: Role of Organic Matter Characteristics. Environ. Sci. Water Res. Technol. 2019, 5 (10), 1782-1795. https://doi.org/10.1039/C9EW00409B.
⁵⁰ Ministry of Environment, L. and P. Ambient Water Quality Criteria for Organic Carbon in British Columbia https://www2.gov.bc.ca/assets/gov/environment/air-land-water/water/waterquality/water-quality-guidelines/approved-wqgs/organic-carbon-tech.pdf.
⁵¹ McSorley, H. J. Spatial and Temporal Variation in Natural Organic Matter Quantity and Quality across a Second Growth Forested Drinking Water Supply Area on Vancouver Island, BC, University of British Columbia, 2020. https://doi.org/0.14288/1.0395411.
⁵² Dixit, F.; Barbeau, B.; Mostafavi, S. G.; Mohseni, M. PFAS and DOM Removal Using an Organic Scavenger and PFAS-Specific Resin: Trade-off between Regeneration and Faster Kinetics. Sci. Total Environ. 2020, 142107. https://doi.org/10.1016/j.scitotenv.2020.142107.
⁵³ Winter, J.; Wray, H. E.; Schulz, M.; Vortisch, R.; Barbeau, B.; Berube, P. R. The Impact of Loading Approach and Biological Activity on NOM Removal by Ion Exchange Resins. Water Res. 2018, 134, 301-310. https://doi.org/10.1016/j.watres.2018.01.052.
⁵⁴ Chintalapati, P. Degradation of Cyanobacterial Toxin Microcystin-LR Using UV/Vacuum-UV Advanced Oxidation for Drinking Water Treatment, University of British Columbia, 2017.
⁵⁵ Chintalapati, P.; Mohseni, M. Degradation of Cyanotoxin Microcystin-LR in Synthetic and Natural Waters by Chemical-Free UV/VUV Radiation. J. Hazard. Mater. 2020, 381 (July 2019), 120921. https://doi.org/10.1016/j.jhazmat.2019.120921.
⁵⁶ Bolton, J. R.; Stefan, M. I.; Shaw, P. S.; Lykke, K. R. Determination of the Quantum Yields of the Potassium Ferrioxalate and Potassium Iodide-Iodate Actinometers and a Method for the Calibration of Radiometer Detectors. J. Photochem. Photobiol. A Chem. 2011, 222 (1), 166-169. https://doi.org/10.1016/j.jphotochem.2011.05.017.
⁵⁷ Rahn, R. O. Potassium Iodide as a Chemical Actinometer for 254 Nm Radiation: Use of Iodate as an Electron Scavenger. Photochem. Photobiol. 1997, 66 (6), 885-885. https://doi.org/10.1111/j.1751-1097.1997.tb03243.x.
⁵⁸ Bolton, J. R.; Linden, K. G. Standardization of Methods for Fluence (UV Dose) Determination in Bench-Scale UV Experiments. J. Environ. Eng. 2003, 129 (3), 209-215. https://doi.org/10.1061/(ASCE)0733-9372(2003)129:3(209).
⁵⁹ Huber, S. A.; Balz, A.; Abert, M.; Pronk, W. Characterisation of Aquatic Humic and Non-Humic Matter with Size-Exclusion Chromatography—Organic Carbon Detection—Organic Nitrogen Detection (LC-OCD-OND). Water Res. 2011, 45 (2), 879-885. https://doi.org/10.1016/j.watres.2010.09.023.
⁶⁰ Winter, J.; Wray, H. E.; Schulz, M.; Vortisch, R.; Barbeau, B.; Berube, P. R. The Impact of Loading Approach and Biological Activity on NOM Removal by Ion Exchange Resins. Water Res. 2018, 134, 301-310. https://doi.org/10.1016/j.watres.2018.01.052.
⁶¹ Sahetya, T. J.; Dixit, F.; Balasubramanian, K. Waste Citrus Fruit Peels for Removal of Hg(II) Ions. Desalin. Water Treat. 2013, 3994 (February 2015), 1-13. https://doi.org/10.1080/19443994.2013.852483.
⁶² Dada, A.; Olalekan, A.; Olatunya, A.; Dada, O. Langmuir, Freundlich, Temkin and Dubinin—Radushkevich Isotherms Studies of Equilibrium Sorption of Zn2+ Unto Phosphoric Acid Modified Rice Husk. IOSR J. Appl. Chem. 2012, 3 (1), 38-45. https://doi.org/10.9790/5736-0313845.
⁶³ Rengaraj, S.; Yeon, J.-W.; Kim, Y.; Jung, Y.; Ha, Y.-K.; Kim, W.-H. Adsorption Characteristics of Cu(II) onto Ion Exchange Resins 252H and 1500H: Kinetics, Isotherms and Error Analysis. J. Hazard. Mater. 2007, 143 (1-2), 469-477. https://doi.org/i0.1016/j.jhazmat.2006.09.064.
⁶⁴ Sahetya, T. J.; Dixit, F.; Balasubramanian, K. Waste Citrus Fruit Peels for Removal of Hg(II) Ions. Desalin. Water Treat. 2013, 3994 (February 2015), 1-13. https://doi.org/10.1080/19443994.2013.852483.
⁶⁵ Ricci, L.; Martinez, R. Adjusted-Type Measures for Tweedie Models. Comput. Stat. Data Anal. 2008, 52 (3), 1650-1660. https://doi.org/10.1016/j.csda.2007.05.017.
⁶⁶ Bazri, M. M.; Mohseni, M. Impact of Natural Organic Matter Properties on the Kinetics of Suspended Ion Exchange Process. Water Res. 2016, 91, 147-155. https://doi.org/10.1016/j.watres.2015.12.036.
⁶⁷ Ko, D. C. K.; Porter, J. F.; McKay, G. Film-Pore Diffusion Model for the Fixed-Bed Sorption of Copper and Cadmium Ions onto Bone Char. Water Res. 2001, 35 (16), 3876-3886. https://doi.org/10.1016/S0043-1354(01)00114-2.
⁶⁸ Helfferich, F. Ion-Exchange Kinetics. V. Ion Exchange Accompanied by Reactions. J Phys. Chem. 1965, 69 (4), 1178-1187. https://doi.org/10.1021/j100888a015.
⁶⁹ (Weber Jr and DiGiano, 1996) Weber, W. J., Jr., and F. A. DiGiano. “Process Dynamics in Environmental Systems”. ISBN 0-471-01711-6. 1996 New York: John Wiley & Sons, Inc.
⁷⁰ Li, P.; Sengupta, A. K. Intraparticle Diffusion during Selective Ion Exchange with a Macroporous Exchanger. React. Funct. Polym. 2000, 44, 273-287.
⁷¹ Li, P.; SenGupta, A. K. Intraparticle Diffusion during Selective Sorption of Trace Contaminants: The Effect of Gel versus Macroporous Morphology. Environ. Sci. Technol. 2000, 34 (24), 5193-5200. https://doi.org/10.1021/es001299o.
⁷² Dixit, F.; Barbeau, B.; Mohseni, M. Characteristics of Competitive Uptake between Microcystin-LR and Natural Organic Matter (NOM) Fractions Using Strongly Basic Anion Exchange Resins. Water Res. 2018, 139, 74-82. https://doi.org/10.1016/j.watres.2018.03.074.
⁷³ Mejia-Avendaño, S.; Munoz, G.; Vo Duy, S.; Desrosiers, M.; Benoit, P.; Sauvé, S.; Liu, J. Novel Fluoroalkylated Surfactants in Soils Following Firefighting Foam Deployment During the Lac-Megantic Railway Accident. Environ. Sci. Technol. 2017, 51 (15), 8313-8323. https://doi. org/10.1021/acs.est.7b02028.
⁷⁴ EPA, U. S. Draft Procedure for Analysis of Perfluorinated Carboxylic Acids and Sulfonic Acids in Sewage Sludge and Biosolids by HPLC-MS-MS. EPA-821⁻R-11-007; 2011.
⁷⁵ Dixit, F.; Dutta, R.; Barbeau, B.; Berube, P.; Mohseni, M. PFAS Removal by Ion Exchange Resins: A Review. Chemosphere 2021, 272. https://doi.org/10.1016/j.chemosphere.2021.129777.
⁷⁶ Wang, R.; Ching, C.; Dichtel, W. R.; Helbling, D. E. Evaluating the Removal of Per- and Polyfluoroalkyl Substances from Contaminated Groundwater with Different Adsorbents Using a Suspect Screening Approach. Environ. Sci. Technol. Lett. 2020, 7 (12), 954-960. https://doi.org/10.1021/acs.estlett.0c00736.
⁷⁷ Dixit, F.; Barbeau, B.; Mohseni, M. Removal of Microcystin-LR from Spiked Natural and Synthetic Waters by Anion Exchange. Sci. Total Environ. 2019, 655. https://doi.org/10.1016/j.scitotenv.2018.11.117.
⁷⁸ Nguyen, T. M. H.; Braunig, J.; Thompson, K.; Thompson, J.; Kabiri, S.; Navarro, D. A.; Kookana, R. S.; Grimison, C.; Barnes, C. M.; Higgins, C. P.; McLaughlin, M. J.; Mueller, J. F. Influences of Chemical Properties, Soil Properties, and Solution PH on Soil-Water Partitioning Coefficients of Per- and Polyfluoroalkyl Substances (PFASs). Environ. Sci. Technol. 2020, 54 (24), 15883-15892. https://doi.org/10.1021/acs.est.0c05705.
⁷⁹Barzen-Hanson, K. A.; Davis, S. E.; Kleber, M.; Field, J. A. Sorption of Fluorotelomer Sulfonates, Fluorotelomer Sulfonamido Betaines, and a Fluorotelomer Sulfonamido Amine in National Foam Aqueous Film-Forming Foam to Soil. Environ. Sci. Technol. 2017, 51 (21), 12394-12404. https://doi.org/10.1021/acs.est.7b03452.
⁸⁰ Jeon, M.; Jun, B. M.; Kim, S.; Jang, M.; Park, C. M.; Snyder, S. A.; Yoon, Y. A Review on MXene-Based Nanomaterials as Adsorbents in Aqueous Solution. Chemosphere 2020, 261, 127781. https://doi.org/10.1016/j.chemosphere.2020.127781.
⁸¹ Jun, B. M.; Park, C. M.; Heo, J.; Yoon, Y. Adsorption of Ba2+ and Sr2+ on Ti3C2Tx MXene in Model Fracking Wastewater. J. Environ. Manage. 2020, 256 (September 2019), 109940. https://doi.org/10.1016/j.jenvman.2019.109940.
⁸² Dixit, F.; Barbeau, B.; Mohseni, M. Simultaneous Uptake of NOM and Microcystin-LR by Anion Exchange Resins: Effect of Inorganic Ions and Resin Regeneration. Chemosphere 2018, 192, 113-121. https://doi.org/10.1016/j.chemosphere.2017.10.135.
⁸³ Amini, A.; Kim, Y.; Zhang, J.; Boyer, T.; Zhang, Q. Environmental and Economic Sustainability of Ion Exchange Drinking Water Treatment for Organics Removal. J Clean. Prod. 2015, 104, 413-421. https://doi.org/10.1016/j.jclepro.2015.05.056.
⁸⁴ Maul, G. A.; Kim, Y.; Amini, A.; Zhang, Q.; Boyer, T. H. Efficiency and Life Cycle Environmental Impacts of Ion-Exchange Regeneration Using Sodium, Potassium, Chloride, and Bicarbonate Salts. Chem. Eng. J. 2014,254, 198-209. https://doi.org/10.1016/j.cej.2014.05.086.
⁸⁵ Tenorio, R.; Liu, J.; Xiao, X.; Maizel, A.; Higgins, C. P.; Schaefer, C. E.; Strathmann, T. J. Destruction of Per- and Polyfluoroalkyl Substances (PFASs) in Aqueous Film-Forming Foam (AFFF) with UV-Sulfite Photoreductive Treatment. Environ. Sci. Technol. 2020, 54 (11), 6957-6967. https://doi.org/10.1021/acs.est.0c00961.
⁸⁶ Moe, M. K.; Huber, S.; Svenson, J.; Hagenaars, A.; Pabon, M.; Trimper, M.; Berger, U.; Knapen, D.; Herzke, D. The Structure of the Fire Fighting Foam Surfactant Forafac®1157 and Its Biological and Photolytic Transformation Products. Chemosphere 2012, 89 (7), 869-875. https://doi.org/10.1016/j.chemosphere.2012.05.012.
⁸⁷ D'Agostino, L. A.; Mabury, S. A. Certain Perfluoroalkyl and Polyfluoroalkyl Substances Associated with Aqueous Film Forming Foam Are Widespread in Canadian Surface Waters. Environ. Sci. Technol. 2017, 51 (23), 13603-13613. https://doi.org/10.1021/acs.est.7b03994.
⁸⁸ Chen, H.; Munoz, G.; Duy, S. V.; Zhang, L.; Yao, Y.; Zhao, Z.; Yi, L.; Liu, M.; Sun, H.; Liu, J.; Sauvé, S. Occurrence and Distribution of Per- and Polyfluoroalkyl Substances in Tianjin, China: The Contribution of Emerging and Unknown Analogues. Environ. Sci. Technol. 2020, 54 (22), 14254-14264. https://doi.org/10.1021/acs.est.0c00934.
⁸⁹ Dauchy, X.; Boiteux, V.; Bach, C.; Colin, A.; Hemard, J.; Rosin, C.; Munoz, J.-F. Mass Flows and Fate of Per- and Polyfluoroalkyl Substances (PFASs) in the Wastewater Treatment Plant of a Fluorochemical Manufacturing Facility. Sci. Total Environ. 2017, 576, 549-558. https://doi.org/10.1016/j.scitotenv.2016.10.130.
⁹⁰ Liu, M.; Munoz, G.; Vo Duy, S.; Sauvé, S.; Liu, J. Stability of Nitrogen-Containing Polyfluoroalkyl Substances in Aerobic Soils. Environ. Sci. Technol. 2021, 55 (8), 4698-4708. https://doi.org/10.1021/acs.est.0c05811.
⁹¹ Fang, Y.; Ellis, A.; Choi, Y. J.; Boyer, T. H.; Higgins, C. P.; Schaefer, C. E.; Strathmann, T. J. Removal of Per- and Polyfluoroalkyl Substances (PFASs) in Aqueous Film-Forming Foam (AFFF) Using Ion-Exchange and Nonionic Resins. Environ. Sci. Technol. 2021, 55 (8), 5001-5011. https://doi.org/10.1021/acs.est.1c00769.
⁹² Ching, C.; Klemes, M. J.; Trang, B.; Dichtel, W. R.; Helbling, D. E. β-Cyclodextrin Polymers with Different Cross-Linkers and Ion-Exchange Resins Exhibit Variable Adsorption of Anionic, Zwitterionic, and Nonionic PFASs. Environ. Sci. Technol. 2020, 54 (19), 12693-12702. https://doi.org/10.1021/acs.est.0c04028.
⁹³ Bruton, T. A.; Sedlak, D. L. Treatment of Aqueous Film-Forming Foam by Heat-Activated Persulfate Under Conditions Representative of In Situ Chemical Oxidation. Environ. Sci. Technol. 2017, 51 (23), 13878-13885. https://doi.org/10.1021/acs.est.7b03969.
⁹⁴ Liu, Z.; Bentel, M. J.; Yu, Y.; Ren, C.; Gao, J.; Pulikkal, V. F.; Sun, M.; Men, Y.; Liu, J. Near-Quantitative Defluorination of Perfluorinated and Fluorotelomer Carboxylates and Sulfonates with Integrated Oxidation and Reduction. Environ. Sci. Technol. 2021, 55 (10), 7052-7062. https://doi.org/10.1021/acs.est.1c00353.
⁹⁵ Song, Z.; Tang, H.; Wang, N.; Zhu, L. Reductive Defluorination of Perfluorooctanoic Acid by Hydrated Electrons in a Sulfite-Mediated UV Photochemical System. J. Hazard. Mater. 2013, 262, 332-338. https://doi.org/10.1016/j.jhazmat.2013.08.059.
⁹⁶ Poltanov, E.A., Shikov, A.N., Dorman, H.J.D., Pozharitskaya, O.N., Makarov, V.G., Tikhonov, V. P. and Hiltunen, R. Chemical and antioxidant evaluation of Indian gooseberry (emblica officinalis gaertn., syn. phyllanthus emblica L.) supplements. Phytother. Res., 2009, 23, 1309-1315. https://doi.org/10.1002/ptr.2775.
⁹⁷ Yang, B.; Liu, P. Composition and biological activities of hydrolyzable tannins of fruits of Phyllanthus emblica. 2014, 62, 529-541.

1. A method of removing an environmental contaminant from media comprising the environmental contaminant, the method comprising:
contacting the media comprising the environmental contaminant with a nanoparticle prepared from a polyphenol-containing natural material and a metal salt.

2. The method of claim 1, wherein the polyphenol-containing natural material is a polyphenol-containing plant material, wherein the polyphenol-containing plant material is a polyphenol-containing fruit, bark, leaf, vegetable, grain or combinations thereof; wherein the metal salt is a metal nitrate, sulfate, chloride or combination thereof; and wherein the metal of the metal salt is iron, silver, gold or combinations thereof.

3. (canceled)

4. The method of claim 2, wherein the polyphenol-containing fruit is of Cyanococcus, Fragaria spp., Rubus spp., Phyllanthus emblica or combinations thereof.

5. The method of claim 4, wherein the polyphenol-containing natural material comprises Phyllanthus emblica fruit powder; and wherein the metal salt comprises FeSO₄.

6. The method of claim 1, wherein the preparation of the nanoparticle comprises combining the polyphenol-containing natural material in the form of a polyphenol-containing extract from the natural material with the metal salt.

7-9. (canceled)

10. The method of claim 1, wherein the nanoparticle is in a composite material comprising the nanoparticle and a substrate.

11. The method of claim 10, wherein the substrate comprises sand, gravel, clay, hydrogel, carbon, mined material, sediment, polymer, a metal organic framework, a zeolite, MXene, a biomaterial or combinations thereof.

12. The method of claim 11, wherein the substrate comprises a PFAS specific resin or a PFAS specific membrane; a polystyrenic resin comprising a quaternary ammonium functional group; or a polyacrylic resin comprising a quaternary ammonium functional group.

13-14. (canceled)

15. The method of claim 1, wherein the nanoparticles are raw.

16. The method of claim 1, wherein the environmental contaminant comprises PFAS, natural organic matter or combinations thereof.

17. The method of claim 16, wherein the environmental contaminant comprises PFAS.

18-19. (canceled)

20. The method of claim 1, wherein the media comprises air, a liquid, a solid, a gel, a slurry or combinations thereof.

21. The method of claim 20, wherein the media comprises water.

22. The method of claim 1, wherein subsequent to contacting, the method further comprises separating the nanoparticle from the media.

23. The method of claim 22, wherein the nanoparticle is in a composite material comprising the nanoparticle and a substrate, and wherein the method further comprises regenerating the composite material.

24. The method of claim 23, wherein the composite is regenerated with an aqueous solution comprising an inorganic salt, inorganic acid, inorganic base, organic solvent or combinations thereof to obtain a regenerated composite material and a regeneration concentrate comprising the environmental contaminant and/or by-products thereof; and wherein the method further comprises treatment of the regeneration concentrate to degrade and/or destroy the environmental contaminant and/or by-products thereof.

25. (canceled)

26. The method of claim 1, wherein subsequent to contacting, the method further comprises treatment of the contacted media to degrade and/or destroy remaining environmental contaminant and/or by-products thereof.

27-28. (canceled)

29. The method of claim 1, wherein prior to contacting the media comprising the environmental contaminant with the nanoparticle, the method comprises oxidizing the environmental contaminant.

30. A method of removing a zwitterionic PFAS from media comprising the zwitterionic PFAS, the method comprising:
contacting the media comprising the zwitterionic PFAS with a MXene.

31-39. (canceled)

40. A method of preparing a composite material, the method comprising: preparing a nanoparticle from a polyphenol-containing natural material and a metal salt; and combining the nanoparticle with a substrate.

41-52. (canceled)

53. A composite material prepared by a method as defined in claim 40.

54-55. (canceled)
